(19) United States
(12) Patent Application Publication
(10) Pub. No.: US 2026/0292319 A1
(43) Pub. Date: Sep. 24, 2026

(54) LENS ACTUATOR, CAMERA DEVICE, AND OPTICAL INSTRUMENT

(71) Applicant: LG INNOTEK CO., LTD., Seoul (KR)

(72) Inventors: Yun Ho NOH, Seoul (KR); Tae Hoon KWON, Seoul (KR); Byung Wook SON, Seoul (KR)

(21) Appl. No.: 19/472,412

(22) PCT Filed: Apr. 2, 2024
(86) PCT No.: PCT/KR2024/004223

§ 371 Date: Oct. 3, 2025

(30) Foreign Application Priority Data
Apr. 6, 2023 (KR) 10-2023-0045589
Apr. 21, 2023 (KR) 10-2023-0052962

(51) Int. Cl. H04N 23/55; H04N 23/54; H04N 23/63

(52) U.S. Cl. CPC H04N 23/55; H04N 23/54; H04N 23/631

(57) ABSTRACT

A first embodiment of the present invention relates to a lens actuator comprising: a base; a housing disposed on the base; a bobbin disposed inside the housing; a first ball disposed between the housing and the base; a second ball disposed between the housing and the lower side of the bobbin; and a coil spring coupled to the bobbin and the housing, wherein the coil spring pressurizes the second ball.

### CROSS-REFERENCE TO RELATED APPLICATIONS

This application is the U.S. national stage application of International Patent Application No. PCT/KR2024/004223, filed Apr. 2, 2024, which claims the benefit under 35 U.S.C. § 119 of Korean Application Nos. 10-2023-0045589, filed Apr. 6, 2023, and 10-2023-0052962, filed Apr. 21, 2023, the disclosures of each of which are incorporated herein by reference in their entirety.

### TECHNICAL FIELD

The present embodiment relates to a lens actuator, a camera device, and an optical instrument.

### BACKGROUND ART

A camera device is a device that photographs a picture or video of a subject, and is installed in optical instruments such as smartphones, drones, and vehicles.

An auto-focus function that automatically adjusts the focus according to the distance of the subject is applied to the camera device. In addition, a handshake correction function is applied to prevent a phenomenon in which the focus is shaken by the user's handshake.

The autofocus function and the handshake correction function may be performed through electromagnetic interaction between the magnet and the coil.

However, in the conventional lens driving device, a magnet that does not require electrical connection is disposed in the moving unit and the coil is disposed in the fixed unit. In this case, there is a problem in that a magnet having a greater weight than a coil is disposed in the moving unit, thereby increasing current consumption.

In particular, recently, as image sensors become more pixelated, the lens diameter has increased, and the weight of the lens has also increased, which has exacerbated the problem.

In addition, in conventional lens actuators, there is a problem in that the height of the camera device in an optical axis direction increases because the guide structure for OIS-x-axis driving and the guide structure for OIS-y-axis driving are disposed in separate layers.

Meanwhile, the autofocus function is performed as the lens moves along the optical axis against the image sensor, and the movement of the lens along the optical axis can be guided by a ball. At this time, the attractive force between the magnet and the yoke can be used to hold the ball between the fixed unit and the moving unit.

However, in this case, there is a problem that a centering force exists in the direction of the optical axis.

Additionally, there is a problem that linearity between current and travel distance is not secured over the entire stroke range of the drive for the handshake correction function.

Patent Literature 1 KR 10-2015-0118005 A

### DETAILED DESCRIPTION OF THE INVENTION

### Technical Subject

The present embodiment is intended to provide a lens actuator that reduces current consumption for performing an autofocus function by placing a coil that is lighter in weight than a magnet in a moving unit.

In addition, it is intended to provide a lens actuator with a minimized height in the optical axis direction by forming a guide structure for OIS-x-axis driving and a guide structure for OIS-y-axis driving as one body.

The present embodiment is intended to provide a lens actuator that pressurizes a ball through an elastic member so that there is no centering force in the optical axis direction that occurs when the ball is pressurized through a yoke and a magnet.

In addition, it is intended to provide a lens actuator with improved linearity between current and travel distance over the entire stroke range of the drive for handshake correction function.

### Technical Solution

A lens actuator according to a first embodiment of the present invention comprises: a base; a housing disposed on the base; a bobbin disposed inside the housing; a first ball disposed between the housing and the base; a second ball disposed between the housing and the lower side of the bobbin; and a coil spring coupled with the bobbin and the housing, wherein the coil spring is configured to press the second ball.

The base may comprise a first guide configured to guide movement of the first ball. The housing may comprise a second guide configured to guide movement of the first ball and formed on a side surface of the housing.

The first guide and the second guide may comprise grooves.

The housing may comprise a first housing comprising a lower plate having a metal member and a second housing coupled with the first housing and having a protrusion configured to guide the second ball.

The lens actuator comprises a first substrate disposed between the first housing and the second housing, the first substrate is coupled with a lower surface of the first housing, and the second housing may be coupled with the first substrate.

The second housing may be in contact with the second ball to press a portion of the coil spring.

The lens actuator comprises a cover coupled with the base, and the first ball may be disposed between the cover and a pillar of the base.

The coil spring may have a circular ring shape when viewed from above.

The coil spring can be formed by bending one strand so that it may be overlapped with one another multiple times in an optical axis direction.

The bobbin comprises a protruded portion protruded from an outer surface of the bobbin, and the coil spring can connect the protruded portion of the bobbin and the lower plate of the housing.

The coil spring can connect the bobbin and the metal member of the housing.

The bobbin comprises first to fourth corners, the coil spring comprises first to fourth coil springs disposed at the first to fourth corners of the bobbin, and the first to fourth coil springs can be spaced apart from one another in a direction perpendicular to the optical axis direction.

A camera device according to a first embodiment of the present invention may comprise: a printed circuit board; an image sensor disposed in the printed circuit board; the lens actuator disposed in the printed circuit board; and a lens coupled with the lens actuator.

An optical instrument according to a first embodiment of the present invention may comprise: a main body; a camera device disposed in the main body; and a display disposed in the main body and outputting at least one of an image and a video photographed by the camera device.

A lens actuator according to a second embodiment of the present invention comprises: a fixed unit; a first moving unit being disposed within the fixed unit; a second moving unit being disposed within the first moving unit; a first magnet and a first coil for moving the first moving unit in the optical axis direction; and a second magnet and a second coil that move the second moving unit in a first direction perpendicular to the optical axis, wherein the second magnet comprises a first magnet portion comprising a north pole and a south pole, and a second magnet portion comprising a south pole and a north pole, wherein the first magnet portion and the second magnet portion are disposed on a first side surface of the second moving unit, wherein the second coil comprises a first coil portion interacting with the first magnet portion, and a second coil portion interacting with the second magnet portion, and wherein the polarity of the first magnet portion facing the first coil portion and the polarity of the second magnet portion facing the second coil portion may be different from each other.

The polarity of the entire area of the first magnet portion facing the first coil portion is a single polarity as the S pole, and the polarity of the entire area of the second magnet portion facing the second coil portion may be a single polarity as the N pole.

The first magnet portion comprises an inner surface disposed on the first side surface of the second moving unit and an outer surface opposite to the inner surface, wherein the inner surface of the first magnet portion is formed as an N pole in its entirety, and wherein the outer surface of the first magnet portion may be formed as an S pole in its entirety.

The first coil portion is overlapped with the first magnet portion in the first direction, and the second coil portion may be overlapped with the second magnet portion in the first direction.

When current is applied to the second coil, the second magnet can move away from or toward the second coil in the first direction.

The first magnet portion and the second magnet portion can be formed as separate magnets.

The second magnet comprises a neutral portion being disposed between the first magnet portion and the second magnet portion, wherein the first magnet portion, the second magnet portion, and the neutral portion can be formed integrally.

The first magnet portion and the second magnet portion can be overlapped with each other in a second direction perpendicular to the optical axis direction and the first direction.

The first coil portion is electrically connected to the second coil portion, and the winding direction of the first coil portion may be opposite to the winding direction of the second coil portion.

The lens actuator comprises a third magnet and a third coil that move the second moving unit in a second direction perpendicular to the optical axis direction and the first direction, wherein the third magnet comprises a third magnet portion comprising a north pole and a south pole, and a fourth magnet portion comprising a south pole and a north pole, wherein the third coil comprises a third coil portion interacting with the third magnet portion, and a fourth coil portion interacting with the fourth magnet portion, and wherein the polarity of the third magnet portion facing the third coil portion and the polarity of the fourth magnet portion facing the fourth coil portion may be different from each other.

The second moving unit comprises a second side surface opposite the first side surface, and a third side surface and a fourth side surface being disposed opposite to each other, wherein the first magnet may be disposed on the third side surface of the second moving unit or disposed opposite to the third side surface, and wherein the third magnet may be disposed on the fourth side surface of the second moving unit.

The lens actuator may comprise a ball being disposed between the first moving unit and the second moving unit.

A lens actuator according to a second embodiment of the present invention comprises: a fixed unit; a first moving unit being disposed within the fixed unit; a second moving unit being disposed within the first moving unit; a first magnet and a first coil that move the first moving unit in an optical axis direction; and a second magnet and a second coil that move the second moving unit in a first direction perpendicular to the optical axis direction, wherein the second magnet comprises a first magnet portion comprising a north pole and a south pole, and a second magnet portion comprising a south pole and a north pole, wherein the second coil comprises a first coil portion interacting with the first magnet portion, and a second coil portion interacting with the second magnet portion, and wherein the first coil portion is overlapped with the first magnet portion in the first direction, and the second coil portion may be overlapped with the second magnet portion in the first direction.

A camera device according to a second embodiment of the present invention may comprise: a printed circuit board; an image sensor being disposed on the printed circuit board; the lens actuator being disposed on the printed circuit board; and a lens being coupled to the lens actuator.

An optical instrument according to a second embodiment of the present invention may comprise: a main body; a camera device being disposed in the main body; and a display being disposed in the main body and outputting at least one of an image and a video photographed by the camera device.

### Advantageous Effects

Through the present embodiment, the current consumption for performing the autofocus function can be reduced by placing a coil that is lighter in weight than the magnet in the moving unit.

In addition, since the guide structure for OIS-x-axis driving and the guide structure for OIS-y-axis driving are formed integrally, the height of the lens actuator in the optical axis direction can be minimized.

Through this, the height at which the camera device being protruded from the smartphone to be minimized.

In addition, since the centering force in an optical axis direction that occurs when the ball is pressurized through the yoke and magnet is eliminated, that is, there is no force to return to the centering position, the current consumption for AF driving is reduced, even if only slightly, and the accuracy of AF driving can be improved.

In addition, the elastic member can expect a stress relief effect due to an increase in spring volume as the coil spring is used, for an example. Consequently, reliability and durability characteristics can be improved. Furthermore, the drivable stroke length can be increased.

In addition, when using a coil spring as an elastic member, the number of parts can be reduced compared to a leaf spring and wire combination structure, simplifying the process and improving the cost.

In addition, linearity between current and travel distance can be ensured over the entire stroke range of the drive for the handshake correction function.

### BRIEF DESCRIPTION OF DRAWINGS

FIG. 1 is a conceptual diagram of a lens actuator according to a first embodiment of the present invention.

FIG. 2 is a perspective view of a lens actuator according to a first embodiment of the present invention.

FIG. 3 is a cross-sectional view taken along line A-A of FIG. 2.

FIG. 4 is a cross-sectional view taken along line B-B of FIG. 2.

FIG. 5 is an enlarged view of area F of FIG. 4.

FIG. 6 is a cross-sectional view ta

ken along line C-C of FIG. 2.

FIG. 7 is an enlarged view of area G of FIG. 6.

FIG. 8 is a cross-sectional view taken along line D-D of FIG. 2.

FIG. 9 is an enlarged view of area H of FIG. 8.

FIG. 10 is a cross-sectional view taken along line E-E of FIG. 2.

FIG. 11 is a cross-sectional view of a lens actuator according to a first embodiment of the present invention, cut perpendicular to the optical axis and viewed from above.

FIG. 12 is an exploded perspective view of a lens actuator according to a first embodiment of the present invention.

FIG. 13 is an exploded perspective view of a lens actuator according to a first embodiment of the present invention, viewed from a different direction than FIG. 12.

FIG. 14 is a perspective view of a lens actuator according to a first embodiment of the present invention, with the cover omitted.

FIG. 15 is a perspective view illustrating a fixed unit and related components of a lens actuator according to a first embodiment of the present invention.

FIG. 16 is a perspective view illustrating a moving unit and related components of a lens actuator according to a first embodiment of the present invention.

FIG. 17 is a perspective view illustrating a coupling structure of an inner substrate and an outer substrate of a lens actuator according to a first embodiment of the present invention.

FIG. 18 is a bottom perspective view illustrating a moving unit and related components of a lens actuator according to a first embodiment of the present invention.

FIG. 19 is a bottom perspective view illustrating a coupling structure of inner and outer substrates of a lens actuator according to a first embodiment of the present invention.

FIG. 20 is a perspective view of FIG. 16 with a cover removed.

FIG. 21A is a perspective view of FIG. 20 with an OIS moving unit and related components removed.

FIG. 21B is an enlarged perspective view of a coupling structure between a coil spring and an AF carrier.

FIG. 21C is an enlarged perspective view of a coupling structure between a coil spring and an OIS carrier.

FIG. 22 is an exploded perspective view of a coil spring of FIG. 21A with the coil spring removed.

FIG. 23 is a perspective view illustrating an OIS moving unit and related components of a lens actuator according to a first embodiment of the present invention.

FIG. 24 is a bottom perspective view viewed from a different direction than FIG. 23.

FIG. 25 is a bottom perspective view of FIG. 16 viewed from a different direction.

FIG. 26 is a bottom view of FIG. 25 with a preload member and an inner substrate removed.

FIG. 27 is a perspective view illustrating a coupling structure of an OIS carrier, a coil spring, and a metal member of a lens actuator according to a first embodiment of the present invention.

FIG. 28 is an enlarged view of area I of FIG. 27.

FIG. 29 is a perspective view of a lens actuator according to a first embodiment of the present invention with a cover and a lid removed.

FIG. 30 is a bottom perspective view of a driving unit of the lens actuator according to a first embodiment of the present invention.

FIG. 31 is a cross-sectional perspective view illustrating a coupling structure of a coil spring of a lens actuator according to a first embodiment of the present invention.

FIG. 32 is a cross-sectional view illustrating a coupling structure of a coil spring of a lens actuator according to a first embodiment of the present invention.

FIG. 33A is a front view illustrating a coil spring of a lens actuator according to a modified embodiment.

FIG. 33B is a perspective view illustrating a coil spring and its coupling structure of a lens actuator according to another modified embodiment.

FIGS. 33C-1, 33C-2, and 33C-3 are drawings illustrating a coil spring according to additional various modified embodiments.

FIG. 34 is a cross-sectional view of a lens actuator according to a modified embodiment, cut perpendicular to an optical axis and viewed from above.

FIG. 35 is a bottom perspective view of a driving unit of a lens actuator according to a modified embodiment.

FIG. 36 is a plan view of a lens actuator according to a first embodiment of the present invention with its cover removed.

FIG. 37 is a plan view of a portion of FIG. 36 enlarged with a cover omitted.

FIG. 38 is a perspective view illustrating a ball and related components of a lens actuator according to a first embodiment of the present invention.

FIG. 39 is a perspective view illustrating a ball accommodating structure of a base of a lens actuator according to a first embodiment of the present invention.

FIG. 40 is a perspective view illustrating a state in which a ball, a plate member, an elastic member, and a reinforcing member in FIG. 39 are disposed.

FIG. 41 is a perspective view of FIG. 40 viewed from a different direction.

FIG. 42 is a perspective view of a moving unit and a ball of a lens actuator according to a first embodiment of the present invention.

FIG. 43 is a perspective view of FIG. 42 viewed from a different direction.

FIG. 44A is a drawing comparing the heights of a ball and a pressure point when a moving unit moves upward, and FIG. 44B is a drawing comparing the heights of a ball and a pressure point when a moving unit moves downward.

FIGS. 45 to 47 are drawings for explaining an autofocus driving of a lens actuator according to a first embodiment of the present invention. FIG. 45 is a cross-sectional view illustrating a moving unit in an initial state where no current is applied to an AF coil. FIG. 46 is a cross-sectional view illustrating a moving unit moving upward in an optical axis direction when a positive current is applied to an AF coil. FIG. 47 is a cross-sectional view illustrating a state in which a reverse current is applied to an AF coil and a moving unit moves downward in an optical axis direction.

FIGS. 48 to 50 are diagrams for explaining a handshake correction driving of the lens actuator according to a first embodiment of the present invention. FIG. 48 is a cross-sectional view illustrating the appearance of an OIS moving unit in an initial state in which no current is applied to an OIS-x coil and an OIS-y coil. FIG. 49 is a cross-sectional view illustrating the appearance in which an OIS moving unit moves in an x-axis direction perpendicular to an optical axis when a current is applied to an OIS-x coil. FIG. 50 is a cross-sectional view illustrating the appearance in which an OIS moving unit moves in a y-axis direction perpendicular to both an optical axis and an x-axis when a current is applied to an OIS-y coil.

FIG. 51 is an exploded perspective view of a camera device according to a first embodiment of the present invention.

FIG. 52 is a perspective view of an optical instrument according to a first embodiment of the present invention.

FIG. 53 is a perspective view of an optical instrument according to a modified embodiment.

FIG. 54 is a conceptual diagram of a lens actuator according to a second embodiment of the present invention.

FIG. 55 is a perspective view of a lens actuator according to a second embodiment of the present invention.

FIG. 56 is a cross-sectional view taken along line A-A of FIG. 55.

FIG. 57 is a cross-sectional view taken along line B-B of FIG. 55.

FIG. 58 is an enlarged view of area F of FIG. 57.

FIG. 59 is a cross-sectional view taken along line C-C of FIG. 55.

FIG. 60 is an enlarged view of area G of FIG. 59.

FIG. 61 is a cross-sectional view taken along line D-D of FIG. 55.

FIG. 62 is an enlarged view of area H of FIG. 61.

FIG. 63 is a cross-sectional view taken along line E-E of FIG. 55.

FIG. 64 is a cross-sectional view taken along line orthogonal to an optical axis and viewed from above of a lens actuator according to a second embodiment of the present invention.

FIG. 65 is an exploded perspective view of a lens actuator according to a second embodiment of the present invention.

FIG. 66 is an exploded perspective view of a lens actuator according to a second embodiment of the present invention, viewed from a different direction than FIG. 65.

FIG. 67 is a perspective view of a lens actuator according to a second embodiment of the present invention with the cover omitted.

FIG. 68 is a perspective view illustrating a fixed unit and related components of a lens actuator according to a second embodiment of the present invention.

FIG. 69 is a perspective view illustrating a moving unit and related components of a lens actuator according to a second embodiment of the present invention.

FIG. 70 is a perspective view illustrating a coupling structure of an inner substrate and an outer substrate of a lens actuator according to a second embodiment of the present invention.

FIG. 71 is a bottom perspective view illustrating a moving unit and related components of a lens actuator according to a second embodiment of the present invention.

FIG. 72 is a bottom perspective view illustrating a coupling structure of inner and outer substrates of a lens actuator according to a second embodiment of the present invention.

FIG. 73 is a perspective view of FIG. 69 with a cover removed.

FIG. 74 is a perspective view of FIG. 73 with an OIS moving unit and related components removed.

FIG. 75 is an exploded perspective view of FIG. 74 with wires removed.

FIG. 76 is a perspective view illustrating an OIS moving unit and related components of a lens actuator according to a second embodiment of the present invention.

FIG. 77 is a bottom perspective view viewed from a different direction from FIG. 76.

FIG. 78 is a bottom perspective view of FIG. 69 viewed from a different direction.

FIG. 79 is a bottom view of FIG. 78 with a preload member and an inner substrate removed.

FIG. 80 is a perspective view illustrating a coupling structure of an elastic member, a wire, and a metal member of a lens actuator according to a second embodiment of the present invention.

FIG. 81 is an enlarged view of area I of FIG. 80.

FIG. 82 is a partial perspective view of a lens actuator according to a second embodiment of the present invention with a cover removed.

FIG. 83 is an enlarged view of area A of FIG. 82.

FIG. 84 is an enlarged view of area B of FIG. 82.

FIG. 85 is a bottom perspective view of a driving unit of a lens actuator according to a second embodiment of the present invention.

FIG. 86 is a bottom perspective view of a driving unit of a lens actuator according to a modified embodiment.

FIG. 87 is a cross-sectional perspective view illustrating a coupling structure of a wire and a preload member of a lens actuator according to a second embodiment of the present invention.

FIG. 88 is a cross-sectional view illustrating a coupling structure of a wire and a preload member of a lens actuator according to a second embodiment of the present invention.

FIG. 89 is a plan view of a lens actuator according to a second embodiment of the present invention with a cover removed.

FIG. 90 is a plan view of a portion of FIG. 89 enlarged with a cover omitted.

FIG. 91 is a perspective view illustrating a ball and related components of a lens actuator according to a second embodiment of the present invention.

FIG. 92 is a perspective view illustrating a ball-accommodating structure of a base of a lens actuator according to a second embodiment of the present invention.

FIG. 93 is a perspective view illustrating a state in which a ball, a plate member, an elastic member, and a reinforcing member in FIG. 92 are disposed.

FIG. 94 is a perspective view of FIG. 93 viewed from a different direction.

FIG. 95 is a perspective view illustrating a moving unit and a ball of a lens actuator according to a second embodiment of the present invention.

FIG. 96 is a perspective view of FIG. 95 viewed from a different direction.

FIG. 97A is a drawing comparing the heights of a ball and a pressure point when a moving unit moves upward, and FIG. 97B is a drawing comparing the heights of a ball and a pressure point when a moving unit moves downward.

FIGS. 98 to 100 are drawings for explaining an auto focus driving of a lens actuator according to a second embodiment of the present invention. FIG. 98 is a cross-sectional view illustrating the appearance of a moving unit in an initial state where no current is applied to an AF coil. FIG. 99 is a cross-sectional view illustrating the appearance where a moving unit moves upward in an optical axis direction when a forward current is applied to an AF coil. FIG. 100 is a cross-sectional view illustrating the appearance where a moving unit moves downward in an optical axis direction when a reverse current is applied to an AF coil.

FIGS. 101 to 103 are diagrams for explaining the handshake correction driving of a lens actuator according to a second embodiment of the present invention. FIG. 101 is a cross-sectional view illustrating the appearance of an OIS moving unit in an initial state in which no current is applied to an OIS-x coil and an OIS-y coil. FIG. 102 is a cross-sectional view illustrating the appearance in which an OIS moving unit moves in an x-axis direction perpendicular to the optical axis when a current is applied to an OIS-x coil. FIG. 103 is a cross-sectional view illustrating the appearance in which an OIS moving unit moves in a y-axis direction perpendicular to both an optical axis and an x-axis when a current is applied to an OIS-y coil.

FIG. 104 is an exploded perspective view of a camera device according to a second embodiment of the present invention.

FIG. 105 is a perspective view of an optical instrument according to a second embodiment of the present invention.

FIG. 106 is a perspective view of an optical instrument according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised.

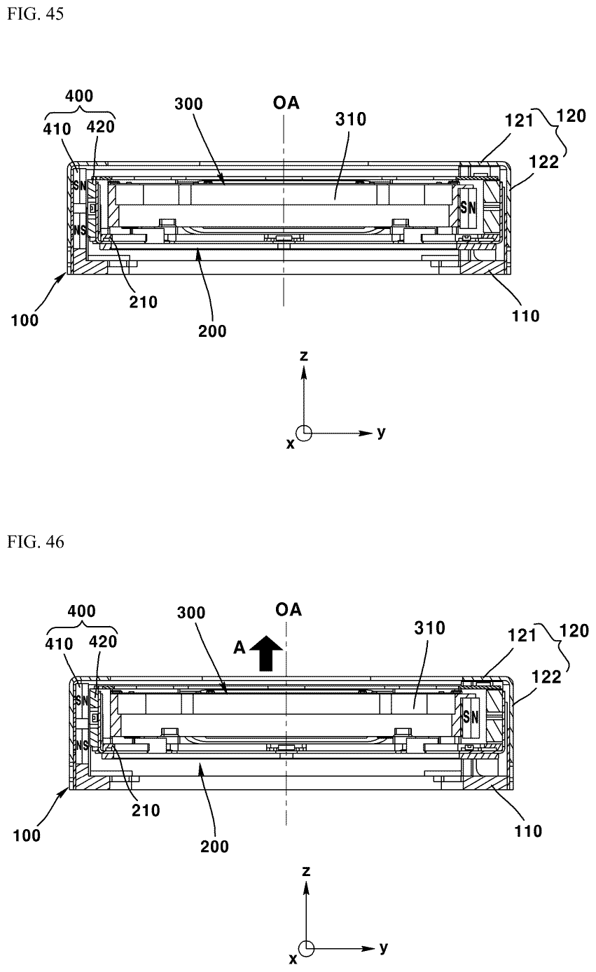

The ‘optical axis (See OA in FIG. 45) direction’ used below is defined as the optical axis direction of the lens and/or image sensor being coupled to the lens actuator.

The ‘vertical direction’ used below may be a direction parallel to or the same direction as the optical axis direction. The vertical direction may correspond to the ‘z-axis direction’. The ‘horizontal direction’ used below may be a direction perpendicular to the vertical direction. That is, the horizontal direction may be a direction perpendicular to the optical axis. Therefore, the horizontal direction may comprise the ‘x-axis direction’and the ‘y-axis direction’.

Hereinafter, one of the ‘x-axis direction’ and the ‘y-axis direction’ may be referred to as the ‘first direction’and the other may be referred to as the ‘second direction’.

The ‘auto focus (AF) function’ used hereinafter is defined as a function that automatically focuses on a subject by adjusting the distance from the image sensor by moving the lens in the optical axis direction according to the distance of the subject so that a clear image of the subject can be obtained on the image sensor. In addition, ‘closed-loop auto focus (CLAF) control’ is defined as detecting the distance between the image sensor and the lens and controlling the position of the lens through feedback in real time in order to improve the accuracy of focus adjustment.

The ‘optical image stabilization (OIS) function’ used hereinafter is defined as a function that moves or tilts the lens in a direction perpendicular to the optical axis to offset hand shake in order to prevent an image or video from shaking due to the user's hand shake. In addition, ‘closed-loop auto focus (CLAF) control’ is defined as detecting the position of the lens with respect to the image sensor and controlling the feedback of the lens position in real time in order to improve the accuracy of hand shake correction.

Hereinafter, one of the “AF moving unit 200” and the “OIS moving unit 300” is referred to as a “first moving unit” and the other may be referred to as a “second moving unit”. Hereinafter, one of the “AF driving unit” and the “OIS driving unit” may be referred to as a “first driving unit” and the other may be referred to as a “second driving unit.” Hereinafter, one among the “AF driving unit”, the “OIS-x driving unit”, and the “OIS-y driving unit” is referred to as a “first driving unit”, the other is referred to as a “second driving unit”, and yet the other may be referred to as a “third driving unit”.

Hereinafter, one among the “AF magnet 410”, the “OIS-x magnet 510”, and the “OIS-y magnet 610” may be referred to as a “first magnet”, the other is referred to as a “second magnet”, and yet the other may be referred to as a “third magnet”.

Hereinafter, one among the “AF coil 420”, the “OIS-x coil 520”, and the “OIS-y coil 620” is referred to as a “first coil”, the other is referred to as a “second coil”, and yet the other may be referred to as a “third coil”.

Hereinafter, one of the “outer substrate 710” and the “inner substrate 720” may be referred to as a “first substrate” and the other may be referred to as a “second substrate”.

Hereinafter, one of the “AF guide ball 810” and the “OIS guide ball 820” may be referred to as a “first ball” and the other may be referred to as a “second ball”.

Hereinafter, one of the “holder member 220” and the “preload member 230” may be referred to as a “first member” and the other as a “second member.” Or, hereinafter, one of the “holder member 220” and the “preload member 230” may be referred to as a “first housing” and the other as a “second housing.”

Hereinafter, one among the “AF sensor 430”, the “OIS-x sensor 530”, and the “OIS-y sensor 630” is referred to as a “first sensor”, the other is referred to as a “second sensor”, and yet the other may be referred to as a “third sensor”.

Hereinafter, one among the “AF yoke 440”, the “OIS-x yoke 540”, and the “OIS-y yoke 640” may be referred to as a “first yoke”, the other may be referred to as a “second yoke”, and yet the other may be referred to as a “third yoke”.

Hereinafter, one of the individual balls of the AF guide ball 810 and the individual balls of the OIS guide ball 820 may be referred to as a “first unit ball,” the other as a “second unit ball,” yet the other as a “third unit ball,” and still the other as a “fourth unit ball.” Furthermore, the “nth unit ball” may be used to refer to as an individual ball, such as a “fifth unit ball,” a “sixth unit ball,” and the like.

Hereinafter, one of the “pillar part 111” and the “outer wall part 112” is referred to as a “first portion” and the other may be referred to as a “second portion”.

Hereinafter, one of the “inner groove 111-1” and the “outer groove 112-1” is referred to as a “first groove” and the other may be referred to as a “second groove”.

Hereinafter, one of the “inner groove 224-1” and the “outer groove 224-2” is referred to as a “first groove” and the other may be referred to as a “second groove”.

Hereinafter, one of the “inner ball 811” and the “outer ball 812” is referred to as a “first unit ball” and the other may be referred to as a “second unit ball”.

Hereinafter, one of the “inner uppermost ball 811-1” and the “outer uppermost ball 812-1” may be referred to as a “first uppermost ball” and the other may be referred to as a “second uppermost ball”.

Hereinafter, one of the “inner lowermost ball 811-2” and the “outer lowermost ball 812-2” may be referred to as a “first lowermost ball” and the other may be referred to as a “second lowermost ball”.

Hereinafter, one among the “upper bent portion 921”, the “lower bent portion 922”, and the “connecting bent portion 923” may be referred to as a “first bent portion”, the other may be referred to as a “second bent portion”, and yet the other may be referred to as a “third bent portion”.

Hereinafter, the “AF carrier 210” may be referred to as a “housing,” Hereinafter, the “OIS carrier 310” may be referred to as a “bobbin.”

Hereinafter, one of the “AF moving unit 1200” and the “OIS moving unit 1300” may be referred to as a “first moving unit” and the other may be referred to as a “second moving unit”.

Hereinafter, one of the “AF driving unit” and the “OIS driving unit” may be referred to as a “first driving unit” and the other may be referred to as a “second driving unit.” Hereinafter, one among the “AF driving unit”, “OIS-x driving unit” and “OIS-y driving unit” may be referred to as a “first driving unit”, the other may be referred to as a “second driving unit” and yet the other may be referred to as a “third driving unit”.

Hereinafter, one among the “AF magnet 1410”, the “OIS-x magnet 1510”, and the “OIS-y magnet 1610” may be referred to as a “first magnet”, the other may be referred to as a “second magnet”, and yet the other may be referred to as a “third magnet”

Hereinafter, one among the “AF coil 1420”, the “OIS-x coil 1520”, and the “OIS-y coil 1620” may be referred to as a “first coil”, the other may be referred to as a “second coil”, and yet the other may be referred to as a “third coil”.

Hereinafter, one of the “outer substrate 1710” and the “inner substrate 1720” may be referred to as a “first substrate” and the other may be referred to as a “second substrate”.

Hereinafter, one of the “AF guide ball 1810” and the “OIS guide ball 1820” may be referred to as a “first ball” and the other may be referred to as a “second ball.” Hereinafter, one of the “holder member 1220” and the “preload member 1230” may be referred to as a “first member” and the other as a “second member.” Or, hereinafter, one of the “holder member 1220” and the “preload member 1230” may be referred to as a “first housing” and the other as a “second housing.”

Hereinafter, one among the “AF sensor 1430”, the “OIS-x sensor 1530”, and the “OIS-y sensor 1630” may be referred to as a “first sensor”, the other may be referred to as a “second sensor”, and yet the other may be referred to as a “third sensor”.

Hereinafter, one of the “AF yoke 1440”, “OIS-x yoke 1540”, and “OIS-y yoke 1640” may be referred to as a “first yoke”, the other may be referred to as a “second yoke”, and yet the other may be referred to as a “third yoke”.

Hereinafter, one of the individual balls of the AF guide ball 1810 and the individual balls of the OIS guide ball 1820 may be referred to as a “first unit ball,” the other as a “second unit ball,” yet the other as a “third unit ball,” and still yet the other as a “fourth unit ball.” Furthermore, the term “unit ball” may be used to refer to individual balls, such as “fifth unit ball,” “sixth unit ball,” and the like.

Hereinafter, one of the “pillar part 1111” and the “outer wall part 1112” may be referred to as a “first portion” and the other may be referred to as a “second portion”.

Hereinafter, one of the “inner groove 1111-1” and the “outer groove 1112-1” may be referred to as a “first groove” and the other as a “second groove”.

Hereinafter, one of the “inner groove 1224-1” and the “outer groove 1224-2” may be referred to as a “first groove” and the other may be referred to as a “second groove”.

Hereinafter, one of the “inner ball 1811” and the “outer ball 1812” may be referred to as a “first unit ball” and the other as a “second unit ball.”

Hereinafter, one of the “inner uppermost ball 1811-1” and the “outer uppermost ball 1812-1” may be called a “first uppermost ball” and the other may be called a “second uppermost ball”.

Hereinafter, one of the “inner lowermost ball 1811-2” and the “outer lowermost ball 1812-2” may be called a “first lowermost ball” and the other may be called a “second lowermost ball”.

Hereinafter, one among the “upper bent portion 1921”, the “lower bent portion 1922”, and the “connecting bent portion 1923” may be referred to as a “first bent portion”, the other may be referred to as a “second bent portion”, and yet the other may be referred to as a “third bent portion”.

Hereinafter, the “AF carrier 1210” may be referred to as a “housing.” Hereinafter, the “OIS carrier 1310” may be referred to as a “bobbin.”Hereinafter, the configuration of a lens actuator according to a first embodiment of the present invention will be described with reference to the drawings.

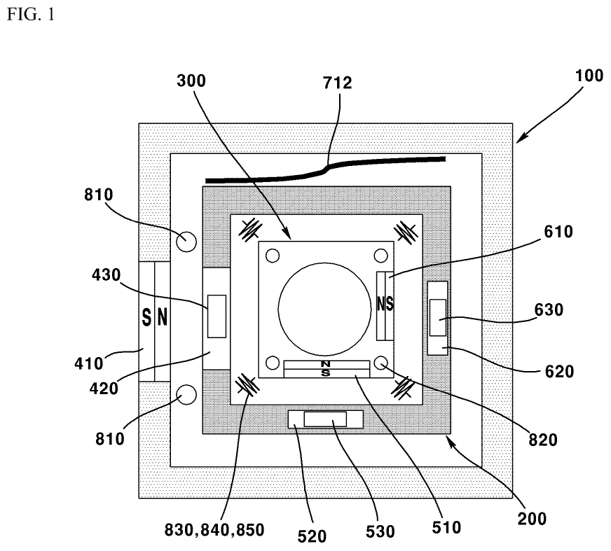

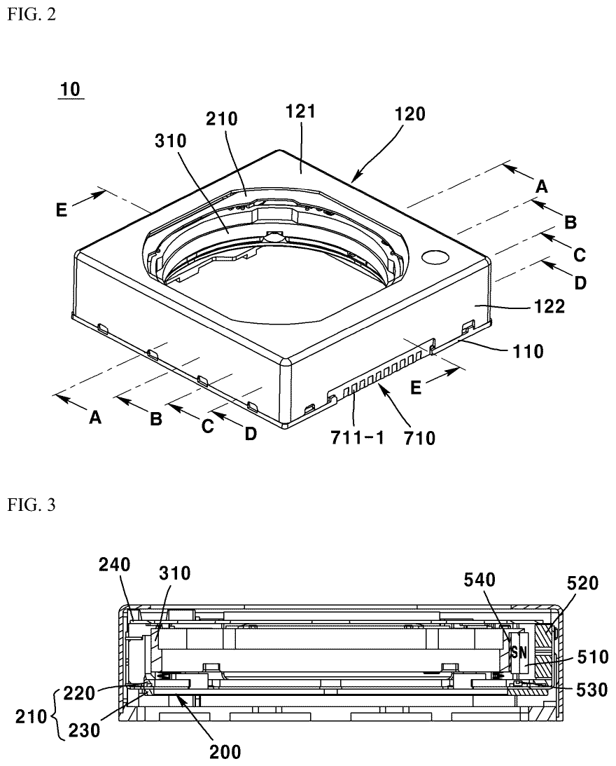

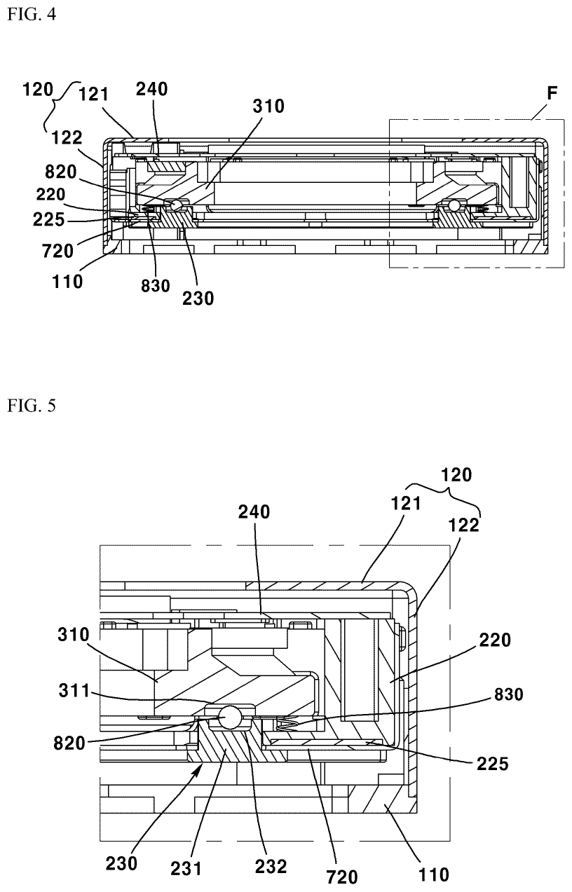

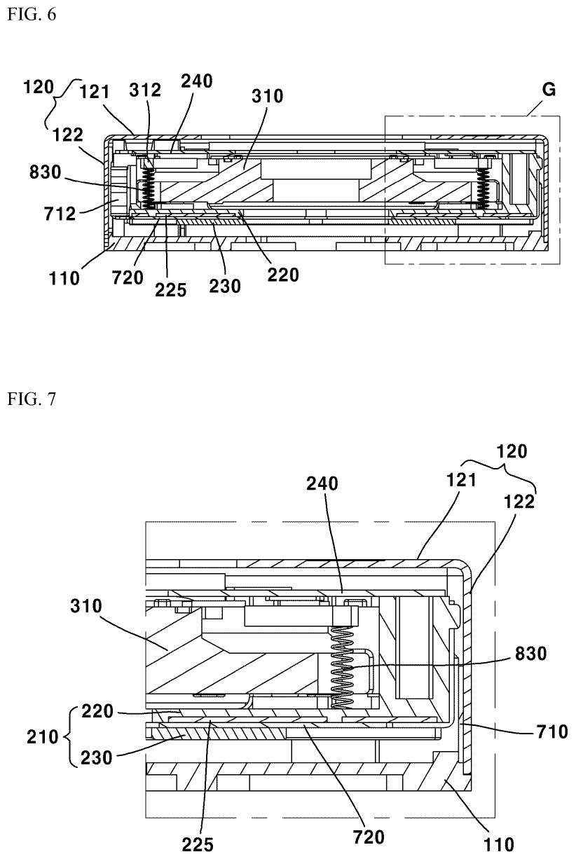

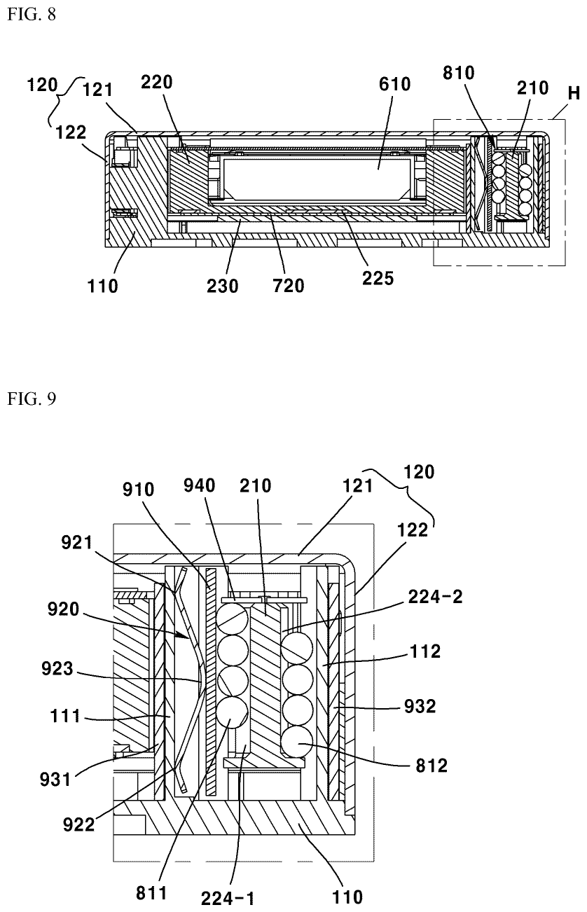

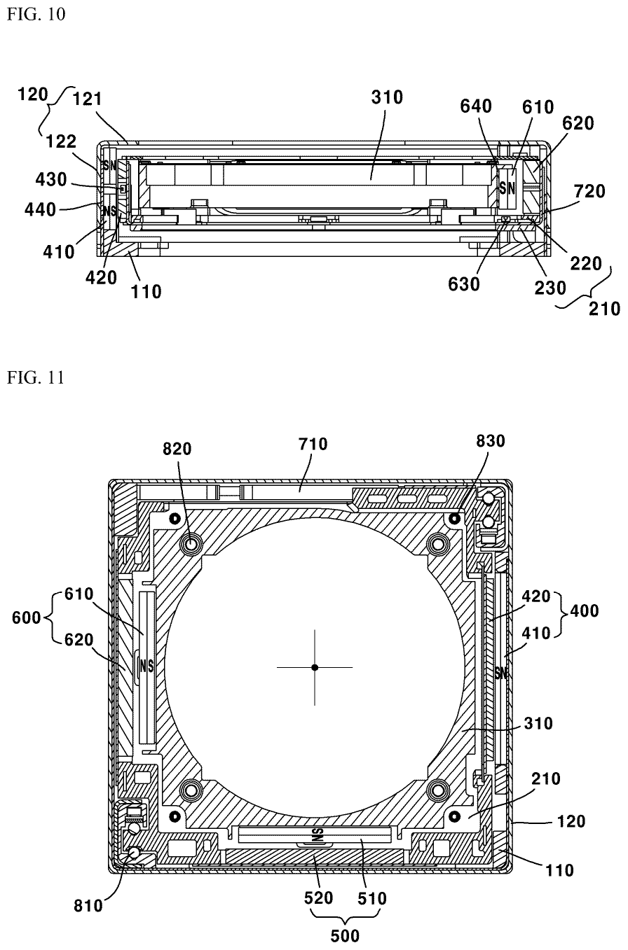

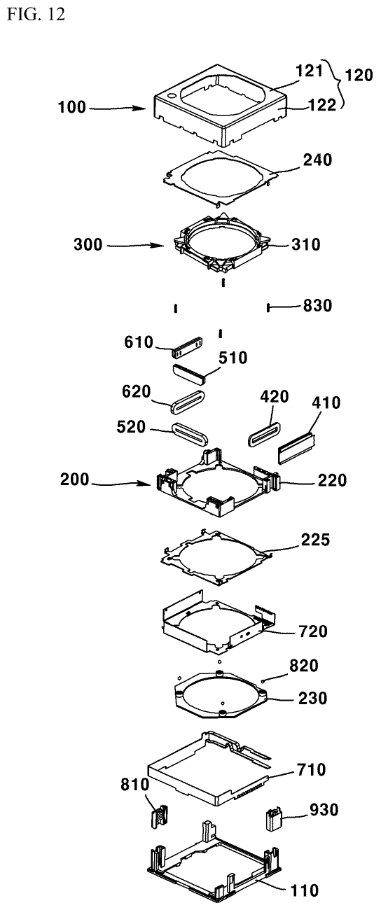

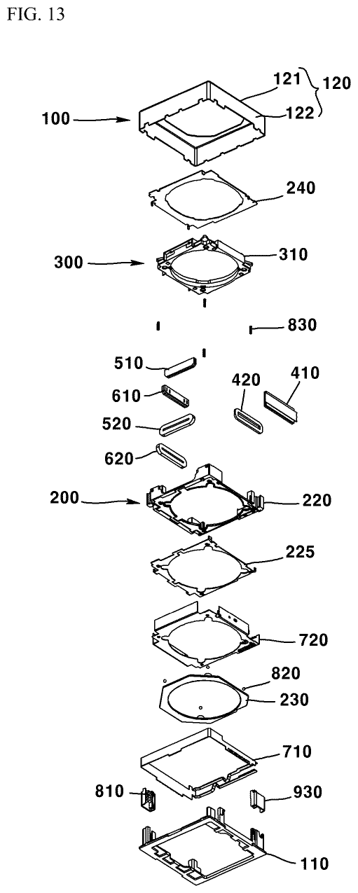

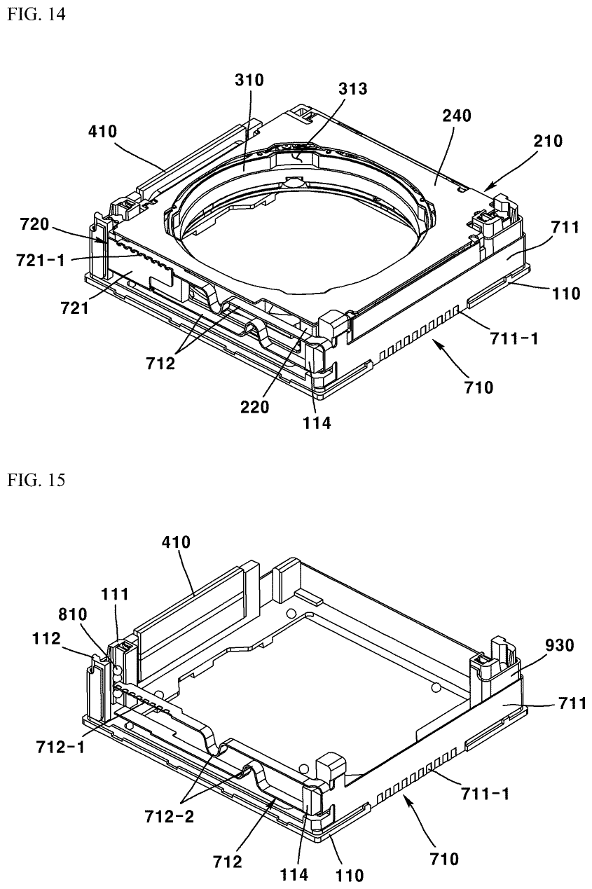

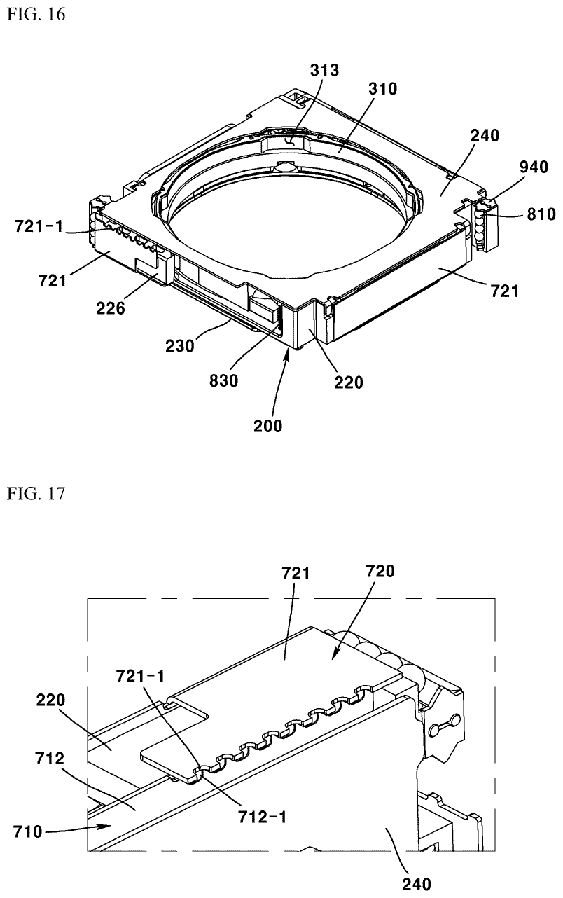

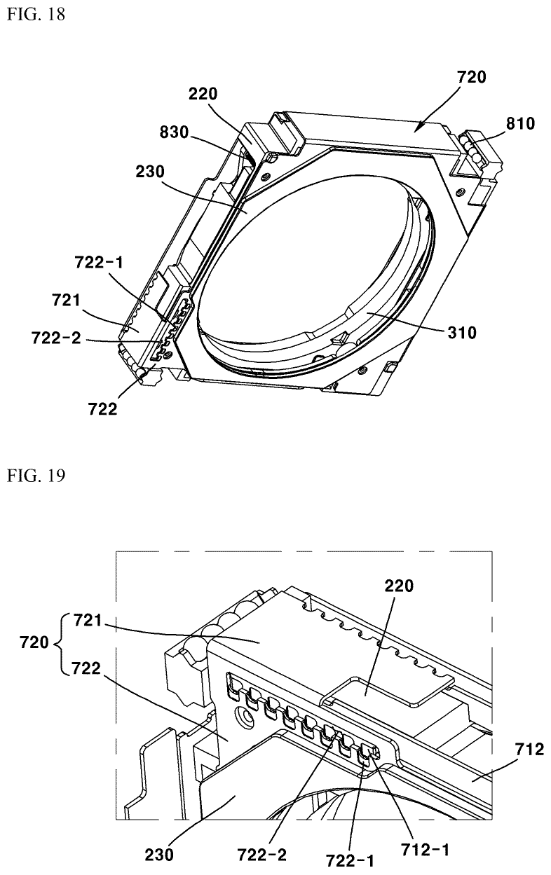

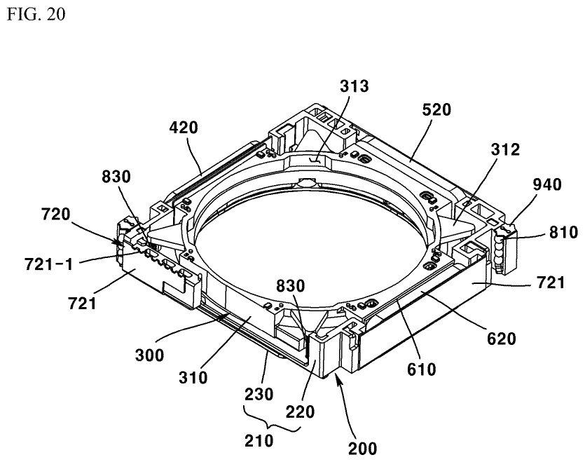

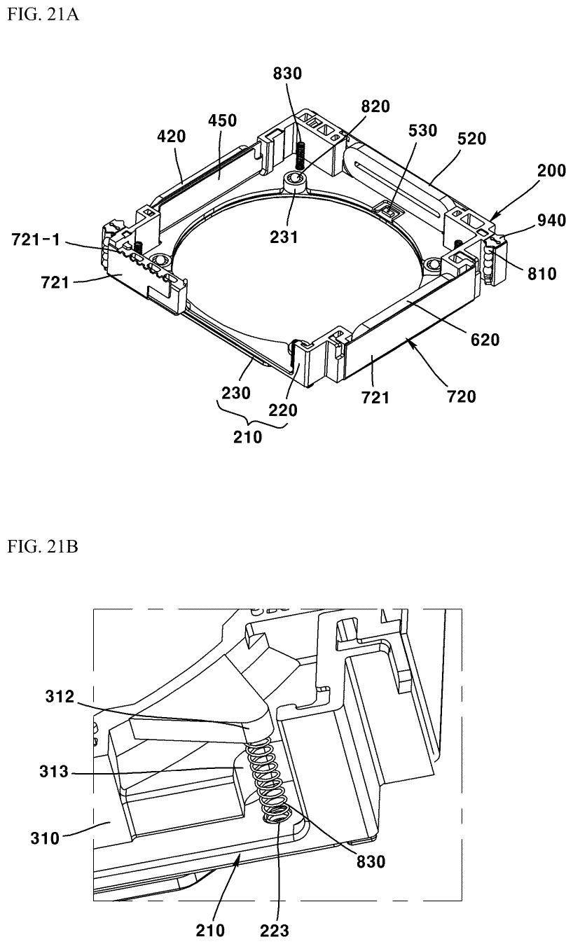

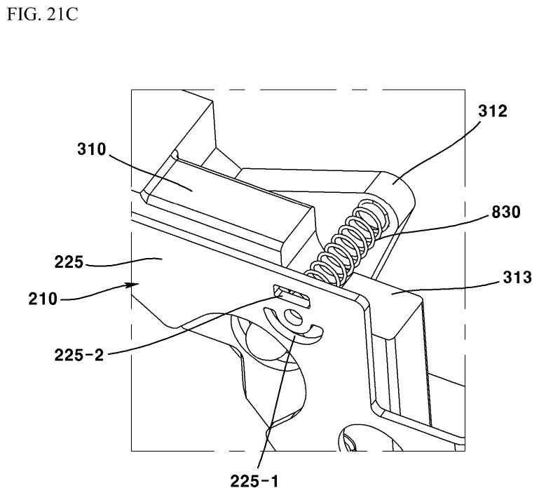

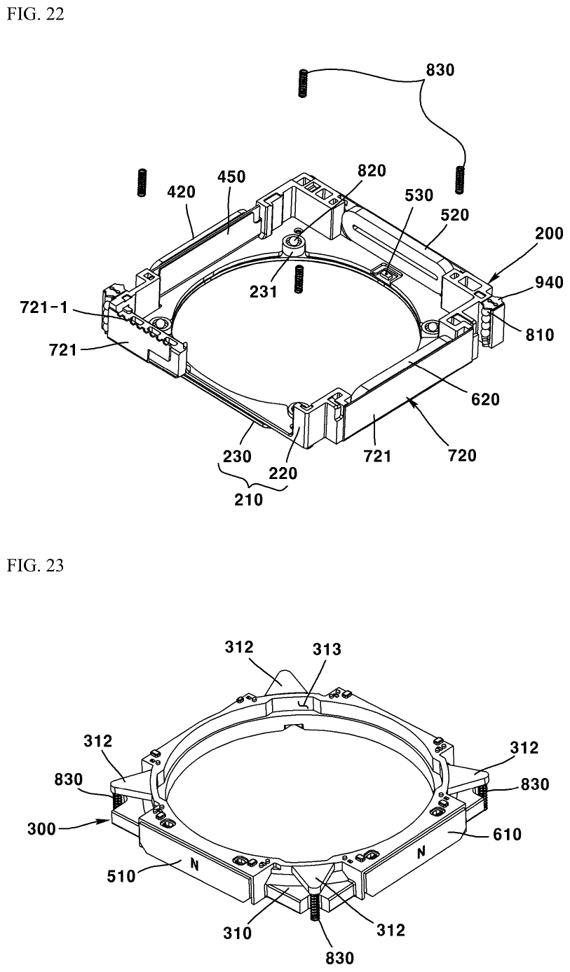

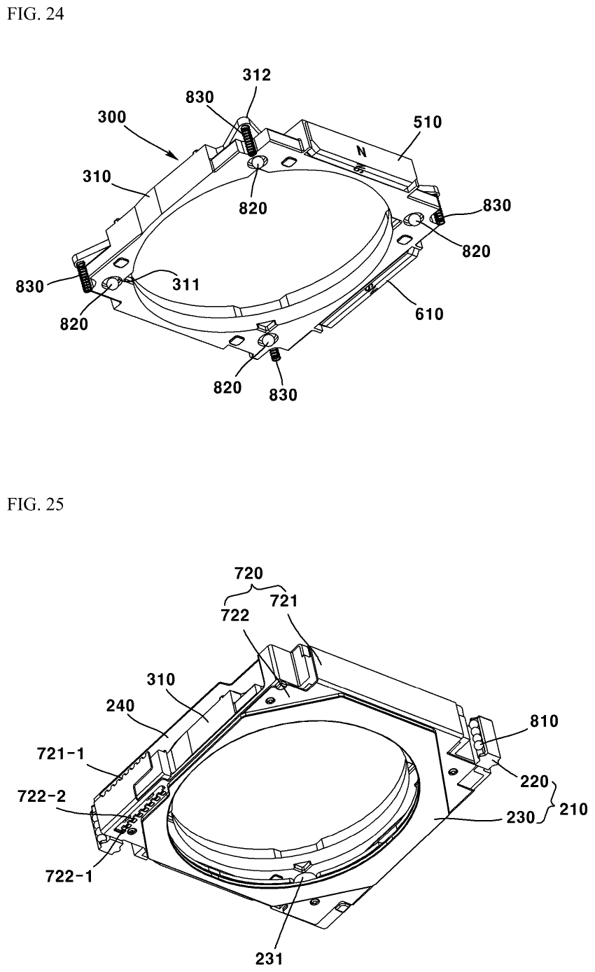

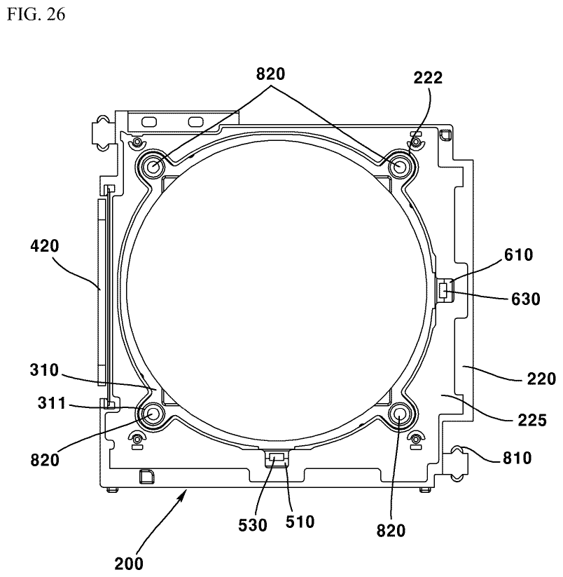

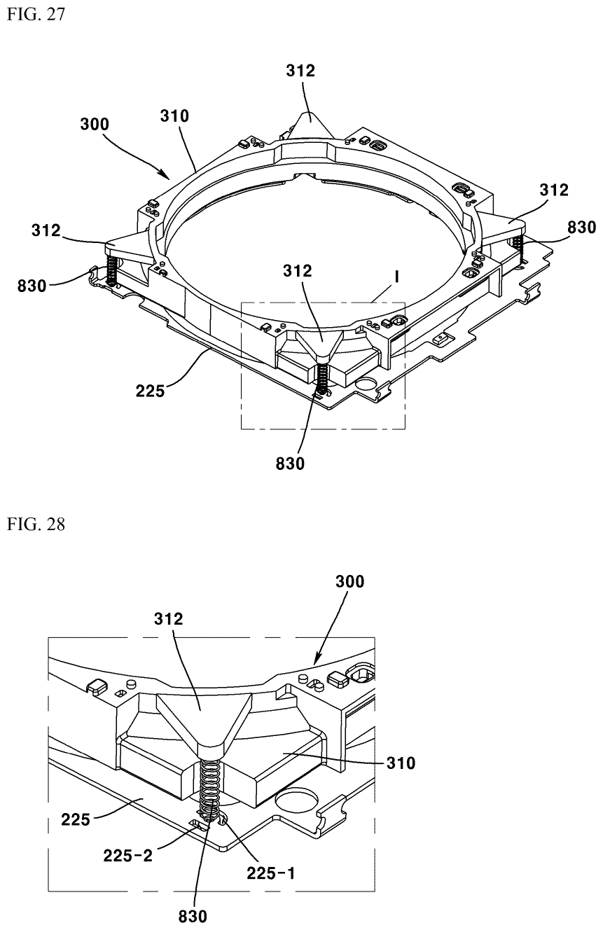

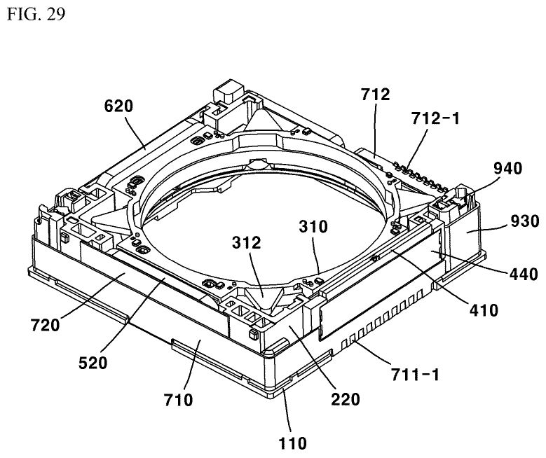

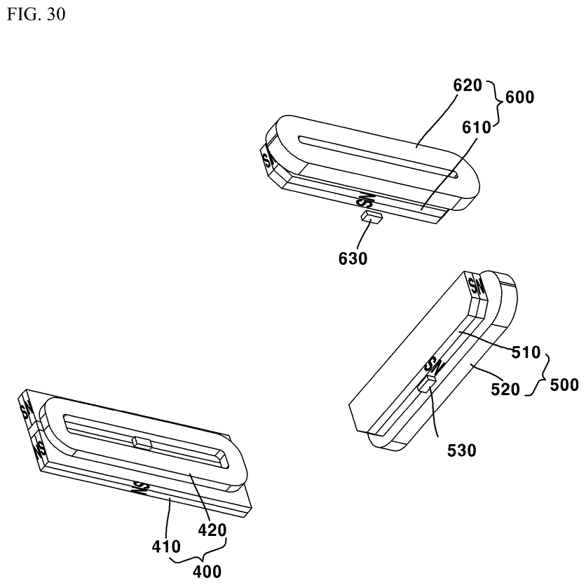

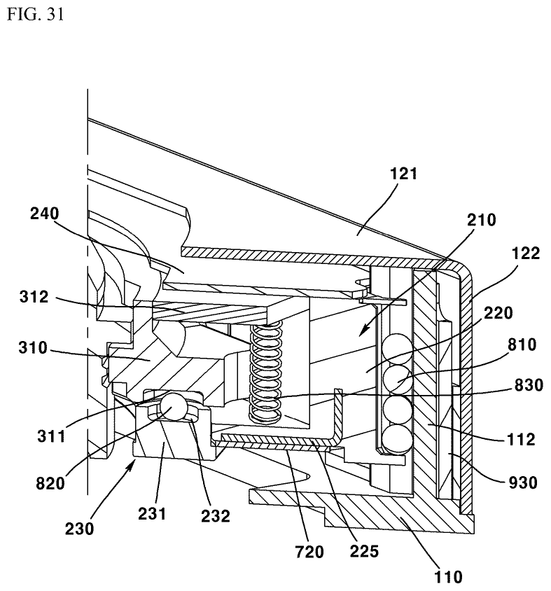

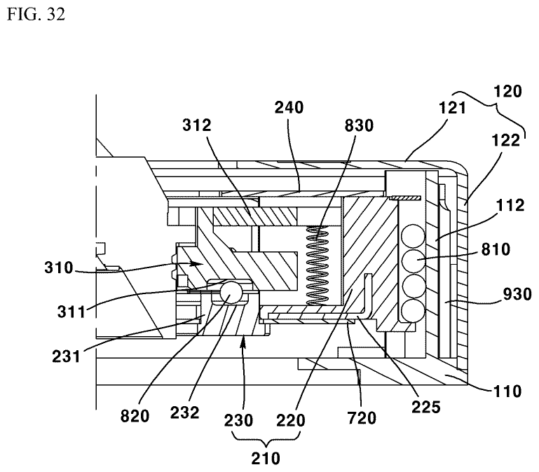

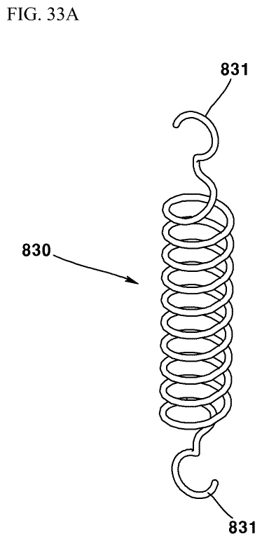

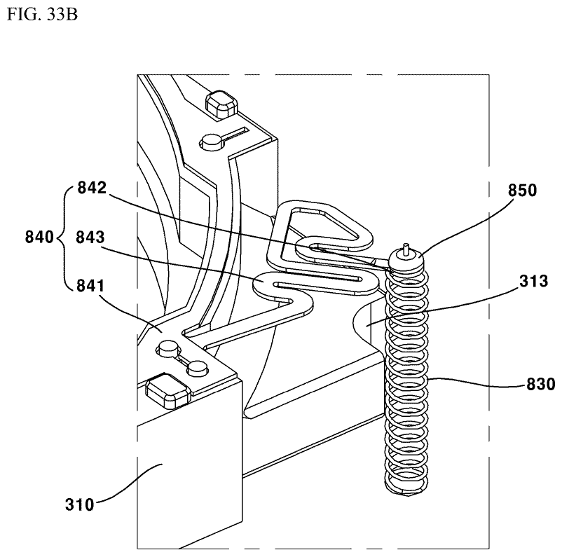

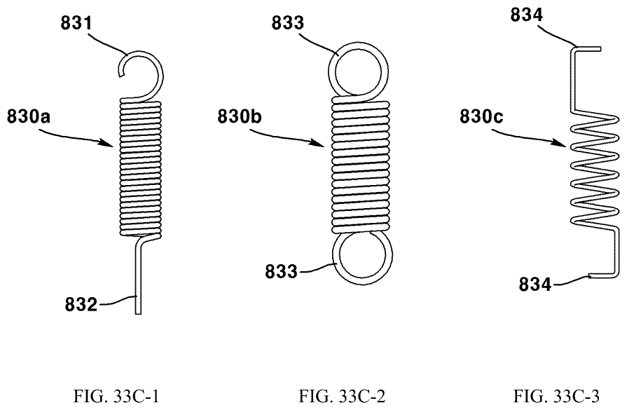

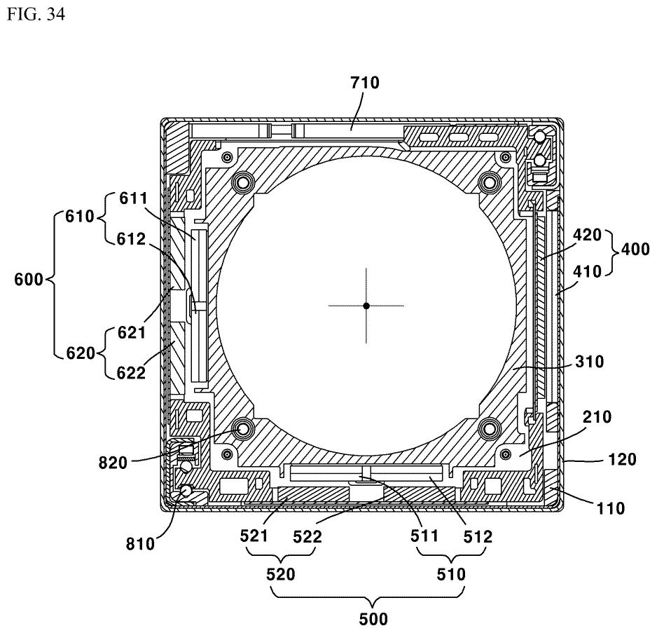

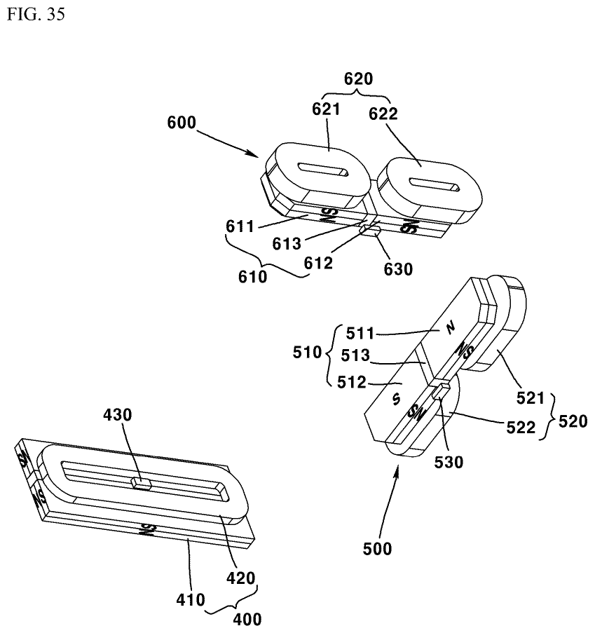

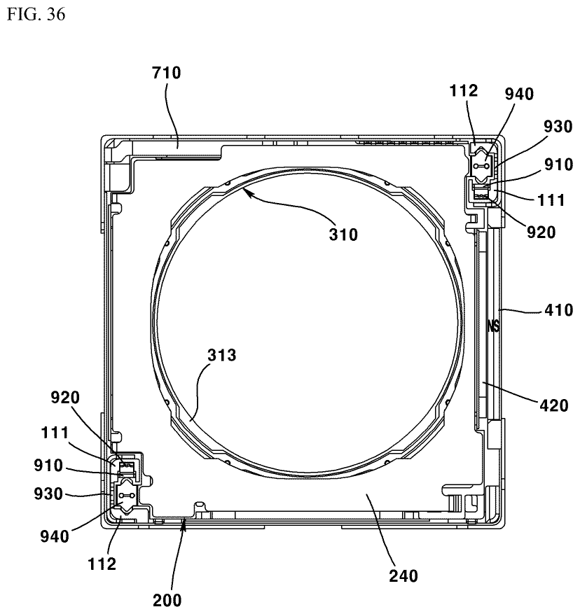

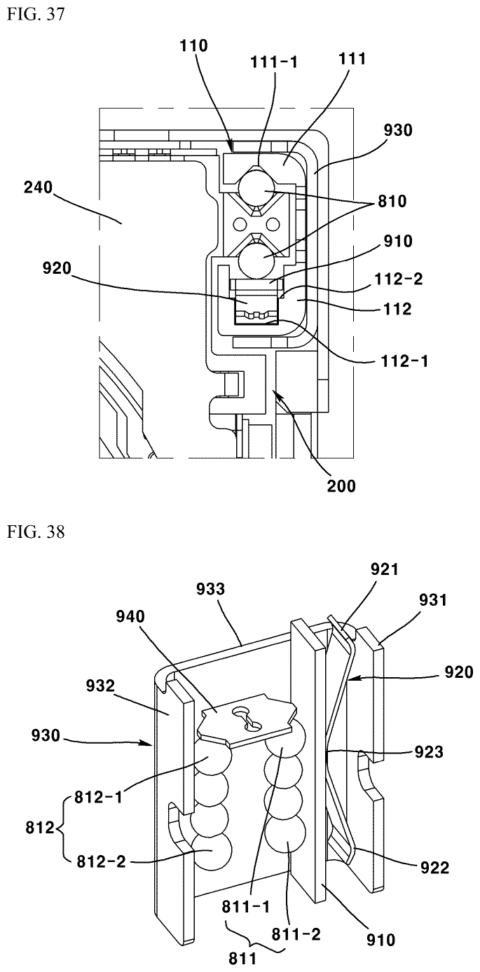

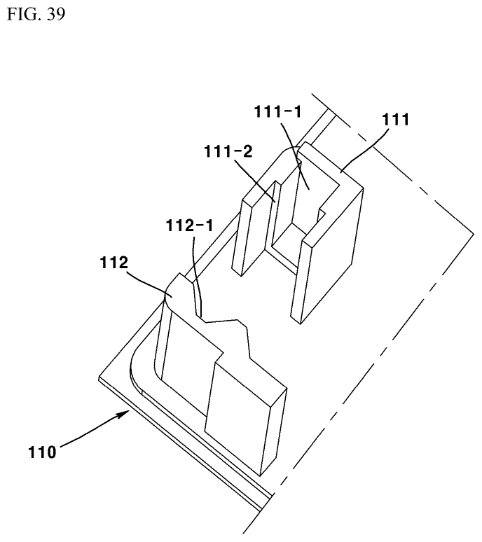

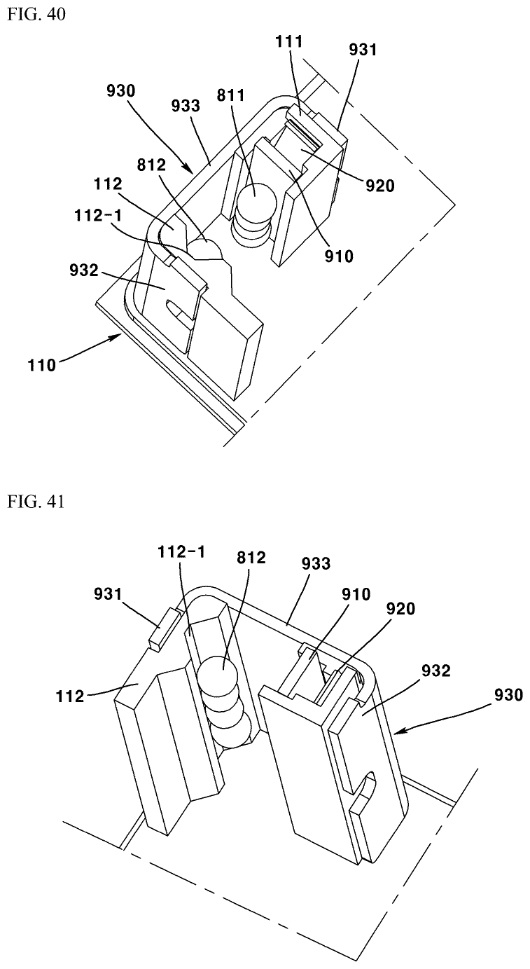

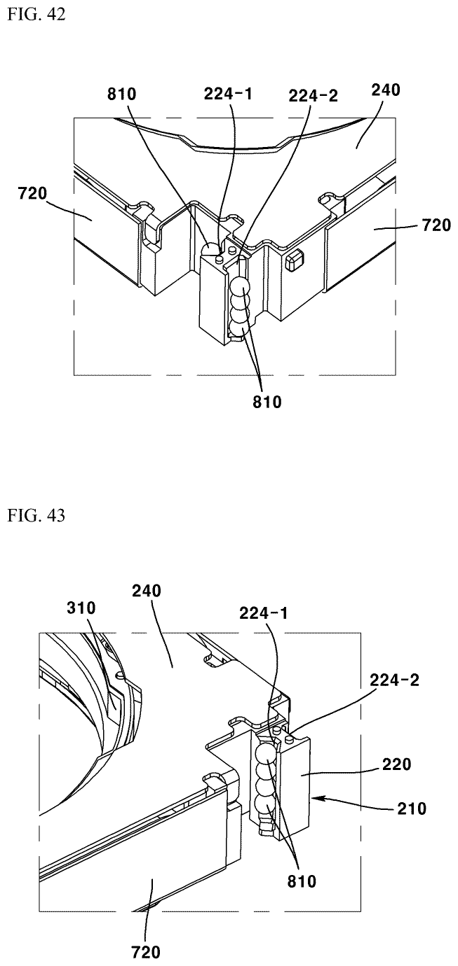

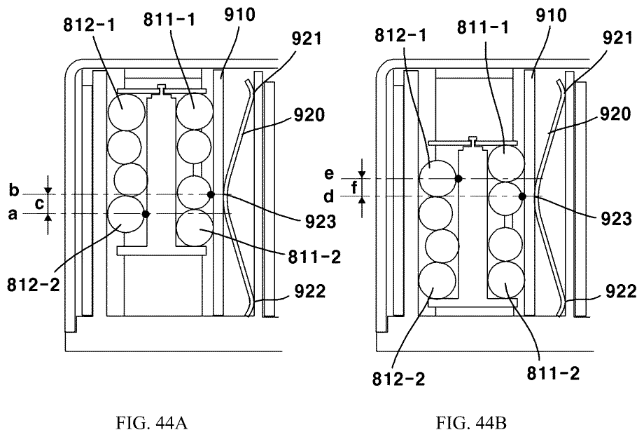

FIG. 1 is a conceptual diagram of a lens actuator according to a first embodiment of the present invention; FIG. 2 is a perspective view of a lens actuator according to a first embodiment of the present invention; FIG. 3 is a cross-sectional view taken along line A-A of FIG. 2; FIG. 4 is a cross-sectional view taken along line B-B of FIG. 2; FIG. 5 is an enlarged view of area F of FIG. 4; FIG. 6 is a cross-sectional view taken along line C-C of FIG. 2; FIG. 7 is an enlarged view of area G of FIG. 6; FIG. 8 is a cross-sectional view taken along line D-D of FIG. 2; FIG. 9 is an enlarged view of area H of FIG. 8; FIG. 10 is a cross-sectional view taken along line E-E of FIG. 2; FIG. 11 is a cross-sectional view of a lens actuator according to a first embodiment of the present invention, cut perpendicular to the optical axis and viewed from above. FIG. 12 is an exploded perspective view of a lens actuator according to a first embodiment of the present invention; FIG. 13 is an exploded perspective view of a lens actuator according to a first embodiment of the present invention, viewed from a different direction than FIG. 12; FIG. 14 is a perspective view of a lens actuator according to a first embodiment of the present invention, with the cover omitted; FIG. 15 is a perspective view illustrating a fixed unit and related components of a lens actuator according to a first embodiment of the present invention; FIG. 16 is a perspective view illustrating a moving unit and related components of a lens actuator according to a first embodiment of the present invention; FIG. 17 is a perspective view illustrating a coupling structure of an inner substrate and an outer substrate of a lens actuator according to a first embodiment of the present invention; FIG. 18 is a bottom perspective view illustrating a moving unit and related components of a lens actuator according to a first embodiment of the present invention; FIG. 19 is a bottom perspective view illustrating a coupling structure of inner and outer substrates of a lens actuator according to a first embodiment of the present invention; FIG. 20 is a perspective view of FIG. 16 with a cover removed; FIG. 21A is a perspective view of FIG. 20 with an OIS moving unit and related components removed; FIG. 21B is an enlarged perspective view of a coupling structure between a coil spring and an AF carrier; FIG. 21C is an enlarged perspective view of a coupling structure between a coil spring and an OIS carrier; FIG. 22 is an exploded perspective view of a coil spring of FIG. 21A with the coil spring removed; FIG. 23 is a perspective view illustrating an OIS moving unit and related components of a lens actuator according to a first embodiment of the present invention; FIG. 24 is a bottom perspective view viewed from a different direction than FIG. 23; FIG. 25 is a bottom perspective view of FIG. 16 viewed from a different direction; FIG. 26 is a bottom view of FIG. 25 with a preload member and an inner substrate removed; FIG. 27 is a perspective view illustrating a coupling structure of an OIS carrier, a coil spring, and a metal member of a lens actuator according to a first embodiment of the present invention; FIG. 28 is an enlarged view of area I of FIG. 27; FIG. 29 is a perspective view of a lens actuator according to a first embodiment of the present invention with a cover and a lid removed; FIG. 30 is a bottom perspective view of a driving unit of the lens actuator according to a first embodiment of the present invention; FIG. 31 is a cross-sectional perspective view illustrating a coupling structure of a coil spring of a lens actuator according to a first embodiment of the present invention; FIG. 32 is a cross-sectional view illustrating a coupling structure of a coil spring of a lens actuator according to a first embodiment of the present invention; FIG. 33A is a front view illustrating a coil spring of a lens actuator according to a modified embodiment; FIG. 33B is a perspective view illustrating a coil spring and its coupling structure of a lens actuator according to another modified embodiment; FIGS. 33C-1, 33C-2, and 33C-3 are drawings illustrating a coil spring according to additional various modified embodiments; FIG. 34 is a cross-sectional view of a lens actuator according to a modified embodiment, cut perpendicular to an optical axis and viewed from above; FIG. 35 is a bottom perspective view of a driving unit of a lens actuator according to a modified embodiment; FIG. 36 is a plan view of a lens actuator according to a first embodiment of the present invention with its cover removed; FIG. 37 is a plan view of a portion of FIG. 36 enlarged with a cover omitted; FIG. 38 is a perspective view illustrating a ball and related components of a lens actuator according to a first embodiment of the present invention; FIG. 39 is a perspective view illustrating a ball accommodating structure of a base of a lens actuator according to a first embodiment of the present invention; FIG. 40 is a perspective view illustrating a state in which a ball, a plate member, an elastic member, and a reinforcing member in FIG. 39 are disposed; FIG. 41 is a perspective view of FIG. 40 viewed from a different direction; FIG. 42 is a perspective view of a moving unit and a ball of a lens actuator according to a first embodiment of the present invention; FIG. 43 is a perspective view of FIG. 42 viewed from a different direction; and FIG. 44A is a drawing comparing the heights of a ball and a pressure point when a moving unit moves upward, and FIG. 44B is a drawing comparing the heights of a ball and a pressure point when a moving unit moves downward.

The lens actuator 10 may be a voice coil motor (VCM). The lens actuator 10 may be a lens drive motor. The lens actuator 10 may be a lens drive actuator. The lens actuator 10 may comprise an AF module. The lens actuator 10 may comprise an OIS module.

The lens actuator 10 may comprise a fixed unit 100. The fixed unit 100 may be a portion that is relatively fixed when the moving unit moves. The moving unit may move against the fixed unit 100.

The lens actuator 10 may comprise a base 110. The fixed unit 100 may comprise a base 110. The base 110 may be disposed below the AF carrier 210. The base 110 may be disposed below the OIS carrier 310. The base 110 may be coupled to the cover 120. The AF carrier 210 and the OIS carrier 310 may be disposed on the base 110. The AF carrier 210 and the OIS carrier 310 may be disposed on the lower plate portion of the base 110. The AF carrier 210 and the OIS carrier 310 may be disposed within the base 110. The AF carrier 210 and the OIS carrier 310 may be disposed within a side wall portion of the base 110.

The base 110 may comprise a lower plate portion. The lower plate portion of the base 110 may support the lower surface of the AF moving unit 200. The lower plate portion of the base 110 may support the lower surface of the AF carrier 210.

The base 110 may comprise a pillar part 111. The pillar part 111 may be extended from an upper surface of the lower plate portion. The pillar part 111 may be disposed on an inner side of the outer wall part 112.

The base 110 may comprise a first guide that guides the AF guide ball 810 to move. The first guide may comprise an inner groove 111-1 of the base 110. The first guide may comprise an outer groove 112-1 of the base 110.

The base 110 may comprise an inner groove 111-1. The pillar part 111 may comprise an inner groove 111-1. The inner groove 111-1 may be formed in the pillar part 111. The inner groove 111-1 may be an ‘AF guide ball accommodating groove’. An AF guide ball 810 may be disposed in the inner groove 111-1. The inner ball 811 may be disposed in the inner groove 111-1. The inner groove 111-1 may be in direct contact with the AF guide ball 810. The inner groove 111-1 may be disposed in an optical axis direction. The inner groove 111-1 may comprise a plurality of grooves. The inner groove 111-1 may comprise two grooves. The two grooves may be disposed parallel to each other. The two grooves can be disposed diagonally with respect to the optical axis.

The base 110 may comprise a step 111-2. The step 111-2 may be formed in the pillar part 111. A plate member 910 may be disposed on the step 111-2.

The base 110 may comprise an outer wall part 112. The outer wall part 112 may be a ‘side’. The outer wall part 112 may be a ‘side plate’. The outer wall part 112 may be a ‘side wall’. The outer wall part 112 of the base 110 may be extended from an upper surface of the lower plate portion.

The base 110 may comprise an outer groove 112-1. The outer wall part 112 may comprise an outer groove 112-1. The outer groove 112-1 may be formed to face the inner groove 111-1. The outer groove 112-1 may be disposed to face the inner groove 111-1. The outer groove 112-1 may be an ‘AF guide ball accommodating groove’. An AF guide ball 810 may be disposed in the outer groove 112-1. An outer ball 812 may be disposed in the outer groove 112-1. The outer groove 112-1 may be in direct contact with the AF guide ball 810. The outer groove 112-1 may be disposed in an optical axis direction. The outer groove 112-1 may comprise a plurality of grooves. The outer groove 112-1 may comprise two grooves. The two grooves may be disposed parallel to each other. The two grooves may be disposed diagonally with respect to the optical axis. The outer groove 112-1 may be disposed at an opposite side of the inner groove 111-1. The outer groove 112-1 may be formed to have a shape corresponding to the inner groove 111-1. The outer groove 112-1 and the inner groove 111-1 may be formed to have the same length in an optical axis direction.

The base 110 may comprise a protruded portion 114. The protruded portion 114 may be protruded outward. A connecting portion 712 of an outer substrate 710 may be disposed above and below the protruded portion 114. A groove may be formed in the protruded portion 114 so as not to interfere with the connecting portion 712 of the outer substrate 710 even when it moves.

The base 110 may comprise a step. The step may be formed at the lower end of the outer side surface of the base 110. The step may be protruded from an outer side surface of the base 110. A side plate 122 of the cover 120 may be disposed in the step of the base 110.

The lens actuator 10 may comprise a cover 120. The fixed unit 100 may comprise a cover 120. The cover 120 may be disposed in the base 110. The cover 120 may be disposed on the base 110. The cover 120 may be coupled to the base 110. The cover 120 may be fixed to the base 110. The cover 120 may accommodate an AF carrier 210 therein. The cover 120 may accommodate an OIS carrier 310 therein. The cover 120 may be a shield member. The cover 120 may be a shield can.

The cover 120 may comprise an upper plate 121. The upper plate 121 may be on a moving unit. The upward movement of the moving unit may be limited by the moving unit being in contact with the upper plate 121. The upper plate 121 may comprise a hole through which light passes.

The cover 120 may comprise a side plate 122. The side plate 122 may be extended from the upper plate 121. The side plate 122 may be disposed in the base 110. The side plate 122 may be disposed on a step portion being protrudedly formed from the lower end portion of the outer side surface of the base 110. The side plate 122 may comprise a plurality of side plates. The side plate 122 may comprise four side plates. The side plate 122 may comprise a first side plate and a second side plate disposed opposite to each other and a third side plate and a fourth side plate disposed opposite to each other.

The lens actuator 10 may comprise a moving unit. The moving unit may be disposed in the fixed unit 100. The moving unit may be disposed within the fixed unit 100. The moving unit may be disposed on the fixed unit 100. The moving unit may be movably disposed in the fixed unit 100. The moving unit may be moved with respect to the fixed unit 100 by the driving unit. The moving unit may be moved during AF driving. The moving unit may be moved during OIS driving. A lens may be coupled to the moving unit.

The lens actuator 10 may comprise an AF moving unit 200. The AF moving unit 200 may be disposed in the fixed unit 100. The AF moving unit 200 may be disposed within the fixed unit 100. The AF moving unit 200 may be disposed on the fixed unit 100. The AF moving unit 200 may be disposed between the fixed unit 100 and the OIS moving unit 300. The AF moving unit 200 may be movably disposed in the fixed unit 100. The AF moving unit 200 may move in an optical axis direction against the fixed unit 100 by the AF driving unit 400. The AF moving unit 200 may move during AF driving.

In a modified embodiment, the AF moving unit 200 and the AF driving unit 400 may be omitted. That is, the OIS moving unit 300 may be disposed in the fixed unit 100. Or, the OIS moving unit 300 may be disposed on the fixed unit 100 and the AF moving unit 200 may be disposed within the OIS moving unit 300.

The lens actuator 10 may comprise an AF carrier 210. The AF moving unit 200 may comprise the AF carrier 210. The AF carrier 210 may be an ‘AF holder’. The AF carrier 210 may be a ‘housing’. The AF carrier 210 may be disposed within the base 110. The AF carrier 210 may be disposed on the base 110. The AF carrier 210 may be disposed within the cover 120. The AF carrier 210 may be disposed between the base 110 and the OIS carrier 310. The AF carrier 210 may be movably disposed in an optical axis direction.

The AF carrier 210 may comprise a frame, a first upper plate, and a second upper plate. At this time, the frame may be a body part. The frame may be a holder member 220. The first upper plate may be a metal member 225. The second upper plate may be a preload member 230. The AF carrier 210 may be a housing. The housing may comprise a first housing and a second housing. At this time, the first housing may comprise a holder member 220 and the second housing may comprise a preload member 230. The OIS carrier 310 may be a bobbin. The OIS guide ball 820 may be disposed between the housing and the bobbin. The AF guide ball 810 may be disposed between a side surface of the housing and a cover 120. The AF guide ball 810 can be disposed between the side surface of the housing and the base or the pillar of the base.

The lens actuator 10 may comprise a holder member 220. The AF carrier 210 may comprise a holder member 220. The holder member 220 may be formed separately from the preload member 230. A wire 850 may be coupled to the holder member 220.

The AF carrier 210 may comprise a lower plate. The lower plate may be disposed below the OIS carrier 310. The lower plate may be disposed between the OIS carrier 310 and the base 110.

The AF carrier 210 may comprise a groove 222. The groove 222 may be a ‘preload member passage hole’. The holder member 220 may comprise a groove 222. The lower plate of the holder member 220 may comprise a groove 222. The groove 222 may be formed in the lower plate of the holder member 220. The groove 222 may be open inward. The preload member 230 may be inserted into the groove 222. The protruded portion 231 of the preload member 230 may be inserted into the groove 222. The groove 222 may be formed as a hole. The groove 222 may be redisposed with a hole. That is, in a modified embodiment, the AF carrier 210 may comprise a groove 222 into which the protruded portion 231 of the preload member 230 is inserted.

The AF carrier 210 may comprise a hole 223. The AF carrier 210 may comprise a hole 223 through which a coil spring 830 passes. The AF carrier 210 may comprise a hole 223 in which the coil spring 830 is disposed. The AF carrier 210 may comprise a hole 223 in which the lower end portion of the coil spring 830 is disposed.

The AF carrier 210 may comprise a side wall. The side wall may be extended downward from the upper plate. An inner substrate 720 may be disposed on the side wall. An AF coil 420 may be disposed on the side wall. An OIS-x coil 520 may be disposed on the side wall. An OIS-y coil 620 may be disposed on the side wall. The side wall may comprise a groove for avoiding the coil. The side wall may comprise a plurality of side walls. The side wall may comprise four side walls. The side wall may comprise a first side wall and a second side wall being disposed opposite to each other and a third side wall and a fourth side wall being disposed opposite to each other.

The AF carrier 210 may comprise a second guide that guides the AF guide ball 810 to move. The second guide may comprise an inner groove 224-1 of the AF carrier 210. The second guide may comprise an outer groove 224-2 of the AF carrier 210.

The AF carrier 210 may comprise an inner groove 224-1. The holder member 220 may comprise an inner groove 224-1. The inner groove 224-1 may be an ‘AF guide ball accommodating groove’. An AF guide ball 810 may be disposed in the inner groove 224-1. An inner ball 811 may be disposed in the inner groove 224-1. The inner groove 224-1 may be in direct contact with the AF guide ball 810. The inner groove 224-1 may be disposed in an optical axis direction. The inner groove 224-1 may guide the AF guide ball 810 to move in an optical axis direction. The inner groove 224-1 may comprise a plurality of grooves. The inner groove 224-1 may comprise two grooves. The two grooves may be disposed parallel to each other. The two grooves can be disposed diagonally with respect to the optical axis.

The AF carrier 210 may comprise an outer groove 224-2. The holder member 220 may comprise an outer groove 224-2. The outer groove 224-2 may be an ‘AF guide ball accommodating groove’. An AF guide ball 810 may be disposed in the outer groove 224-2. An outer ball 812 may be disposed in the outer groove 224-2. The outer groove 224-2 may be in direct contact with the AF guide ball 810. The outer groove 224-2 may be disposed in an optical axis direction. The outer groove 224-2 may guide the AF guide ball 810 to move in an optical axis direction. The outer groove 224-2 may comprise a plurality of grooves. The outer groove 224-2 may comprise two grooves. The two grooves may be disposed parallel to each other. The two grooves can be disposed diagonally with respect to the optical axis. The outer groove 224-2 can be disposed opposite to the inner groove 224-1. The outer groove 224-2 can have a shape corresponding to that of the inner groove 224-1. The outer groove 224-2 and the inner groove 224-1 can be formed to have the same length in an optical axis direction.

The AF carrier 210 may comprise a metal member 225. The holder member 220 may comprise the metal member 225. The metal member 225 may be coupled to the lower plate 221 of the AF moving unit 200. The holder member 220 may comprise a lower plate having the metal member 225. The metal member 225 may be disposed in the holder member 220. The metal member 225 may be insert-molded into the holder member 220. At least a portion of the metal member 225 may be disposed on an upper surface of the holder member 220. At least a portion of the metal member 225 may be disposed on a lower surface of the holder member 220. At least a portion of the metal member 225 may be exposed to the surface of the holder member 220. A metal member 225 may be disposed to reinforce the strength of the holder member 220.

The metal member 225 may comprise a hole. A wire 850 may be disposed in the hole. The wire 850 may pass through the hole of the metal member 225.

The metal member 225 may comprise a first hole 225-1. The first hole 225-1 may be disposed adjacent to the wire 850. The first hole 225-1 may be disposed adjacent to a hole through which the wire 850 passes. The first hole 225-1 may be disposed adjacent to a conductive member that connects the wire 850 and the metal member 225. The conductive member that connects the wire 850 and the metal member 225 may be introduced into the first hole 225-1. Solder that connects the wire 850 and the metal member 225 may be introduced into the first hole 225-1. The first hole 225-1 may be formed to have a curvature. The first hole 225-1 may be formed in a U-shape when viewed from below. The first hole 225-1 may comprise a curved shape when viewed from below.

The metal member 225 may comprise a second hole 225-2. The second hole 225-2 may be disposed adjacent to the wire 850. The second hole 225-2 may be disposed adjacent to a hole through which the wire 850 passes. The second hole 225-2 may be disposed adjacent to a conductive member that connects the wire 850 and the metal member 225. The conductive member that connects the wire 850 and the metal member 225 may be introduced into the second hole 225-2. The second hole 225-2 may be disposed at an opposite side of the first hole 225-1 with respect to the wire 850. The second hole 225-2 may be disposed at an opposite side of the first hole 225-1 with respect to the hole of the metal member 225 in which the wire 850 is disposed. Solder that connects the wire 850 and the metal member 225 may be introduced into the second hole 225-2. The second hole 225-2 may be extended straight.

The AF carrier 210 may comprise a protruded portion 226. The holder member 220 may comprise a protruded portion 226. The protruded portion 226 may be formed on an outer side surface of the AF carrier 210. The protruded portion 226 may be protruded outward from the AF carrier 210. A connecting portion 712 may be disposed on an upper surface and a lower surface of the protruded portion 226.

The lens actuator 10 may comprise a preload member 230. The AF carrier 210 may comprise a preload member 230. The preload member 230 may be coupled to an upper surface of a holder member 220. The preload member 230 may be coupled to the holder member 220. The preload member 230 may be inserted into and coupled to the holder member 220 from the upper side. The preload member 230 may pressurize the OIS guide ball 820. The preload member 230 may be in contact with the OIS guide ball 820. The preload member 230 may be in directly contact with the OIS guide ball 820. The preload member 230 may be coupled to the holder member 220 to pressurize the OIS guide ball 820. The preload member 230 can pressurize a portion of the coil spring 830 by being in contact with the OIS guide ball 820.

The preload member 230 may be disposed between the AF moving unit 200 and the base 110 in an optical axis direction. The preload member 230 may be disposed between the AF moving unit 200 and the base 110. The preload member 230 may be disposed between the AF carrier 210 and the base 110.

The AF carrier 210 may comprise a protruded portion 231. The preload member 230 may comprise a protruded portion 231. The protruded portion 231 may be ‘protrusion’. The preload member 230 may have a protruded portion 231 that guides the OIS guide ball 820. The protruded portion 231 may be coupled to a groove 222 of a holder member 220. The protruded portion 231 of the preload member 230 may be inserted into the groove 222 of the holder member 220 from below. The protruded portion 231 of the preload member 230 may be disposed in the groove 222 of the holder member 220. At least a portion of the protruded portion 231 of the preload member 230 may be disposed in the groove 222 of the holder member 220. The protruded portion 231 may comprise a plurality of protrusions. The protruded portion 231 may comprise four protrusions.

The AF carrier 210 may comprise a groove 232. The preload member 230 may comprise a groove 232. The groove 232 may be an ‘OIS guide ball accommodating groove’. The groove 232 may be formed in the protruded portion 231. The groove 232 may be formed on an upper surface of the protruded portion 231. The groove 232 may be formed on an end portion of the protruded portion 231. The groove 232 may be concavely formed on an upper surface of the protruded portion 231. An OIS guide ball 820 may be disposed in the groove 232. The OIS guide ball 820 may come into contact with the groove 232.

The preload member 230 may comprise a body part 233. The body part 233 may be coupled to a holder member 220. The body part 233 may be disposed on a lower surface of the holder member 220. The protruded portion 231 may protrude upward from the body part 233. The lens actuator 10 may comprise a cover 240. The AF moving unit 200 may comprise a cover 240. The cover 240 may be coupled to the AF carrier 210. The cover 240 may be coupled to an upper surface of the AF carrier 210. The cover 240 may be coupled to an upper surface of the AF carrier 210. The cover 240 may be coupled to an upper side of the holder member 220. The cover 240 may comprise a hook. The hook of the cover 240 may be coupled to the AF carrier 210. The hook of the cover 240 may be protruded downward and be coupled to a side surface of the AF carrier 210.

The lens actuator 10 may comprise an OIS moving unit 300. The OIS moving unit 300 may be disposed in the fixed unit 100. The OIS moving unit 300 may be disposed within the fixed unit 100. The OIS moving unit 300 may be disposed on the fixed unit 100. The OIS moving unit 300 may be disposed within the AF moving unit 200. The OIS moving unit 300 may be disposed on the AF moving unit 200. The OIS moving unit 300 may be disposed on a lower plate of the AF moving unit 200. The OIS moving unit 300 may be movably disposed. The OIS moving unit 300 may move in a direction perpendicular to the optical axis with respect to the fixed unit 100 and the AF moving unit 200 by the OIS driving unit. The OIS moving unit 300 can move in an x-axis direction by the OIS-x driving unit 500. The OIS moving unit 300 can move in a y-axis direction by the OIS-y driving unit 600. The OIS moving unit 300 can move during OIS driving.

The OIS moving unit 300 may comprise a first side surface and a second side surface which are disposed opposite to each other, and a third side surface and a fourth side surface which are disposed opposite to each other. The OIS-x magnet 510 may be disposed on a first side surface of the OIS moving unit 300. The AF magnet 410 may be disposed on a third side surface of the OIS moving unit 300 or may be disposed opposite to the third side surface. That is, the AF magnet 410 may be disposed at a position corresponding to a third side surface of the OIS moving unit 300. The AF magnet 410 may be disposed closest to a third side surface among the first to fourth side surfaces of the OIS moving unit 300. The OIS-y magnet 610 may be disposed on a fourth side surface of the OIS moving unit 300.

The lens actuator 10 may comprise an OIS carrier 310. The OIS moving unit 300 may comprise an OIS carrier 310. The OIS carrier 310 may be an ‘OIS holder’. The OIS carrier 310 may be a ‘bobbin’. The OIS carrier 310 may be disposed within the AF carrier 210. The OIS carrier 310 may be disposed within the base 110. The OIS carrier 310 may be disposed on the base 110. The OIS carrier 310 may be disposed within the cover 120. The OIS carrier 310 may be movably disposed in a direction perpendicular to the optical axis.

The OIS carrier 310 may comprise an outer side surface. The OIS carrier 310 may comprise a plurality of side surfaces. The OIS carrier 310 may comprise a first side surface and a second side surface being disposed opposite to each other, and a third side surface and a fourth side surface being disposed opposite to each other. The AF coil 420 may be disposed between the first side surface of the OIS carrier 310 and the AF magnet 410. The OIS-x magnet 510 may be disposed on a third side surface of the OIS carrier 310. The OIS-y magnet 610 may be disposed on a second side surface of the OIS carrier 310.

The OIS carrier 310 may comprise a groove. The groove may be an ‘elastic member interference prevention groove’. The groove may be formed on an upper surface of the OIS carrier 310. The groove may be formed concavely on an upper surface of the OIS carrier 310. The groove may be disposed corresponding to the coil spring 830 to prevent interference between the OIS carrier 310 and the coil spring 830.

The OIS carrier 310 may comprise a groove 311. The groove 311 may be an ‘OIS guide ball accommodating groove’. An OIS guide ball 820 may be disposed in the groove 311. The groove 311 may be in direct contact with the OIS guide ball 820. The groove 311 may be concavely formed on a lower surface of the OIS moving unit 300. The groove 311 may be concavely formed on a lower surface of the OIS carrier 310. The groove 311 may be disposed in a direction perpendicular to the optical axis. The groove 311 may be recessed in an optical axis direction. The groove 311 may comprise a plurality of grooves. The groove 311 may comprise four grooves. The groove 311 may be formed on a lower surface of the OIS carrier 310.

The OIS carrier 310 may comprise a lateral stopper. The lateral stopper may limit the lateral stroke of the OIS carrier 310. That is, when the OIS carrier 310 moves to the maximum, the lateral stopper of the OIS carrier 310 may be in contact with at least one of the AF carrier 210 and the base 110. The lateral stopper may be formed on an outer side surface of the OIS carrier 310. The lateral stopper may be protruded outward from a side surface of the OIS carrier 310.

The OIS carrier 310 may comprise a protruded portion 312. The protruded portion 312 may be protruded from an outer circumferential surface of the OIS moving unit 300. The protruded portion 312 may be protruded from an outer side surface of the OIS moving unit 300. The protruded portion 312 may be protruded from an outer side surface of the OIS carrier 310. The protruded portion 312 may be protruded from an outer side surface of the OIS carrier 310. The protruded portion 312 may be protruded outward from the OIS carrier 310. A coil spring 830 may be coupled to the protruded portion 312. A coil spring 830 may be coupled to a lower surface of the protruded portion 312.

The protruded portion 312 may comprise a hole or groove being coupled with the coil spring 830. A hole or groove in which a portion of the coil spring 830 is disposed may be formed on a lower surface of the protruded portion 312. The hole or groove of the protruded portion 312 may have a shape corresponding to a portion of the coil spring 830.

The protruded portion 312 may comprise a plurality of protruded portions. The protruded portion 312 may comprise four protruded portions. The protruded portion 312 may comprise four protruded portions being spaced apart from one another. The protruded portion 312 may comprise first to fourth protruded portions. The protruded portion 312 may comprise four protruded portions corresponding to four corners of the OIS moving unit 300.

The OIS carrier 310 may comprise an avoidance portion 313. The avoidance portion 313 may be formed concavely on the outer surface of the OIS carrier 310. The avoidance portion 313 may be formed so that the OIS carrier 310 does not interfere with the coil spring 830.

The OIS carrier 310 may comprise a groove 313. The groove 313 may be a ‘lens adhesive accommodating groove’. The groove 313 may be formed on an inner circumferential surface of the OIS carrier 310. The groove 313 may be formed concavely on an inner circumferential surface of the OIS carrier 310. An adhesive may be injected between the lens and the OIS carrier 310 through the groove 313. An adhesive for bonding the lens and the OIS carrier 310 may be disposed in the groove 313.

The OIS carrier 310 may comprise a mounting portion. The mounting portion may be a ‘magnet mounting portion.’ Magnets 510 and 620 may be disposed in the mounting portion. The mounting portion may be formed, for example, as a groove.

The lens actuator 10 may comprise a driving unit. The driving unit may move the moving unit against the fixed unit 100. The driving unit may comprise an AF driving unit 400. The driving unit may comprise an OIS driving unit. The driving unit may comprise an OIS-x driving unit 500. The driving unit may comprise an OIS-y driving unit 600. The driving unit may comprise a coil and a magnet.

The lens actuator 10 may comprise an AF driving unit 400. The AF driving unit 400 may move the AF moving unit 200 in an optical axis direction. The AF driving unit 400 may move the AF carrier 210 in an optical axis direction. The AF driving unit 400 may move the AF carrier 210 in an optical axis direction through electromagnetic force. The AF driving unit 400 may comprise a coil and a magnet.

The lens actuator 10 may comprise an AF magnet 410 and an AF coil 420 that move the AF moving unit 200 in an optical axis direction.

In a first embodiment of the present invention, the AF carrier 210 and the OIS carrier 310 can move in an optical axis direction by the interaction between the AF coil 420 and the AF magnet 410. The AF coil 420, the AF carrier 210, and the OIS carrier 310 can move integrally in an optical axis direction.

The lens actuator 10 may comprise an AF magnet 410. The AF driving unit 400 may comprise an AF magnet 410. The AF magnet 410 may be an ‘AF magnet’. The AF magnet 410 may be a permanent magnet. The AF magnet 410 may be disposed in the fixed unit 100. The AF magnet 410 may be disposed in the base 110. The AF magnet 410 may be disposed in the cover 120. The AF magnet 410 may be disposed in the side plate 122 of the cover 120. The AF magnet 410 may be disposed on an outer side surface of the base 110. The AF magnet 410 may be disposed on an inner side surface of the base 110. The AF magnet 410 can be fixed to the base 110. The AF magnet 410 can be coupled to the base 110. The AF magnet 410 can be bonded to the base 110 with an adhesive. The AF magnet 410 can be disposed within the cover 120. The AF magnet 410 can interact with the AF coil 420. The AF magnet 410 can electromagnetically interact with the AF coil 420. The AF magnet 410 can be disposed at a position corresponding to the AF coil 420. The AF magnet 410 can face the AF coil 420. The AF magnet 410 can face the AF coil 420. The AF magnet 410 can be overlapped with the AF coil 420 in a direction perpendicular to the optical axis.

The AF magnet 410 may be a four-pole magnet. The AF magnet 410 may comprise a four-pole magnetizing magnet. The AF magnet 410 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be disposed spaced apart from each other in a vertical direction, and a neutral portion may be disposed between the first magnet portion and the second magnet portion.

The lens actuator 10 may comprise an AF coil 420. The AF driving unit 400 may comprise the AF coil 420. The AF coil 420 may interact with the AF magnet 410. The AF coil 420 may face the AF magnet 410. The AF coil 420 may be disposed at a position corresponding to the AF magnet 410. The AF coil 420 may be overlapped with the AF magnet 410 in a direction perpendicular to the optical axis. The AF coil 420 may be disposed in the inner substrate 720. The AF coil 420 may be disposed in the AF carrier 210. The AF coil 420 may be disposed in the AF moving unit 200.

In a first embodiment of the present invention, the AF coil 420 can move in an optical axis direction. The AF coil 420 can move in an optical axis direction through interaction with the AF magnet 410. The AF coil 420 can move together with the AF moving unit 200. The AF coil 420 can move in an optical axis direction together with the AF moving unit 200. During the AF driving process, the AF coil 420 can move in an optical axis direction together with the AF moving unit 200. The AF coil 420 can be disposed in the AF moving unit 200. The AF coil 420 can be fixed to the AF moving unit 200. The AF coil 420 can be coupled to the AF moving unit 200.

The lens actuator 10 may comprise an AF sensor 430. The AF driving unit 400 may comprise an AF sensor 430. The AF sensor 430 may be a Hall sensor. The AF sensor 430 may be disposed in the inner substrate 720. The AF sensor 430 may detect the AF magnet 410. The AF sensor 430 may detect the movement of the AF magnet 410. The movement amount or position of the AF magnet 410 detected by the AF sensor 430 may be used for feedback of auto focus driving.

The AF sensor 430 may be a driver IC. The driver IC may comprise a sensing unit. The sensing unit may comprise a Hall element (Hall IC). The driver IC may be electrically connected to the AF coil 420. The driver IC may supply current to the AF coil 420.

The AF sensor 430 may be disposed within the AF coil 420. The AF sensor 430 may be overlapped with the neutral portion of the AF magnet 410 in a direction perpendicular to the optical axis. In a modified embodiment, the AF sensor 430 may be disposed outside the AF coil 420. The AF sensor 430 may be overlapped with the AF coil 420 in an optical axis direction. The AF sensor 430 may be overlapped with the AF coil 420 in a direction perpendicular to the optical axis.

The lens actuator 10 may comprise an AF yoke 440. The AF yoke 440 may be disposed corresponding to the AF magnet 410. An attractive force may be applied between the AF yoke 440 and the AF magnet 410. The AF guide ball 810 may be maintained in contact with the base 110 and the AF carrier 210 by the attractive force between the AF yoke 440 and the AF magnet 410. The AF yoke 440 may be disposed in the inner substrate 720. The AF yoke 440 may be disposed inside the AF coil 420.

The lens actuator 10 may comprise an OIS driving unit. The OIS driving unit may move the OIS moving unit 300 in a direction perpendicular to the optical axis direction. The OIS driving unit may move the OIS carrier 310 in a direction perpendicular to the optical axis. The OIS driving unit may move the OIS carrier 310 in a direction perpendicular to the optical axis through electromagnetic force.

The lens actuator 10 may comprise an OIS-x driving unit 500. The OIS driving unit may comprise an OIS-x driving unit 500. The OIS-x driving unit 500 may move the OIS carrier 310 in an x-axis direction perpendicular to the optical axis. The OIS-x driving unit 500 may move the OIS carrier 310 in an x-axis direction perpendicular to the optical axis through electromagnetic force. The OIS-x driving unit 500 may comprise a coil and a magnet.

The lens actuator 10 may comprise an OIS-x magnet 510 and an OIS-x coil 520 that move the OIS moving unit 300 in an x-axis direction perpendicular to the optical axis direction. In a first embodiment of the present invention, the OIS-x magnet 510 and the OIS-x coil 520 can move the OIS moving unit 300 in a first direction perpendicular to the optical axis direction. At this time, the first direction may be an x-axis direction. The OIS carrier 310 can move in an x-axis direction perpendicular to the optical axis direction by the interaction between the OIS-x coil 520 and the OIS-x magnet 510. The OIS-x magnet 510 and the OIS carrier 310 can move integrally in an x-axis direction.

The lens actuator 10 may comprise an OIS-x magnet 510. The OIS driving unit may comprise an OIS-x magnet 510. The OIS-x magnet 510 may be an ‘OIS-x magnet’. The OIS-x magnet 510 may be a permanent magnet. The OIS-x magnet 510 may be disposed in the OIS moving unit 300. The OIS-x magnet 510 may be spaced apart from the AF magnet 410. The OIS-x magnet 510 may be disposed in the OIS carrier 310. The OIS-x magnet 510 may be disposed on an outer surface of the OIS carrier 310. The OIS-x magnet 510 may be fixed to the OIS carrier 310. The OIS-x magnet 510 can be coupled to the OIS carrier 310. The OIS-x magnet 510 can be bonded to the OIS carrier 310 with an adhesive. The OIS-x magnet 510 can be disposed inside the cover 120. The OIS-x magnet 510 can interact with the OIS-x coil 520. The OIS-x magnet 510 can electromagnetically interact with the OIS-x coil 520. The OIS-x magnet 510 can be disposed at a position corresponding to the OIS-x coil 520. The OIS-x magnet 510 can face the OIS-x coil 520. The OIS-x magnet 510 can face the OIS-x coil 520. The OIS-x magnet 510 can be overlapped with the OIS-x coil 520 in a direction perpendicular to the optical axis. The OIS-x magnet 510 can be overlapped with the OIS-x coil 520 in an x-axis direction. The OIS-x magnet 510 can move in an x-axis direction perpendicular to the optical axis.

The OIS-x magnet 510 may be a two-pole magnet. The OIS-x magnet 510 may comprise a two-pole magnetizing magnet. The OIS-x magnet 510 may comprise an N pole and an S pole.

The lens actuator 10 may comprise an OIS-x coil 520. The OIS driving unit may comprise an OIS-x coil 520. The OIS-x coil 520 may interact with the OIS-x magnet 510. The OIS-x coil 520 may move the OIS-x magnet 510 in an x-axis direction perpendicular to the optical axis. The OIS-x coil 520 may move the OIS-x magnet 510 in an x-axis direction through interaction with the OIS-x magnet 510. The OIS-x coil 520 may face the OIS-x magnet 510. The OIS-x coil 520 may face the OIS-x magnet 510. The OIS-x coil 520 may be disposed corresponding to the OIS-x magnet 510. The OIS-x coil 520 may be overlapped with the OIS-x magnet 510 in a direction perpendicular to the optical axis. The OIS-x coil 520 may be disposed in the inner substrate 720. The OIS-x coil 520 may be disposed in the AF carrier 210. In a first embodiment of the present invention, the OIS-x coil 520 can move together with the AF moving unit 200. The OIS-x coil 520 can move in an optical axis direction together with the AF moving unit 200. During the AF driving process, the OIS-x coil 520 can move in an optical axis direction together with the AF moving unit 200. The OIS-x coil 520 can be disposed in the AF moving unit 200. The OIS-x coil 520 can be fixed to the AF moving unit 200. The OIS-x coil 520 can be coupled to the AF moving unit 200.

When a current is applied to the OIS-x coil 520, the OIS-x magnet 510 can move away from or closer to the OIS-x coil 520 in an x-axis direction.

The lens actuator 10 may comprise an OIS-x sensor 530. The OIS driving unit may comprise an OIS-x sensor 530. The OIS-x sensor 530 may be disposed in an inner substrate 720. The OIS-x sensor 530 may comprise a Hall sensor. The OIS-x sensor 530 may detect an OIS-x magnet 510. The OIS-x sensor 530 may detect a magnetic force of the OIS-x magnet 510. The OIS-x sensor 530 may be disposed at a lower side of the OIS-x magnet 510. The OIS-x sensor 530 may be overlapped with the OIS-x magnet 510 in an optical axis direction. In a modified embodiment, the OIS-x sensor 530 may be disposed within the OIS-x coil 520. The OIS-x sensor 530 may be overlapped with the OIS-x coil 520 in an optical axis direction. The OIS-x sensor 530 may be overlapped with the OIS-x coil 520 in a direction perpendicular to the optical axis. The OIS-x sensor 530 may face the OIS-x magnet 510. The OIS-x sensor 530 may be disposed at a position corresponding to the OIS-x magnet 510. The OIS-x sensor 530 may detect movement of the OIS-x magnet 510. The amount of movement or position of the OIS-x magnet 510 detected by the OIS-x sensor 530 may be used for feedback of handshake correction driving in an x-axis direction.

The lens actuator 10 may comprise an OIS-x yoke 540. The OIS-x yoke 540 may be disposed in an OIS-x magnet 510. The OIS-x yoke 540 may be disposed between the OIS-x magnet 510 and the OIS carrier 310. The OIS-x yoke 540 may prevent magnetic flux leakage of the OIS-x magnet 510 and thereby improve interaction with the OIS-x coil 520.

The lens actuator 10 may comprise an OIS-y driving unit 600. The OIS driving unit may comprise an OIS-y driving unit 600. The OIS-y driving unit 600 may move the OIS carrier 310 in a y-axis direction perpendicular to both the optical axis and the x-axis direction. The OIS-y driving unit 600 may move the OIS carrier 310 in a y-axis direction perpendicular to both the optical axis and the x-axis direction through electromagnetic force. The OIS-y driving unit 600 may comprise a coil and a magnet.

The lens actuator 10 may comprise an OIS-y magnet 610 and an OIS-y coil 620 that move the OIS moving unit 300 in a y-axis direction perpendicular to the optical axis direction and the x-axis direction.

In a first embodiment of the present invention, the OIS-y magnet 610 and the OIS-y coil 620 can move the OIS moving unit 300 in a second direction perpendicular to the optical axis direction and the first direction. At this time, the second direction may be a y-axis direction. By the interaction of the OIS-y coil 620 and the OIS-y magnet 610, the OIS carrier 310 can move in a y-axis direction perpendicular to both the optical axis direction and the x-axis direction. The OIS-y magnet 610 and the OIS carrier 310 can move integrally in a y-axis direction. The OIS-y magnet 610 can be overlapped with the AF magnet 410 in a second direction. The OIS-y magnet 610 can be overlapped with the AF magnet 410 in a y-axis direction.

The lens actuator 10 may comprise an OIS-y magnet 610. The OIS-y driving unit 600 may comprise an OIS-y magnet 610. The OIS-y magnet 610 may be an ‘OIS-y magnet’. The OIS-y magnet 610 may be a permanent magnet. The OIS-y magnet 610 may be disposed in the OIS moving unit 300. The OIS-y magnet 610 may be spaced apart from the OIS-x magnet 510. The OIS-y magnet 610 may be spaced apart from the AF magnet 410. The OIS-y magnet 610 may be disposed in the OIS carrier 310. The OIS-y magnet 610 may be disposed on an outer side surface of the OIS carrier 310. The OIS-y magnet 610 may be fixed to the OIS carrier 310. The OIS-y magnet 610 may be coupled to the OIS carrier 310. The OIS-y magnet 610 may be adhesively bonded to the OIS carrier 310 with an adhesive. The OIS-y magnet 610 may be disposed within the cover 120. The OIS-y magnet 610 may interact with the OIS-y coil 620. The OIS-y magnet 610 may electromagnetically interact with the OIS-y coil 620. The OIS-y magnet 610 may be disposed at a position corresponding to the OIS-y coil 620. The OIS-y magnet 610 can face the OIS-y coil 620. The OIS-y magnet 610 can face the OIS-y coil 620. The OIS-y magnet 610 can be overlapped with the OIS-y coil 620 in a direction perpendicular to the optical axis. The OIS-y magnet 610 can be overlapped with the OIS-y coil 620 in a y-axis direction. The OIS-y magnet 610 can move in a y-axis direction.

The OIS-y magnet 610 may be a two-pole magnet. The OIS-y magnet 610 may comprise a two-pole magnetizing magnet. The OIS-y magnet 610 may comprise an N pole and an S pole.

The lens actuator 10 may comprise an OIS-y coil 620. The OIS-y driving unit 600 may comprise the OIS-y coil 620. The OIS-y coil 620 may interact with the OIS-y magnet 610. The OIS-y coil 620 may be disposed on the opposite side of the AF coil 420 with respect to the optical axis. The OIS-y coil 620 may move the OIS-y magnet 610 in a y-axis direction, which is perpendicular to both the optical axis and the x-axis. The OIS-y coil 620 may move the OIS-y magnet 610 in a y-axis direction through interaction with the OIS-y magnet 610. The OIS-y coil 620 may face the OIS-y magnet 610. The OIS-y coil 620 may face the OIS-y magnet 610. The OIS-y coil 620 may be disposed corresponding to the OIS-y magnet 610. The OIS-y coil 620 may be overlapped with the OIS-y magnet 610 in a direction perpendicular to the optical axis. The OIS-y coil 620 may be disposed on the inner substrate 720. The OIS-y coil 620 may be disposed on the AF carrier 210.

In a first embodiment of the present invention, the OIS-y coil 620 can move together with the AF moving unit 200. The OIS-y coil 620 can move in an optical axis direction together with the AF moving unit 200. During the AF driving process, the OIS-y coil 620 can move in an optical axis direction together with the AF moving unit 200. The OIS-y coil 620 can be disposed in the AF moving unit 200. The OIS-y coil 620 can be fixed to the AF moving unit 200. The OIS-y coil 620 can be coupled to the AF moving unit 200.

When a current is applied to the OIS-y coil 620, the OIS-y magnet 610 can move away from or closer to the OIS-y coil 620 in a y-axis direction.

The lens actuator 10 may comprise an OIS-y sensor 630. The OIS-y driving unit 600 may comprise the OIS-y sensor 630. The OIS-y sensor 630 may be disposed in the inner substrate 720. The OIS-y sensor 630 may comprise a Hall sensor. The OIS-y sensor 630 may detect the OIS-y magnet 610. The OIS-y sensor 630 may detect the magnetic force of the OIS-y magnet 610. The OIS-y sensor 630 may be disposed below the OIS-y magnet 610. The OIS-y sensor 630 may be overlapped with the OIS-y magnet 610 in an optical axis direction. The OIS-y sensor 630 may be overlapped with the OIS-y magnet 610 in a direction perpendicular to the optical axis. In a modified embodiment, the OIS-y sensor 630 may be disposed within the OIS-y coil 620. The OIS-y sensor 630 may be overlapped with the OIS-y coil 620 in an optical axis direction. The OIS-y sensor 630 may face the OIS-y magnet 610. The OIS-y sensor 630 may be disposed at a position corresponding to the OIS-y magnet 610. The OIS-y sensor 630 may detect the movement of the OIS-y magnet 610. The movement amount or position of the OIS-y magnet 610 detected by the OIS-y sensor 630 may be used for feedback of the handshake correction driving in a y-axis direction.

The lens actuator 10 may comprise an OIS-y yoke 640. The OIS-y yoke 640 may be disposed on an OIS-y magnet 610. The OIS-y yoke 640 may be disposed between the OIS-y magnet 610 and the OIS carrier 310. The OIS-y yoke 640 may prevent magnetic flux leakage of the OIS-y magnet 610 and thereby enhance interaction with the OIS-y coil 620.

When viewed from above, the AF magnet 410, the AF coil 420, the OIS-y magnet 610, and the OIS-y coil 620 can be disposed in order on an imaginary straight line. When viewed from above, the AF magnet 410, the AF coil 420, the OIS-y magnet 610, and the OIS-y coil 620 can be disposed in order on an imaginary straight line. When viewed from above, the AF magnet 410, the AF coil 420, the OIS-y magnet 610, and the OIS-y coil 620 can be disposed in order. When viewed from above, the AF magnet 410, the AF coil 420, the OIS-y magnet 610, and the OIS-y coil 620 can be disposed in order in a y-axis direction. When viewed from above, the AF magnet 410, the AF coil 420, the OIS-y magnet 610, and the OIS-y coil 620 can be overlapped in a y-axis direction.

The lens actuator 10 may comprise substrates 710 and 720. The substrates 710 and 720 may comprise a flexible printed circuit board (FPCB). The substrates 710 and 720 may be electrically connected to coils 420, 520 and 620. The substrates 710 and 720 may be electrically connected to sensors 430, 530 and 630.

The lens actuator 10 may comprise an outer substrate 710. The outer substrate 710 may be disposed in the base 110. The outer substrate 710 may be electrically connected to coils 420, 520 and 620. The outer substrate 710 may be electrically connected to sensors 430, 530 and 630. The outer substrate 710 may connect the AF carrier 210 and the base 110. The outer substrate 710 may elastically connect the AF carrier 210 and the base 110. The outer substrate 710 may connect the fixed unit 100 and the inner substrate 720. The outer substrate 710 may support the AF carrier 210 to be movable against the base 110. The outer substrate 710 can guide the AF carrier 210 to move in an optical axis direction with respect to the base 110. The outer substrate 710 can comprise a flexible substrate. The outer substrate 710 can comprise a flexible printed circuit board (FPCB). The outer substrate 710 can comprise an elastic portion. The outer substrate 710 can comprise an elastic member. The outer substrate 710 can comprise an outer portion 711 disposed in the fixed unit 100, and a connecting portion 712 being extended from the outer portion 711 and coupled to the inner substrate 720.

The outer substrate 710 may comprise an outer side portion 711. The outer side portion 711 may be disposed on the base 110. The outer side portion 711 may be formed to surround a side surface of the base 110. The outer side portion 711 may be disposed on three side surfaces the base 110. The outer side portion 711 may comprise two terminal portions. The two terminal portions may be disposed on opposite sides with respect to the optical axis. The terminal portion may comprise a terminal 711-1.

The outer substrate 710 may comprise a terminal 711-1. The outer side portion 711 of the outer substrate 710 may comprise a terminal 711-1. The terminal 711-1 may be electrically connected to a terminal 712-1. The terminal 711-1 may be disposed at a lower end portion of the base 110. The terminal 711-1 may be coupled to a printed circuit board 50. The terminal 711-1 may be coupled to a terminal of the printed circuit board 50 via solder. The terminal 711-1 may be coupled to a terminal of the printed circuit board 50 via a conductive member. The terminal 711-1 may be connected to a terminal of the printed circuit board 50. The terminal 711-1 can be electrically connected to a terminal of a printed circuit board 50.

The outer substrate 710 may comprise a connecting portion 712. The connecting portion 712 may be an ‘extension portion’. The connecting portion 712 may be a ‘leg portion’. The connecting portion 712 may be extended from the outer side portion 711. At least a portion of the connecting portion 712 may move together with the AF carrier 210. The extending portion may extend from the outer side portion 711. At least a portion of the extending portion may move together with the AF carrier 210. At least a portion of the connecting portion 712 may be disposed perpendicular to the optical axis direction. The connecting portion 712 of the outer substrate 710 may be coupled to the inner substrate 720 such that the inner substrate 720 may move in an optical axis direction. At least a portion of the connecting portion 712 may be disposed parallel to the optical axis direction.

The connecting portion 712 may comprise a plurality of connecting portions. The connecting portion 712 may comprise a first connecting portion and a second connecting portion. The second connecting portion may be disposed below the first connecting portion.

The outer substrate 710 may comprise a terminal 712-1. The connecting portion 712 of the outer substrate 710 may comprise a terminal 712-1. The terminal 712-1 may be coupled to a terminal 721-1 of the inner substrate 720. The terminal 712-1 of the outer substrate 710 may be coupled to the terminal 721-1 of the inner substrate 720 through solder. The terminal 712-1 of the outer substrate 710 may be coupled to the terminal 721-1 of the inner substrate 720 through a conductive member. The terminal 712-1 of the outer substrate 710 may be connected to the terminal 721-1 of the inner substrate 720. The terminal 712-1 of the outer substrate 710 can be electrically connected to the terminal 721-1 of the inner substrate 720.

The outer substrate 710 may comprise a bent portion 712-2. The bent portion 712-2 may be formed in the connecting portion 712. The bent portion 712-2 may be formed in each of the first connecting portion and the second connecting portion. The bent portion 712-2 may comprise a shape that is bent at least twice. The bent portion 712-2 may comprise a shape bent in a U shape. The bent portion 712-2 may comprise a rounded shape. The bent portion 712-2 may comprise a portion that is disposed parallel to the optical axis.

Hereinafter, one of the ‘terminal 711-1’ and the ‘terminal 712-1’ of the outer substrate 710 may be referred to as a ‘first terminal’ and the other may be referred to as a ‘second terminal’.

The lens actuator 10 may comprise an inner substrate 720. The inner substrate 720 may be electrically connected to coils 420, 520 and 620. The inner substrate 720 may be electrically connected to sensors 430, 530 and 630. The inner substrate 720 may be disposed in the AF moving unit 200. The inner substrate 720 may be disposed in the AF carrier 210. The inner substrate 720 may be fixed to the AF carrier 210. The inner substrate 720 may be coupled to the AF carrier 210. The inner substrate 720 may be bonded to the AF carrier 210 with an adhesive. The inner substrate 720 may comprise a flexible substrate. The inner substrate 720 may comprise a flexible printed circuit board (FPCB). The inner substrate 720 may comprise an elastic portion. The inner substrate 720 may comprise an elastic member.

The inner substrate 720 can be coupled to a lower surface of the holder member 220. The preload member 230 can be coupled to the inner substrate 720.

The inner substrate 720 may comprise a side plate portion 721. The side plate portion 721 may be disposed on the side surface of the AF carrier 210. The side plate portion 721 may be disposed on an outer side surface of the AF carrier 210. In another embodiment, the side plate portion 721 may be disposed on an inner side surface of the AF carrier 210. The side plate portion 721 of the inner substrate 720 may comprise a plurality of portions. The side plate portion 721 may comprise first to fourth portions.

The inner substrate 720 may comprise a first portion. The first portion may be disposed on the AF carrier 210. The AF coil 420 may be disposed in a first portion of the inner substrate 720. The AF sensor 430 may be disposed in a first portion of the inner substrate 720. The AF yoke 440 may be disposed in a first portion of the inner substrate 720.

The inner substrate 720 may comprise a second portion. The second portion may be disposed opposite to the first portion. The second portion may be disposed in the AF carrier 210. The second portion may be disposed at a second side surface of the AF carrier 210. The OIS-y coil 620 may be disposed at a second portion of the inner substrate 720. The OIS-y sensor 630 may be disposed at a second portion of the inner substrate 720. More specifically, the OIS-y sensor 630 may be disposed at a lower plate portion 722 being bent and disposed at an upper side of a second portion of the inner substrate 720. The OIS-y sensor 630 may be disposed at a lower surface of the lower plate portion 722.

The inner substrate 720 may comprise a third portion. The third portion may be disposed in the AF carrier 210. The third portion may be disposed at a third side surface of the AF carrier 210. The OIS-x coil 520 may be disposed at a third portion of the inner substrate 720. The OIS-x sensor 530 may be disposed at a third portion of the inner substrate 720. More specifically, the OIS-x sensor 530 may be disposed at a lower plate portion 722 being bent and disposed at an upper side of a third portion of the inner substrate 720. The OIS-x sensor 530 may be disposed at a lower surface of the lower plate portion 722.

The inner substrate 720 may comprise a fourth portion. The fourth portion may be disposed opposite to the third portion. The fourth portion may be disposed in the AF carrier 210. The fourth portion may be disposed at a fourth side surface of the AF carrier 210.

The inner substrate 720 may comprise a terminal 721-1. The terminal 721-1 may be disposed in the fourth portion of the inner substrate 720. The terminal 721-1 may be electrically connected to the coils 420, 520 and 620. The terminal 721-1 may be electrically connected to the sensors 430, 530 and 630. The terminal 721-1 may be coupled to the terminal 712-1 of the outer substrate 710.

The inner substrate 720 may comprise a terminal 722-1. The terminal 722-1 may be disposed in the lower plate portion 722 of the inner substrate 720. The terminal 722-1 may be electrically connected to the coils 420, 520 and 620. The terminal 722-1 may be electrically connected to the sensors 430, 530 and 630. The terminal 722-1 may be coupled to the terminal 712-1 of the outer substrate 710.

The inner substrate 720 may comprise a hole 722-2. Through the hole 722-2, a terminal 722-1 of the inner substrate 720 may be soldered to a terminal 712-1 of the outer substrate 710. The lens actuator 10 may comprise a guide member. The guide member may comprise a ball. The guide member may comprise a pin. The guide member may comprise a cylindrical member. The guide member may guide the movement of the moving unit against the fixed unit 100 in a specific direction.

The lens actuator 10 may comprise an AF guide ball 810. The AF guide ball 810 may guide movement of the AF moving unit 200 against the fixed unit 100 in an optical axis direction. The AF guide ball 810 may guide movement of the AF carrier 210 against the base 110 in an optical axis direction. The AF guide ball 810 may be disposed between the fixed unit 100 and the AF moving unit 200. The AF guide ball 810 may be disposed between the base 110 and the AF carrier 210. The AF guide ball 810 may be disposed between the housing and the base 110. The AF guide ball 810 may be disposed between the base 110 and the AF carrier 210 in an x direction. Or, the AF guide ball 810 may be disposed between the base 110 and the AF carrier 210 in a y direction. The AF guide ball 810 may be disposed in a groove of the base 110. The AF guide ball 810 may be disposed in a groove of the AF carrier 210. The AF guide ball 810 may be spherical. The AF guide ball 810 may be formed of metal. Grease may be applied to the surface of the AF guide ball 810.

The AF guide ball 810 may be disposed at a first corner of the base 110. The AF guide ball 810 may be disposed at a second corner in diagonal direction of the first corner of the base 110. The AF guide ball 810 may be disposed at each of the first and second corners of the base 110. The first and second corner regions of the fixed unit 100 may be disposed diagonally against an optical axis. The AF guide ball 810 may be disposed at the first and second corner regions of the fixed unit 100. Two sets of AF guide balls 810 may be disposed at each of the first and second corners of the base 110. At this time, one set may comprise four balls. The two sets may be disposed at opposite sides of the pillar part of the AF carrier 210.

In a modified embodiment, the AF guide ball 810 may be disposed at a first corner and a third corner. Or, the AF guide ball 810 may be disposed at a first corner and a fourth corner. That is, the AF guide ball 810 may not be disposed diagonally.

The AF guide ball 810 may comprise a first unit ball disposed at a first corner region of the fixed unit 100 when viewed from above, and a second unit ball being disposed at a second corner region diagonally from a first corner region of the fixed unit 100. At this time, the OIS guide ball 820 may comprise a first guide member and a second guide member being spaced apart from each other and disposed diagonally between the first unit ball and the second unit ball of the AF guide ball 810, when viewed from above.

The AF guide ball 810 may comprise a first unit ball and a second unit ball being disposed at a first corner region of the fixed unit 100 when viewed from above, and a third unit ball and a fourth unit ball being disposed at a second corner region diagonally opposite to the first corner region of the fixed unit 100. The AF guide balls 810 may be disposed in sets of two per corner.

The AF guide ball 810 may comprise a ball being overlapped with the OIS guide ball 820 in a direction perpendicular to the optical axis direction. At least a portion of the AF guide ball 810 may be overlapped with the OIS guide ball 820.

The AF guide ball 810 may comprise an inner ball 811. The inner ball 811 may be disposed in the pillar part 111 of the base 110. The inner ball 811 may be disposed in the inner groove 111-1 of the base 110. The inner ball 811 may be disposed in the inner groove 224-1 of the AF carrier 210. The inner ball 811 may be disposed in the inner groove 224-1 of the AF moving unit 200. The inner ball 811 may be disposed in the inner groove 111-1 of the base 110 and the inner groove 224-1 of the AF carrier 210. The inner ball 811 may be disposed between the inner groove 111-1 of the base 110 and the inner groove 224-1 of the AF carrier 210. The inner ball 811 can be disposed between the AF moving unit 200 and the pillar part 111 of the fixed unit 100.

The AF guide ball 810 may comprise an outer ball 812. The outer ball 812 may be disposed in the outer wall part 112 of the base 110. The outer ball 812 may be disposed in the outer groove 112-1 of the base 110. The outer ball 812 may be disposed in the outer groove 224-2 of the AF carrier 210. The outer ball 812 may be disposed in the outer groove 112-1 of the base 110 and the outer groove 224-2 of the AF carrier 210. The outer ball 812 may be disposed between the outer groove 112-1 of the base 110 and the outer groove 224-2 of the AF carrier 210. The outer ball 812 may be disposed between the outer groove 112-1 of the fixed unit 100 and the outer groove 224-2 of the AF moving unit 200. The outer ball 812 may be disposed between the AF moving unit 200 and the outer wall part 112 of the fixed unit 100.

The inner ball 811 may comprise a plurality of inner balls 811. The plurality of inner balls 811 may be disposed in the optical axis direction. The inner ball 811 may comprise four inner balls 811. The inner ball 811 may comprise first to fourth inner balls. Two of the four inner balls 811 may have large diameters and the remaining two may have small diameters. The two balls with large diameters may be disposed at the uppermost end and the lowermost end. In other words, two balls with small diameters may be disposed between the two balls with large diameters.

The inner ball 811 may comprise an inner uppermost ball 811-1. The inner uppermost ball 811-1 may be disposed highest among the inner balls 811. The inner uppermost ball 811-1 may be disposed closest to the upper plate 121 of the cover 120 among the inner balls 811. The inner ball 811 may comprise an inner lowermost ball 811-2. The inner lowermost ball 811-2 may be disposed lowest among the inner balls 811. The inner lowermost ball 811-2 may be disposed closest to the lower plate portion of the base 110 among the inner balls 811. The plurality of inner balls 811 may comprise balls having a smaller diameter than each of the inner uppermost ball 811-1 and the inner lowermost ball 811-2. The plurality of inner balls 811 may comprise balls being disposed between the inner uppermost ball 811-1 and the inner lowermost ball 811-2.

The outer ball 812 may comprise a plurality of outer balls 812. The plurality of outer balls 812 may be disposed in an optical axis direction. The outer ball 812 may comprise four outer balls 812. The outer ball 812 may comprise first to fourth outer balls. Two of the four outer balls 812 may have large diameters and the remaining two may have small diameters. The two balls with large diameters may be disposed at the uppermost end and the lowermost end. That is, two balls with small diameters may be disposed between the two balls with large diameters.

The outer ball 812 may comprise an outer uppermost ball 812-1. The outer uppermost ball 812-1 may be disposed highest among the outer balls 812. The outer uppermost ball 812-1 may be disposed closest to the upper plate 121 of the cover 120 among the outer balls 812. The outer ball 812 may comprise an outer lowermost ball 812-2. The outer lowermost ball 812-2 may be disposed lowest among the outer balls 812. The outer lowermost ball 812-2 may be disposed closest to the lower plate portion of the base 110 among the outer balls 812. The plurality of outer balls 812 may comprise balls having a diameter smaller than each of the outer uppermost ball 812-1 and the outer lowermost ball 812-2. The plurality of outer balls 812 may comprise balls being disposed between the outer uppermost ball 812-1 and the outer lowermost ball 812-2.

The AF guide ball 810 may comprise a plurality of balls disposed in an optical axis direction. At this time, the plurality of balls may comprise uppermost balls 811-1 and 812-1 being disposed at the highest position and lowermost balls 811-2 and 812-2 being disposed at the lowest position. The height of the point where the elastic member 920 pressurizes the plate member 910 may be disposed between the height of the uppermost balls 811-1 and 812-1 and the height of the lowermost balls 811-2 and 812-2.

The lens actuator 10 may comprise an OIS guide ball 820. The OIS guide ball 820 may guide the movement of the OIS carrier 310 against the AF carrier 210 in a direction perpendicular to the optical axis. The OIS guide ball 820 may be disposed between the AF moving unit 200 and the OIS moving unit 300. The OIS guide ball 820 may be disposed between the lower plate of the AF moving unit 200 and the OIS moving unit 300. The OIS guide ball 820 may be disposed between the AF carrier 210 and the OIS carrier 310. The OIS guide ball 820 may be disposed between the lower side of the AF carrier 210 and the OIS carrier 310. The OIS guide ball 820 may be disposed between the housing and the bobbin. The OIS guide ball 820 may be disposed between the housing and the lower side of the bobbin. The OIS guide ball 820 may be disposed between the AF carrier 210 and the OIS carrier 310 in an optical axis direction.

The OIS guide ball 820 may be disposed in the protruded portion 231 of the preload member 230. The OIS guide ball 820 may be disposed in the groove 232 of the protruded portion 231. The OIS guide ball 820 may be disposed in the groove 311 of the OIS moving unit 300. The OIS guide ball 820 may be disposed between the groove 232 of the protruded portion 231 of the AF moving unit 200 and the groove 311 of the OIS moving unit 300.

The OIS guide ball 820 may be disposed between the preload member 230 of the AF carrier 210 and the OIS carrier 310. The OIS guide ball 820 may be pressurized between the AF carrier 210 and the OIS carrier 310 by the pressurizing force of the coil spring 830. The preload member 230 may pressurize the OIS guide ball 820 upward during the process of being coupled to the holder member 220. The preload member 230 may pressurize the OIS guide ball 820 toward the OIS carrier 310 during the process of being coupled to the holder member 220. At this time, the OIS carrier 310 may pressurize the OIS guide ball 820 toward the preload member 230 by the restoring force of the coil spring 830. Accordingly, the OIS guide ball 820 can be pressurized between the preload member 230 and the OIS carrier 310.

The OIS guide ball 820 can guide the OIS moving unit 300 to move in an x-axis direction and a y-axis direction. The OIS guide ball 820 can guide the movement of the OIS moving unit 300 in an x-axis direction and a y-axis direction. The OIS guide ball 820 can guide the OIS carrier 310 to move in an x-axis direction and a y-axis direction perpendicular to the optical axis direction against the AF carrier 210. That is, the OIS guide ball 820 can guide the OIS carrier 310 to move in an x-axis direction and a y-axis direction. That is, the OIS guide ball 820 can guide the movement in both an x-axis direction and a y-axis direction. For reference, in a first embodiment of the present invention in which the ball guiding an x-axis direction and the ball guiding a y-axis direction are provided as a single unit, the size of the lens actuator 10 can be minimized compared to the comparative example in which the ball guiding an x-axis direction and the ball guiding a y-axis direction are provided separately. In particular, the height of the lens actuator 10 in an optical axis direction can be reduced. Through this, the height being protruded from the smartphone, that is, the shoulder height can be minimized. The OIS guide ball 820 may comprise a plurality of balls. The OIS guide ball 820 may comprise four balls.

In a modified embodiment, the OIS guide ball 820 may be provided with a separate ball that guides an x-axis driving and a ball that guides a y-axis driving.

The lens actuator 10 may comprise an elastic member. The elastic member may be formed to support OIS driving. The elastic member may support movement of the OIS moving unit 300. The elastic member may be a ‘supporting member’. The elastic member may be formed to pressurize the OIS guide ball 820. The elastic member may be a ‘pressurizing member’. The elastic member may be formed to guide both an OIS-x-axis driving and an OIS-y-axis driving with only the OIS guide ball 820. The elastic member may have elasticity. The elastic member may be formed of metal.

The elastic member can pressurize the OIS guide ball 820 between the AF moving unit 200 and the OIS moving unit 300. The elastic member can pressurize the OIS moving unit 300 toward the AF moving unit 200. The elastic member can pressurize the AF moving unit 200 toward the OIS moving unit 300.

The lens actuator 10 may comprise a coil spring 830. The coil spring 830 may have elasticity. The coil spring 830 may connect the AF moving unit 200 and the OIS moving unit 300. The coil spring 830 may connect the protruded portion 312 of the OIS moving unit 300 and the AF moving unit 200. The coil spring 830 may connect the OIS moving unit 300 and the lower plate 221 of the AF moving unit 200. The coil spring 830 may connect the protruded portion 312 of the OIS moving unit 300 and the lower plate 221 of the AF moving unit 200. The coil spring 830 may connect the OIS carrier 310 and the AF carrier 210. The coil spring 830 can connect the OIS carrier 310 and the holder member 220.

The coil spring 830 can connect a first portion of the AF moving unit 200 and a first portion of the OIS moving unit 300. At this time, the first portion of the AF moving unit 200 and the first portion of the OIS moving unit 300 can be overlapped with each other in an optical axis direction. The coil spring 830 can be disposed to be long in lengthwise in an optical axis direction.

The coil spring 830 can connect the metal member 225 of the OIS moving unit 300 and the AF moving unit 200. The coil spring 830 can be coupled to the metal member 225 of the OIS moving unit 300 and the AF moving unit 200.

The coil spring 830 can be fixed to the OIS moving unit 300 by an adhesive. The coil spring 830 can be coupled to the metal member 225 by solder. The coil spring 830 can be soldered to the metal member 225. The coil spring 830 can be coupled to the metal member 225 by a conductive member.

The metal member 225 may comprise a hole or groove being coupled with the coil spring 830. The metal member 225 may comprise a hole 225-1 through which the coil spring 830 passes. The metal member 225 may comprise an additional U-shaped hole 225-2 being formed adjacent to the hole 225-1 through which the coil spring 830 passes. One of the holes 225-1 and 225-2 may be referred to as a ‘first hole’ and the other may be referred to as a ‘second hole’.

The upper end portion of the coil spring 830 can be coupled with the OIS moving unit 300. The upper end portion of the coil spring 830 can be connected to the OIS moving unit 300. The upper end portion of the coil spring 830 can be disposed in the OIS moving unit 300. The upper end portion of the coil spring 830 can be in contact with the OIS moving unit 300. The upper end portion of the coil spring 830 can be fixed to the OIS moving unit 300.

The lower end portion of the coil spring 830 can be coupled with the AF moving unit 200. The lower end portion of the coil spring 830 can be connected to the AF moving unit 200. The lower end portion of the coil spring 830 can be disposed with the AF moving unit 200. The lower end portion of the coil spring 830 can be in contact with the AF moving unit 200. The lower end portion of the coil spring 830 can be fixed to the AF moving unit 200.

The coil spring 830 may be formed so that the AF moving unit 200 and the OIS moving unit 300 pressurize the OIS guide ball 820. The OIS guide ball 820 may be pressurized between the AF moving unit 200 and the OIS moving unit 300 by the coil spring 830. The OIS guide ball 820 may be brought into close contact with the AF moving unit 200 and the OIS moving unit 300 by the coil spring 830.

The coil spring 830 may have a circular ring shape when viewed from above. The coil spring 830 may be formed by bending one strand to be overlapped multiple times in an optical axis direction.

The length of the coil spring 830 in an optical axis direction may be 56% to 96% of the distance between the upper surface of the metal member 225 and the lower surface of the cover 240. The length of the coil spring 830 in an optical axis direction may be 66% to 86% of the distance between the upper surface of the metal member 225 and the lower surface of the cover 240.

The coil spring 830 may comprise a plurality of coil springs. The coil spring 830 may comprise four coil springs. The coil spring 830 may comprise first to fourth coil springs. The OIS moving unit 300 may comprise first to fourth corners. At this time, the coil spring 830 may comprise first to fourth coil springs being disposed at the first to fourth corners of the OIS moving unit 300. The first to fourth coil springs may be spaced apart from each other in a direction perpendicular to the optical axis direction.

As illustrated in FIG. 33A, the coil spring 830 according to a modified embodiment may comprise a hook portion 831. The hook portion 831 may comprise a hook shape. The hook portion 831 may be a latch shape. The hook portion 831 may comprise a hook shape. The hook portion 831 may be a hook shape. The hook portion 831 may be formed on at least one of both ends of the coil spring 830. That is, the hook portion 831 may be formed only on an upper end portion of the coil spring 830. Or, the hook portion 831 may be formed only on a lower end portion of the coil spring 830. Or, the hook portion 831 may be formed on both the upper end portion and the lower end portion of the coil spring 830.

The hook portion 831 can be coupled with the OIS moving unit 300. The OIS moving unit 300 may comprise a groove or hole in which the hook portion 831 of the coil spring 830 is caught.

The hook portion 831 can be coupled with the metal member 225 of the AF moving unit 200. The metal member 225 of the AF moving unit 200 can comprise a groove or hole in which the hook portion 831 of the coil spring 830 is caught.

As illustrated in FIG. 33B, a coil spring 830 according to another modified embodiment may connect an elastic member 840 and an AF carrier 210. The elastic member 840 may be an upper elastic member. The elastic member 840 may be an upper side elastic member. The elastic member 840 may comprise a spring. The elastic member 840 may be formed as a leaf spring. The elastic member 840 may have elasticity in at least a portion.

The elastic member 840 may comprise an inner side portion 841. The inner side portion 841 may be coupled with the OIS carrier 310. The elastic member 840 may comprise a coupling portion 842. The coupling portion 842 may be coupled with the coil spring 830. The elastic member 840 may comprise a connecting portion 843. The connecting portion 843 may connect the inner side portion 841 and the coupling portion 842.

The coupling portion 842 of the elastic member 840 and the coil spring 830 can be coupled through solder 850. The lower end of the coil spring 830 can also be coupled to the metal member 225 of the AF carrier 210 through solder.

As illustrated in FIGS. 33C-1, 33C-2, and 33C-3, the coil spring 830 may comprise modified embodiments of various shapes. As illustrated in FIG. 33C-1, the coil spring 830a may comprise a hook portion 831 at one end. However, the other end of the coil spring 830a may be formed as an extension portion 832 being extended straight in a straight line shape. As illustrated in FIG. 33C-2, the coil spring 830b may comprise a circular hook portion 833. The circular hook portion 833 may be formed at each of both ends of the coil spring 830b. At this time, the circular hook portion 833 may be a circular shape with an open end rather than a complete circular shape so that it can be hooked to another member. The hook portion 833 may comprise a rounded shape. As illustrated in FIG. 33C-3, the coil spring 830c may comprise a hook portion 834 having a shape bent one time. The hook portion 834 may be formed at each of the two ends of the coil spring 830c. The hook portion 834 may be bent multiple times in a modified embodiment. The hook portion 834 may comprise a bent shape. The hook portion 834 may comprise a shape bent at a right angle. The hook portion 834 may comprise a curved shape.

The lens actuator 10 may comprise a pressurizing member. The pressurizing member may be an ‘AF guide ball pressurizing member’. The pressurizing member may pressurize the AF guide ball 810. The pressurizing member may be formed to pressurize the ball. The AF guide ball 810 pressurized by the pressurizing member may be sandwiched between the fixed unit 100 and the AF moving unit 200. The AF guide ball 810 pressurized by the pressurizing member may be sandwiched between the base 110 and the AF carrier 210. The pressurizing member may allow the AF guide ball 810 to be maintained in contact with the fixed unit 100 and the AF moving unit 200. The pressurizing member may allow the AF guide ball 810 to be maintained in contact with the base 110 and the AF carrier 210.

The lens actuator 10 may comprise a plate member 910. The pressurizing member may comprise the plate member 910. The plate member 910 may be disposed at the AF guide ball 810. The plate member 910 may contact the AF guide ball 810. The plate member 910 may be disposed at the elastic member 920. The plate member 910 may be disposed in the base 110. The plate member 910 may be disposed between the elastic member 920 and the AF guide ball 810. The plate member 910 may pressurize the AF guide ball 810 toward the AF carrier 210 by the elastic member 920. The plate member 910 may be disposed between the AF guide ball 810 and the fixed unit 100. The plate member 910 can be disposed between the inner ball 811 and the pillar part 111 of the fixed unit 100.

The lens actuator 10 may comprise an elastic member 920. The pressurizing member may comprise the elastic member 920. The elastic member 920 may be a spring. The elastic member 920 may be a tapered spring. The elastic member 920 may be disposed in the fixed unit 100. The elastic member 920 may pressurize the AF guide ball 810 toward the AF moving unit 200. The elastic member 920 may pressurize the plate member 910 toward the AF guide ball 810. The elastic member 920 may be disposed between the plate member 910 and the fixed unit 100. The elastic member 920 may push the plate member 910 against the fixed unit 100. The elastic member 920 can pressurize the plate member 910 in an opposite direction of the fixed unit 100. The elastic member 920 can be disposed between the plate member 910 and the pillar part 111 of the fixed unit 100. The elastic member 920 can be disposed in the inner groove 111-1 of the fixed unit 100. The elastic member 920 can pressurize the AF guide ball 810 between the fixed unit 100 and the AF moving unit 200.

In a modified embodiment, the elastic member 920 may be disposed in the AF moving unit 200. At this time, the elastic member 920 may pressurize the AF guide ball 810 toward the fixed unit 100. The elastic member 920 may be disposed in one of the fixed unit 100 and the AF moving unit 200 to pressurize the AF guide ball 810 toward the other of the fixed unit 100 and the AF moving unit 200. The elastic member 920 may pressurize the plate member 910. The elastic member 920 may be disposed between the plate member 910 and the base 110. The elastic member 920 may be disposed between the AF guide ball 810 and the base 110. The elastic member 920 may be disposed in the base 110. The elastic member 920 can be disposed in the inner groove 111-1 of the base 110. The elastic member 920 can pressurize the AF guide ball 810 toward the AF carrier 210. Through this, the AF guide ball 810 can be maintained in contact with the plate member 910 and the AF carrier 210.

The elastic member 920 may comprise a bent portion. The bent portion may comprise a bent shape. The bent portion may comprise a plurality of bent portions. The bent portion may comprise three bent portions. The elastic member 920 may be bent at least three times. The elastic member 920 may comprise an upper bent portion 921. The elastic member 920 may comprise a lower bent portion 922. The elastic member 920 may comprise a connecting bent portion 923. The connecting bent portion 923 may be disposed between the upper bent portion 921 and the lower bent portion 922. The upper bent portion 921 may form an obtuse angle. The lower bent portion 922 may form an obtuse angle. The connecting bent portion 923 may form an obtuse angle. The upper bent portion 921 may be disposed in the fixed unit 100. The lower bent portion 922 may be disposed in the fixed unit 100. The connecting bent portion 923 may be disposed in the plate member 910. Through this structure, the elastic member 920 may push the plate member 910 against the fixed unit 100. The connecting bent portion 923 may be in contact with the plate member 910 and pressurize the plate member 910 toward the AF guide ball 810.

The height of the point where the elastic member 920 pressurizes the plate member 910 may be lower than the height of the ball that is disposed lower between the inner uppermost ball 811-1 and the outer uppermost ball 812-1 and higher than the height of the ball being disposed higher between the inner lowermost ball 811-2 and the outer lowermost ball 812-2. More specifically, as shown in FIG. 44A, when the AF moving unit 200 moves upward, the height b of the point where the elastic member 920 the plate member 910 may be higher than the height a of the ball that is disposed higher between the inner lowermost ball 422 and the outer lowermost ball 412. A gap c may exist in the height between the two points. In addition, as shown in FIG. 44B, when the AF moving unit 200 moves downward, the height e of the point where the elastic member 920 pressurizes the plate member 910 may be lower than the height d of the ball that is disposed lower between the inner uppermost ball 421 and the outer uppermost ball 411. A gap f may exist between the two points. Through this, the generation of a moment being generated as the elastic member 920 pressurizes the plate member 910 can be prevented or minimized. In other words, the phenomenon in that the plate member 910 is tilted or detached can be prevented.

The lens actuator 10 may comprise a reinforcing member 930. The reinforcing member 930 may be disposed in the base 110. The reinforcing member 930 may be disposed to reinforce the strength of the base 110. The reinforcing member 930 may prevent damage to the base 110. The reinforcing member 930 may prevent damage to the pillar part 111 of the base 110. The reinforcing member 930 may prevent damage to the outer wall part 112 of the base 110. The reinforcing member 930 may have elasticity. The reinforcing member 930 may be formed of metal. The reinforcing member 930 may comprise a shape that is bent at least twice. The reinforcing member 930 may be formed in a ‘c’ shape when viewed from above. The reinforcing member 930 can be opened inward.

The reinforcing member 930 may comprise an inner side portion 931. The inner side portion 931 may be disposed on an opposite surface of the inner groove 111-1 of the pillar part 111 of the fixed unit 100. The reinforcing member 930 may comprise an outer side portion 932. The outer side portion 932 may be disposed on an opposite surface of the outer groove 112-1 of the outer wall part 112 of the fixed unit 100. The reinforcing member 930 may comprise a connecting portion 933. The connecting portion 933 may connect the inner side portion 931 and the outer side portion 932.

The lens actuator 10 may comprise a cover 940. The cover 940 may be disposed on the AF guide ball 810. The cover 940 may be overlapped with the AF guide ball 810 in an optical axis direction. The cover 940 may be overlapped with the inner ball 811 in an optical axis direction. The cover 940 may be overlapped with the outer ball 812 in an optical axis direction. The cover 940 may be disposed on the inner groove 224-1 and the outer groove 224-2 of the AF carrier 210 to prevent the AF guide ball 810 from being separated upward.

In a first embodiment of the present invention, one side of the wire 850 can be coupled to the AF moving unit 200 that is fixed during OIS driving, thereby reducing the characteristic of the wire 850 vibrating as a point mass.

In a first embodiment of the present invention, the base 110, preload member 230, inner substrate 720, holder member 220, and OIS carrier 310 may be disposed in this order from the bottom up. In a first embodiment of the present invention, the base 110, preload member 230, inner substrate 720, holder member 220, and OIS carrier 310 may be laminated in this order from the bottom up. In a first embodiment of the present invention, a stable coupling surface with the lens module 20 can be secured through the lamination direction. In a first embodiment of the present invention, the rib of the lens module 20 can be disposed in the groove 313 of the OIS carrier 310.

In a first embodiment of the present invention, two coils may be provided for each of the OIS-x driving unit 500 and the OIS-y driving unit 600. By forming the distribution of the driving force into two points on the outside, the driving linearity may be improved. The magnets of each of the OIS-x driving unit 500 and the OIS-y driving unit 600 may be formed with four poles. Or, a total of four magnets may be formed, with two each of the two poles.

According to a first embodiment of the present invention, the attraction and repulsive forces between the AF magnet 410 and the OIS-x magnet 510 or the AF magnet 410 and the OIS-y magnet 610 can be reduced. Accordingly, the driving noise can be reduced.

Hereinafter, the configuration of a lens actuator according to a modified embodiment is described with reference to drawings.

FIG. 34 is a cross-sectional view of a lens actuator according to a modified embodiment, cut perpendicular to an optical axis and viewed from above. FIG. 35 is a bottom perspective view of a driving unit of a lens actuator according to a modified embodiment.

In a modified embodiment, the OIS-x magnet 510, OIS-x coil 520, OIS-y magnet 610, and OIS-y coil 620 may be changed compared to the first embodiment of the present invention. The description in the first embodiment of the present invention may be applied analogously to the configurations of the modified embodiment that are not described below.

The OIS-x magnet 510 may comprise a first magnet portion 511. The first magnet portion 511 may comprise an N pole and an S pole. The first magnet portion 511 may be disposed on a first side surface of the OIS moving unit 300. The first magnet portion 511 may comprise an inner surface being disposed on a first side surface of the OIS moving unit 300 and an outer surface opposite to the inner surface. The inner surface of the first magnet portion 511 may be formed as an N pole in its entirety. The outer surface of the first magnet portion 511 may be formed as an S pole in its entirety. Or, conversely, the inner surface of the first magnet portion 511 may be an S pole and the outer surface may be an N pole.

The OIS-x magnet 510 may comprise a second magnet portion 512. The second magnet portion 512 may comprise a south pole and a north pole. The second magnet portion 512 may be disposed on a first side surface of the OIS moving unit 300. The second magnet portion 512 may comprise an inner surface disposed on a first side surface of the OIS moving unit 300 and an outer surface opposite the inner surface. The inner surface of the second magnet portion 512 may be formed as a south pole in its entirety. The outer surface of the second magnet portion 512 may be formed as a north pole in its entirety. Or, conversely, the inner surface of the second magnet portion 512 may be a north pole and the outer surface may be a south pole.

The first magnet portion 511 and the second magnet portion 512 may be overlapped with each other in a y-axis direction perpendicular to the optical axis direction and the x-axis direction. The first magnet portion 511 and the second magnet portion 512 may be formed to have the same size. The first magnet portion 511 and the second magnet portion 512 may be formed to have the same shape.

In a first embodiment of the present invention, the first magnet portion 511 and the second magnet portion 512 of the OIS-x magnet 510 may have outer surfaces formed with different polarities. However, in a modified embodiment, the first magnet portion 511 and the second magnet portion 512 of the OIS-x magnet 510 may have outer surfaces formed with the same polarity.

The polarity of the first magnet portion 511 facing the first coil portion 521 and the polarity of the second magnet portion 512 facing the second coil portion 522 may be different from each other. The polarity of the entire area of the first magnet portion 511 facing the first coil portion 521 may be a south pole. The polarity of the entire area of the first magnet portion 511 facing the first coil portion 521 may be a single polarity. The polarity of the entire area of the second magnet portion 512 facing the second coil portion 522 may be a north pole. The polarity of the entire area of the second magnet portion 512 facing the second coil portion 522 may be a single polarity.

The OIS-x magnet 510 may comprise a neutral portion 513. The neutral portion 513 may be disposed between the first magnet portion 511 and the second magnet portion 512. The neutral portion 513 may have a lower polarity than the first magnet portion 511 and the second magnet portion 512. The neutral portion 513 may not have a polarity.

In a first embodiment of the present invention, the first magnet portion 511, the second magnet portion 512, and the neutral portion 513 may be formed integrally. That is, the first magnet portion 511, the second magnet portion 512, and the neutral portion 513 may be a single four-pole magnetized magnet.

The OIS-x coil 520 may comprise a first coil portion 521. The first coil portion 521 may interact with the first magnet portion 511. The first coil portion 521 may be overlapped with the first magnet portion 511 in an x-axis direction. That is, the first coil portion 521 and the first magnet portion 511 may be overlapped with each other in a direction that matches the driving direction due to the interaction.

The OIS-x coil 520 may comprise a second coil portion 522. The second coil portion 522 may interact with the second magnet portion 512. The second coil portion 522 may be overlapped with the second magnet portion 512 in an x-axis direction. That is, the second coil portion 522 and the second magnet portion 512 may be overlapped with each other in a direction that matches the driving direction due to the interaction.

The OIS-x coil 520 may comprise two coils. The OIS-x coil 520 may comprise two bundles of coils. The OIS-x coil 520 may comprise two ring-shaped coils. The OIS-x coil 520 may comprise two coil units. The OIS-x coil 520 may comprise two split coils. The OIS-x coil 520 may be separated into two coils. The OIS-x coil 520 may be separated into two regions. Each of the first coil portion 521 and the second coil portion 522 may comprise a ring shape. The first coil portion 521 and the second coil portion 522 can be formed as separate coils.

The first coil portion 521 and the second coil portion 522 can be connected. The first coil portion 521 can be electrically connected to the second coil portion 522. At this time, the winding direction of the first coil portion 521 can be opposite to the winding direction of the second coil portion 522. In this case, when a current is applied, the direction of the electromagnetic force induced in s first coil portion 521 and s second coil portion 522 can be opposite.

The OIS-y magnet 610 may comprise a third magnet portion 611. The third magnet portion 611 may comprise an N pole and an S pole. The third magnet portion 611 may be disposed on a fourth side surface of the OIS moving unit 300. The third magnet portion 611 may comprise an inner surface being disposed on a fourth side surface of the OIS moving unit 300 and an outer surface opposite to the inner surface. The inner surface of the third magnet portion 611 may be formed as an N pole in its entirety. The outer surface of the third magnet portion 611 may be formed as an S pole in its entirety. Or, conversely, the inner surface of the third magnet portion 611 may be an S pole and the outer surface may be an N pole.

The OIS-y magnet 610 may comprise a fourth magnet portion 612. The fourth magnet portion 612 may comprise a south pole and a north pole. The fourth magnet portion 612 may be disposed on a fourth side surface of the OIS moving unit 300. The fourth magnet portion 612 may comprise an inner surface being disposed on a fourth side surface of the OIS moving unit 300 and an outer surface opposite to the inner surface. The inner surface of the fourth magnet portion 612 may be formed as a south pole in its entirety. The outer surface of the fourth magnet portion 612 may be formed as a north pole in its entirety. Or, conversely, the inner surface of the fourth magnet portion 612 may be a north pole and the outer surface may be a south pole.

The third magnet portion 611 and the fourth magnet portion 612 may be overlapped with each other in a y-axis direction perpendicular to the optical axis direction and the x-axis direction. The third magnet portion 611 and the fourth magnet portion 612 may be formed to have the same size. The third magnet portion 611 and the fourth magnet portion 612 may be formed to have the same shape.

In a first embodiment of the present invention, the third magnet portion 611 and the fourth magnet portion 612 of the OIS-y magnet 610 may have outer surfaces formed with different polarities. However, in a modified embodiment, the third magnet portion 611 and the fourth magnet portion 612 of the OIS-y magnet 610 may have outer surfaces formed with the same polarity.

The polarity of the third magnet portion 611 facing the third coil portion 621 and the polarity of the fourth magnet portion 612 facing the fourth coil portion 622 may be different from each other. The polarity of the entire area of the third magnet portion 611 facing the third coil portion 621 may be a south pole. The polarity of the entire area of the third magnet portion 611 facing the third coil portion 621 may be a single polarity. The polarity of the entire area of the fourth magnet portion 612 facing the fourth coil portion 622 may be a north pole. The polarity of the entire area of the fourth magnet portion 612 facing the fourth coil portion 622 may be a single polarity.

The OIS-y magnet 610 may comprise a neutral portion 613. The neutral portion 613 may be disposed between the third magnet portion 611 and the fourth magnet portion 612. The neutral portion 613 may have a lower polarity than the third magnet portion 611 and the fourth magnet portion 612. The neutral portion 613 may not have a polarity.

In the first embodiment of the present invention, the third magnet portion 611, the fourth magnet portion 612, and the neutral portion 613 may be formed integrally. That is, the third magnet portion 611, the fourth magnet portion 612, and the neutral portion 613 may be a single four-pole magnetized magnet.

The OIS-y coil 620 may comprise a third coil portion 621. The third coil portion 621 may interact with the third magnet portion 611. The third coil portion 621 may be overlapped with the third magnet portion 611 in an x-axis direction. That is, the third coil portion 621 and the third magnet portion 611 may be overlapped with each other in a direction that matches the driving direction due to the interaction.

The OIS-y coil 620 may comprise a fourth coil portion 622. The fourth coil portion 622 may interact with the fourth magnet portion 612. The fourth coil portion 622 may be overlapped with the fourth magnet portion 612 in an x-axis direction. That is, the fourth coil portion 622 and the fourth magnet portion 612 may be overlapped with each other in a direction that matches the driving direction due to the interaction.

The OIS-y coil 620 may comprise two coils. The OIS-y coil 620 may comprise two bundles of coils. The OIS-y coil 620 may comprise two ring-shaped coils. The OIS-y coil 620 may comprise two coil units. The OIS-y coil 620 may comprise two split coils. The OIS-y coil 620 may be separated into two coils. The OIS-y coil 620 may be separated into two regions. Each of the third coil portion 621 and the fourth coil portion 622 may comprise a ring shape. The third coil portion 621 and the fourth coil portion 622 can be formed as separate coils.

The third coil portion 621 and the fourth coil portion 622 can be connected. The third coil portion 621 can be electrically connected to the fourth coil portion 622. At this time, the winding direction of the third coil portion 621 can be opposite to the winding direction of the fourth coil portion 622. In this case, when a current is applied, the direction of the electromagnetic force induced in the third coil portion 621 and the fourth coil portion 622 can be opposite.

Hereinafter, the auto focus (AF) operation of the lens actuator according to a first embodiment of the present invention will be described with reference to the drawings.

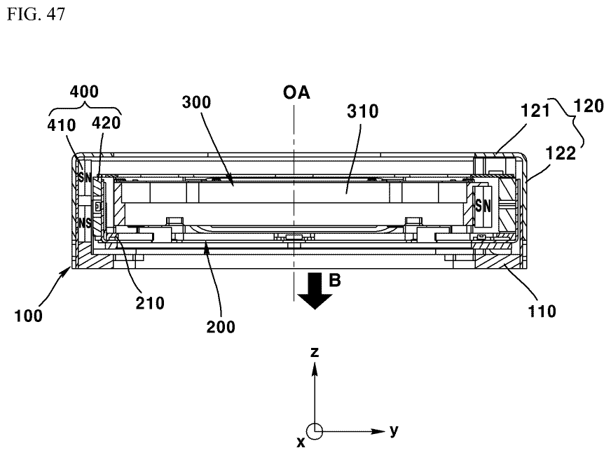

FIGS. 45 to 47 are drawings for explaining an autofocus driving of a lens actuator according to a first embodiment of the present invention. FIG. 45 is a cross-sectional view illustrating a moving unit in an initial state where no current is applied to an AF coil. FIG. 46 is a cross-sectional view illustrating a moving unit moving upward in an optical axis direction when a positive current is applied to an AF coil. FIG. 47 is a cross-sectional view illustrating a state in which a reverse current is applied to an AF coil and a moving unit moves downward in an optical axis direction.

As illustrated in FIG. 45, the moving unit may be disposed at a position spaced apart from both the upper plate 121 of the cover 120 and the base 110 in an initial position where no current is applied to the AF coil 420. At this time, the moving unit may be an AF moving unit 200. In addition, the moving unit may comprise an AF moving unit 200 and an OIS moving unit 300.

When a positive current is applied to the AF coil 420, the AF coil 420 can move upward in an optical axis direction due to the electromagnetic interaction between the AF coil 420 and the AF magnet 410 (See A of FIG. 46). At this time, the AF carrier 210 can move upward in an optical axis direction together with the AF coil 420. Furthermore, the OIS carrier 310 and the lens can move upward in an optical axis direction together with the AF carrier 210. Accordingly, the distance between the lens and the image sensor can be changed, so that the focus of the image formed on the image sensor through the lens can be adjusted.

When a reverse current is applied to the AF coil 420, the AF coil 420 can move downward in an optical axis direction due to the electromagnetic interaction between the AF coil 420 and the AF magnet 410 (See B of FIG. 47). At this time, the AF carrier 210 can move downward in an optical axis direction together with the AF coil 420. Furthermore, the OIS carrier 310 and the lens can move downward in an optical axis direction together with the AF carrier 210. Accordingly, the distance between the lens and the image sensor can be changed, so that the focus of the image being formed on the image sensor through the lens can be adjusted.

Meanwhile, during the movement of the AF coil 420, the AF sensor 430 moves together with the AF coil 420 and detects the strength of the magnetic field of the AF magnet 410 to detect the amount of movement or position of the lens in an optical axis direction. The amount of movement or position of the lens in an optical axis direction detected by the AF sensor 430 can be used for auto focus feedback control.

Hereinafter, the handshake correction (OIS, optical image stabilization) operation of the lens actuator according to a first embodiment of the present invention will be described with reference to the drawings.

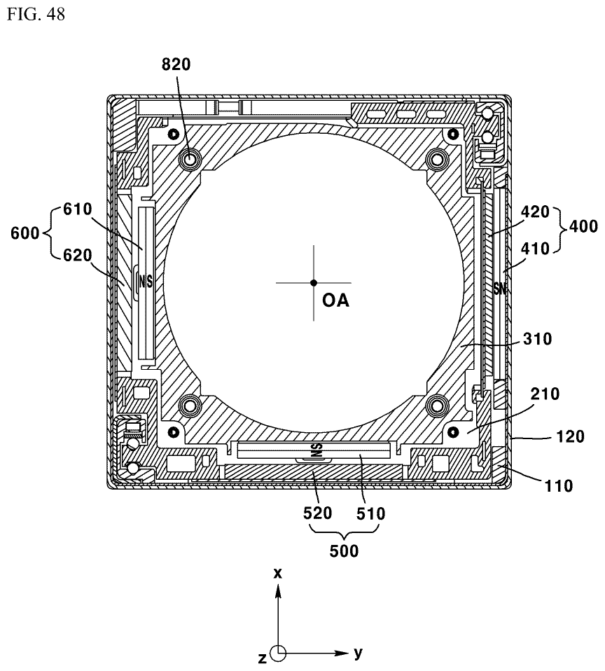

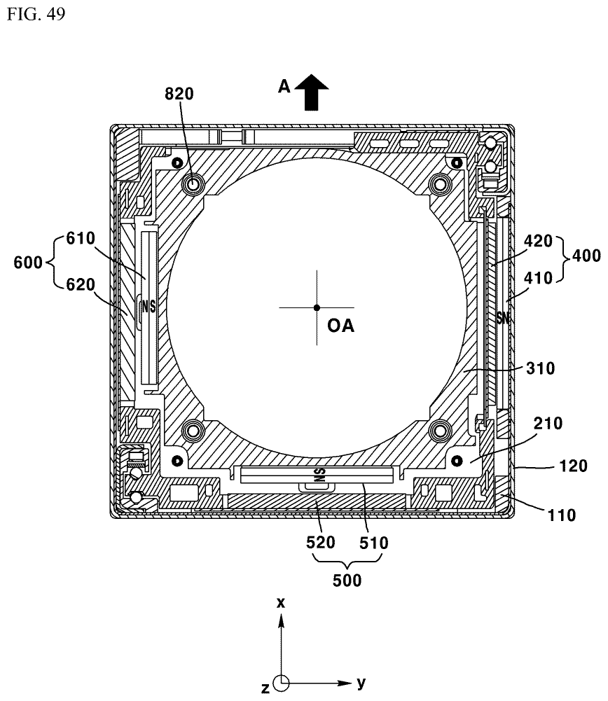

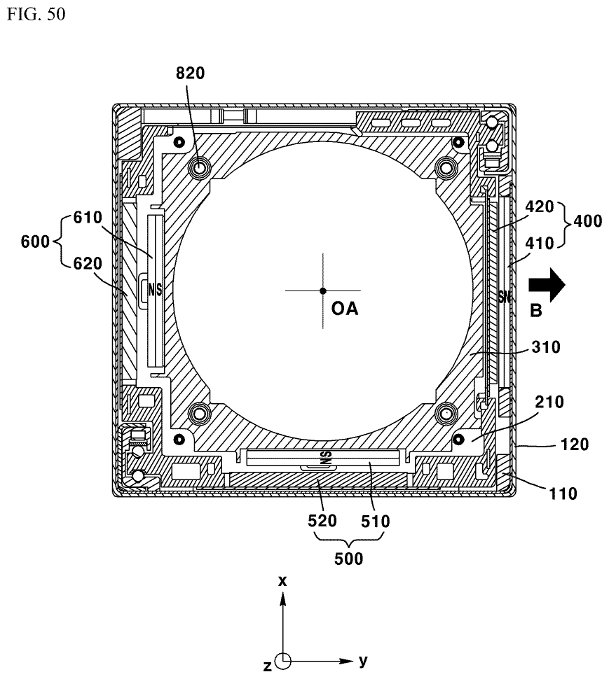

FIGS. 48 to 50 are diagrams for explaining a handshake correction driving of the lens actuator according to a first embodiment of the present invention. FIG. 48 is a cross-sectional view illustrating the appearance of an OIS moving unit in an initial state in which no current is applied to an OIS-x coil and an OIS-y coil. FIG. 49 is a cross-sectional view illustrating the appearance in which an OIS moving unit moves in an x-axis direction perpendicular to an optical axis when a current is applied to an OIS-x coil. FIG. 50 is a cross-sectional view illustrating the appearance in which an OIS moving unit moves in a y-axis direction perpendicular to both an optical axis and an x-axis when a current is applied to an OIS-y coil. As illustrated in FIG. 48, the moving unit may be disposed at an initial position in a state in which no current is applied to the OIS-x coil 520 and the OIS-y coil 620. At this time, the moving unit may be the OIS moving unit 300.

When current is applied to the OIS-x coil 520, the OIS-x magnet 510 can move in an x-axis direction perpendicular to the optical axis due to the electromagnetic interaction between the OIS-x coil 520 and the OIS-x magnet 510 (See A of FIG. 49). At this time, the OIS carrier 310 can move in an x-axis direction together with the OIS-x magnet 510. Furthermore, the lens can move in an x-axis direction together with the OIS carrier 310. More specifically, when a positive current is applied to the OIS-x coil 520, the OIS-x magnet 510, the OIS carrier 310, and the lens can move in one direction on the x-axis. In addition, when a reverse current is applied to the OIS-x coil 520, the OIS-x magnet 510, the OIS carrier 310, and the lens can move in the other direction along the x-axis.

When a current is applied to an OIS-y coil 620, the OIS-y magnet 610 can move in a y-axis direction perpendicular to the optical axis due to the electromagnetic interaction between the OIS-y coil 620 and the OIS-y magnet 610 (See B of FIG. 50). At this time, the OIS carrier 310 can move in a y-axis direction together with the OIS-y magnet 610. Furthermore, the lens can move in a y-axis direction together with the OIS carrier 310. More specifically, when a positive current is applied to the OIS-y coil 620, the OIS-y magnet 610, the OIS carrier 310, and the lens can move in one direction on a y-axis. In addition, when a reverse current is applied to the OIS-y coil 620, the OIS-y magnet 610, the OIS carrier 310, and the lens can move in the other direction on a y-axis.

Meanwhile, the OIS-x sensor 530 can detect the amount of movement or position of the OIS-x magnet 510 by detecting the strength of the magnetic field of the OIS-x magnet 510. The amount of movement or position detected by the OIS-x sensor 530 can be used for x-axis direction handshake correction feedback control. The OIS-y sensor 630 can detect the amount of movement or position of the OIS-y magnet 610 by detecting the strength of the magnetic field of the OIS-y magnet 610. The amount of movement or position detected by the OIS-y sensor 630 can be used for y-axis direction handshake correction feedback control.

Hereinafter, a camera device according to a first embodiment of the present invention will be described with reference to the drawings.

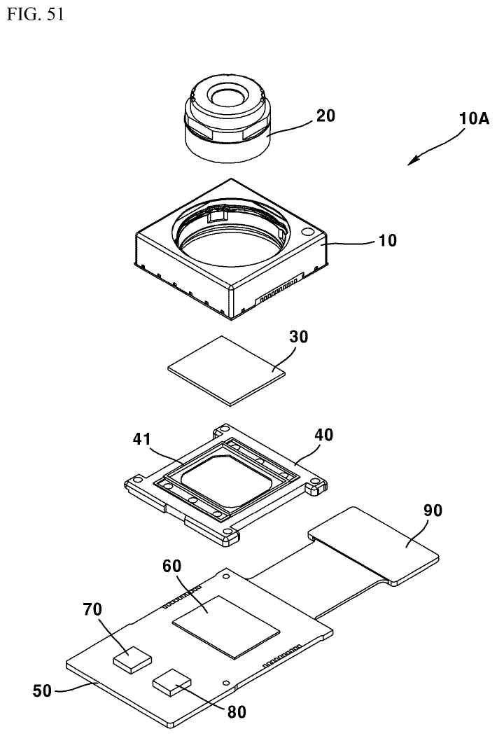

FIG. 51 is an exploded perspective view of a camera device according to a first embodiment of the present invention.

The camera device 10A may comprise a camera module.

The camera device 10A may comprise a lens module 20. The lens module 20 may comprise at least one lens. The lens may be disposed corresponding to the image sensor 60. The lens module 20 may comprise a lens and a barrel. The lens module 20 may be coupled to the OIS carrier 310 of the lens actuator 10. The lens module 20 may be coupled to the OIS carrier 310 by screw coupling and/or an adhesive. The lens module 20 may move integrally with the OIS carrier 310.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light in the infrared region from being incident on the image sensor 60.

The camera device 10A may comprise a sensor base 40. The sensor base 40 may be disposed between the lens actuator 10 and the printed circuit board 50. The sensor base 40 may comprise a protruded portion 41 in which a filter 30 is disposed. An opening may be formed in a portion of the sensor base 40 in which the filter 30 is disposed so that light passing through the filter 30 may be incident on the image sensor 60. An adhesive member may couple or attach the base 110 of the lens actuator 10 to the sensor base 40. The adhesive member may additionally serve to prevent foreign substances from entering the interior of the lens actuator 10. The adhesive member may comprise at least one among an epoxy, a thermosetting adhesive, and an ultraviolet-curable adhesive.

The camera device 10A may comprise a printed circuit board (PCB) 50. The printed circuit board 50 may be a substrate or a circuit board. A lens actuator 10 may be disposed in the printed circuit board 50. A sensor base 40 may be disposed between the printed circuit board 50 and the lens actuator 10. The printed circuit board 50 may be electrically connected to the lens actuator 10. An image sensor 60 may be disposed on the printed circuit board 50. Various circuits, elements, control units, and the like may be provided on the printed circuit board 50 to convert an image being formed on the image sensor 60 into an electrical signal and transmit it to an external device.

The camera device 10A may comprise an image sensor 60. The image sensor 60 may be a configuration in which a light passing through a lens and a filter 30 is incident thereon to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to the control unit 80 through a circuit pattern being provided on the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed on a printed circuit board 50. The control unit 80 may be electrically connected to a coil 330 of a lens driving device 10. The control unit 80 may individually control the direction, intensity, amplitude, and the like of the current supplied to the coil 330. The control unit 80 may control the lens driving device 10 to perform an auto focus function and/or a shake correction function. Furthermore, the control unit 80 may perform auto focus feedback control and/or handshake correction feedback control for the lens driving device 10.

The camera device 10A may comprise a connector 90. The connector 90 may be electrically connected to the printed circuit board 50. The connector 90 may comprise a port for electrically connecting to an external device.

Hereinafter, an optical instrument according to a first embodiment of the present invention will be described with reference to the drawings.

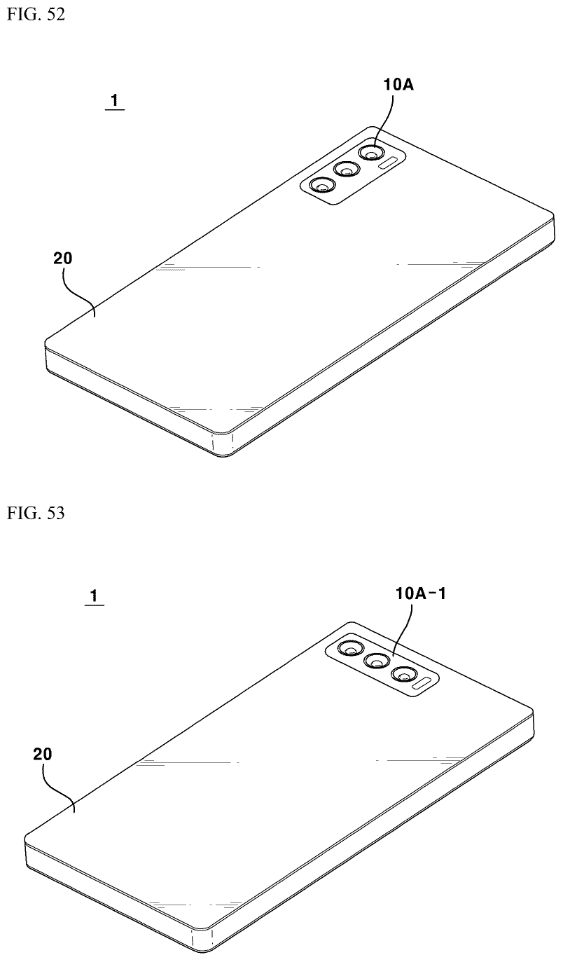

FIG. 52 is a perspective view of an optical instrument according to a first embodiment of the present invention. FIG. 53 is a perspective view of an optical instrument according to a modified embodiment.

The optical instrument 1 may comprise at least one among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical instrument 1 may comprise any device for photographing videos or pictures.

The optical instrument 1 may comprise a main body 20. The optical instrument 1 may comprise a camera device 10A. The camera device 10A may be disposed in the main body 20. The camera device 10A may capture a subject. The optical instrument 1 may comprise a display. The display may be disposed in the main body 20. The display may output one or more of an image and a video captured by the camera device 10A. The display may be disposed on a first surface of the main body 20. The camera device 10A may be disposed on one or more of the first surface of the main body 20 and the second surface opposite to the first surface. As illustrated in FIG. 52, in the camera device 10A, a triple camera may be disposed in a vertical direction. As illustrated in FIG. 53, in the camera device 10A-1, a triple camera may be disposed in a horizontal direction.

Hereinafter, the configuration of a lens actuator according to a second embodiment of the present invention is described with reference to the drawings.

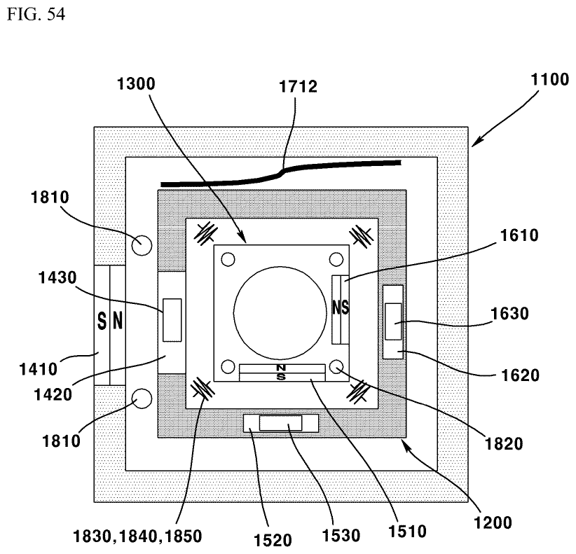

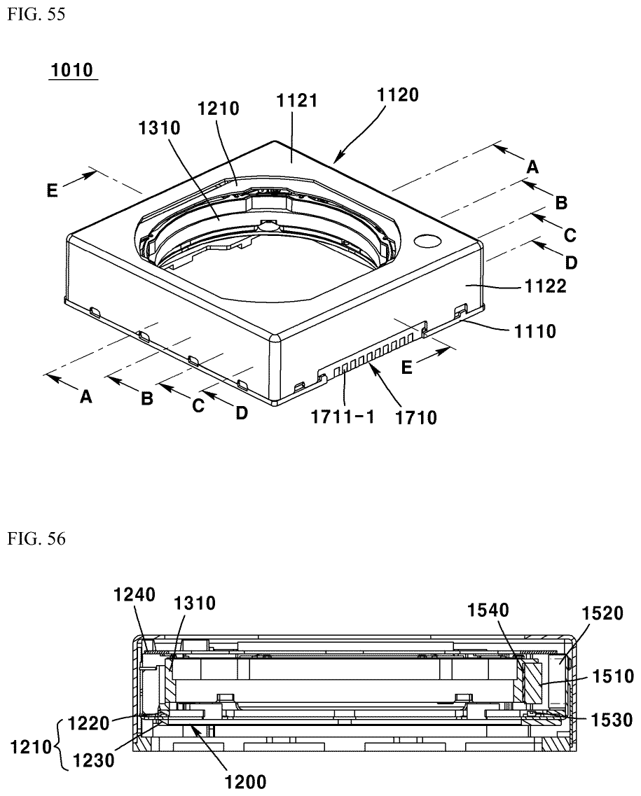

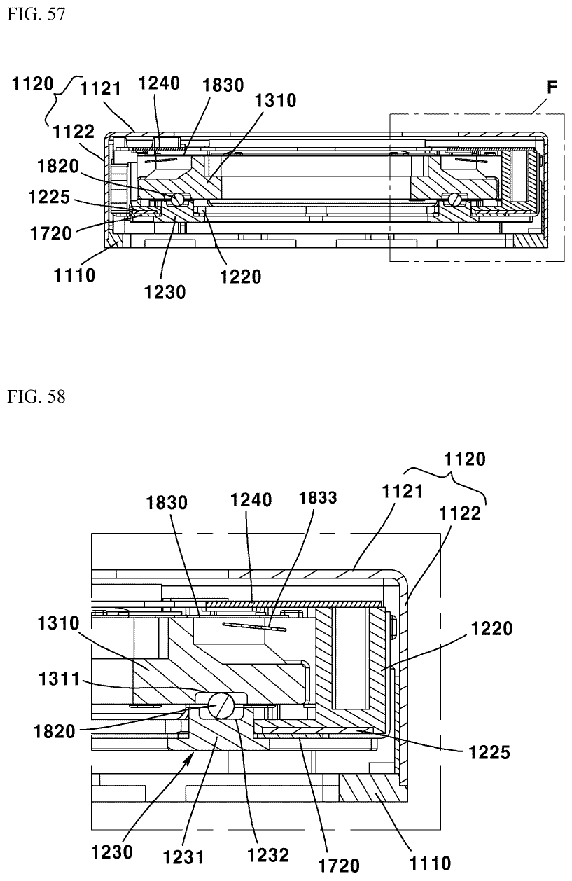

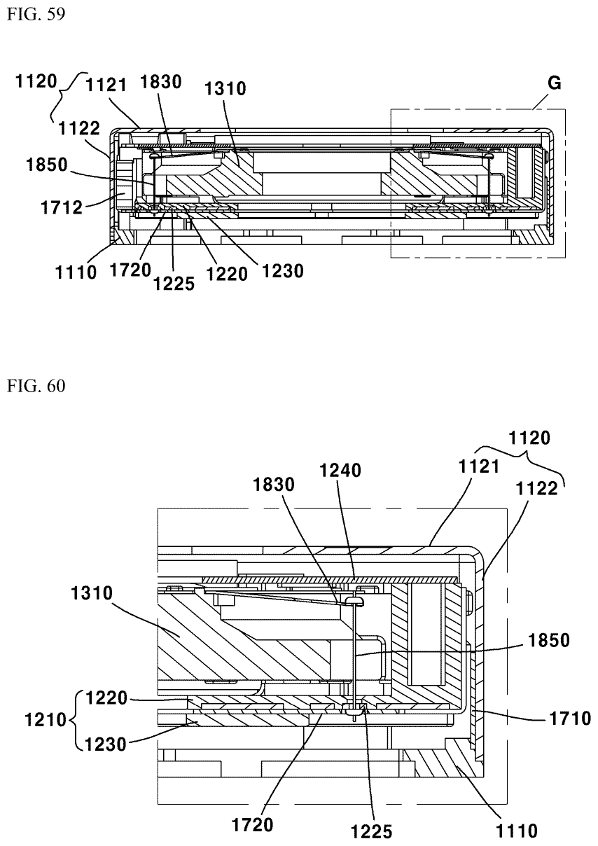

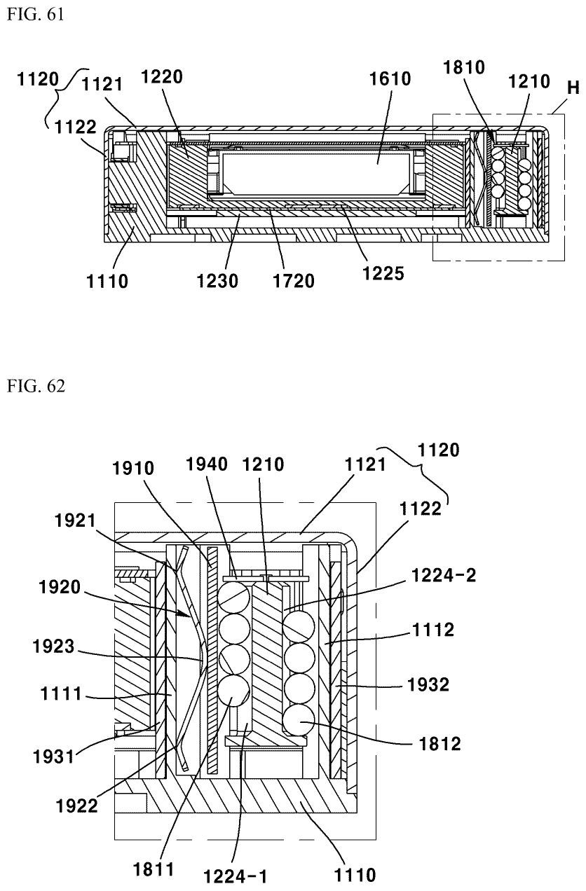

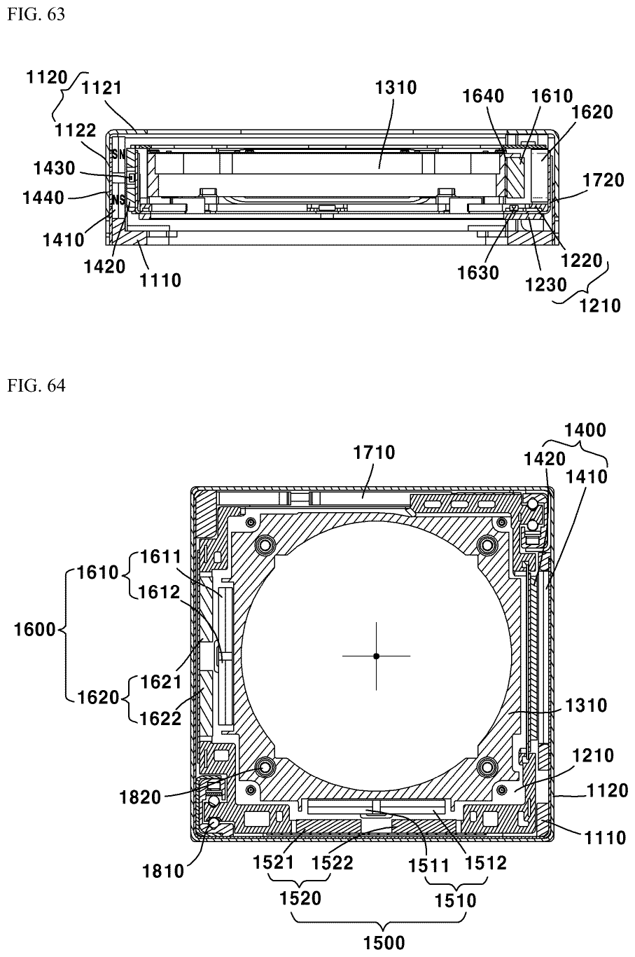

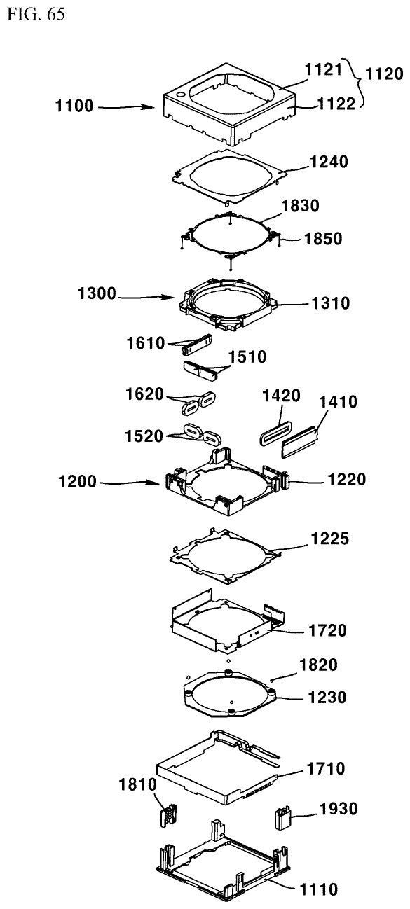

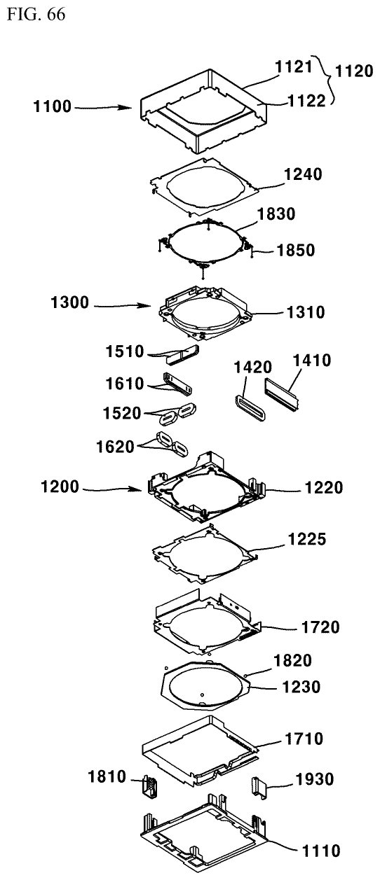

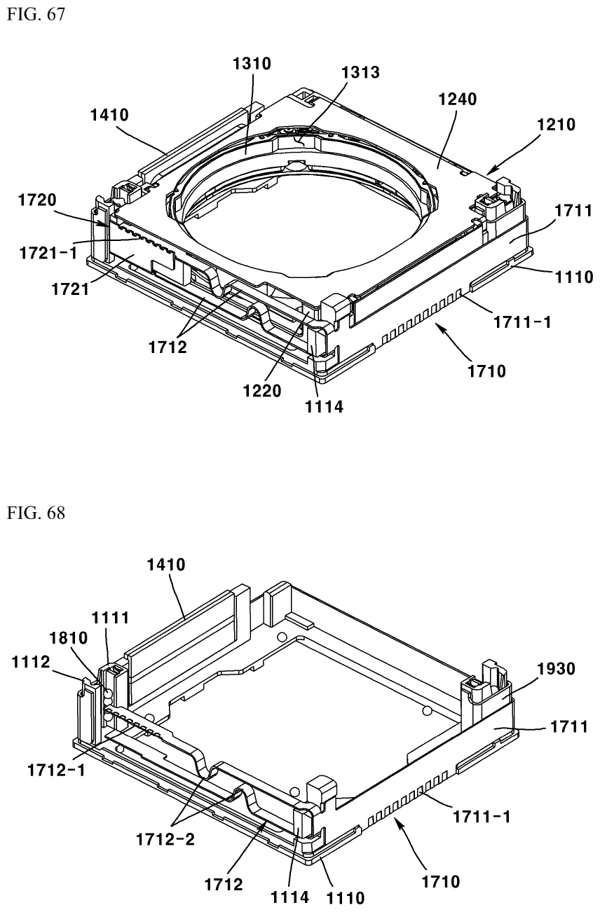

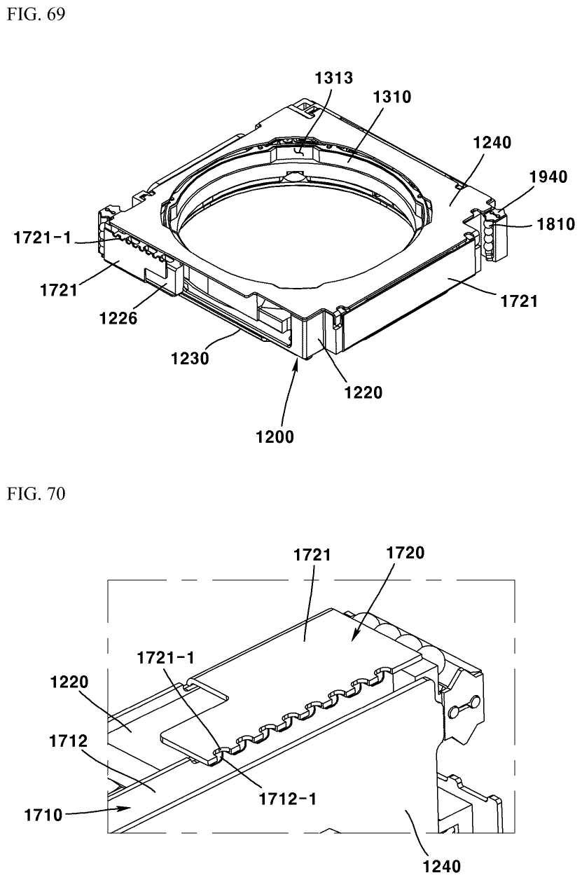

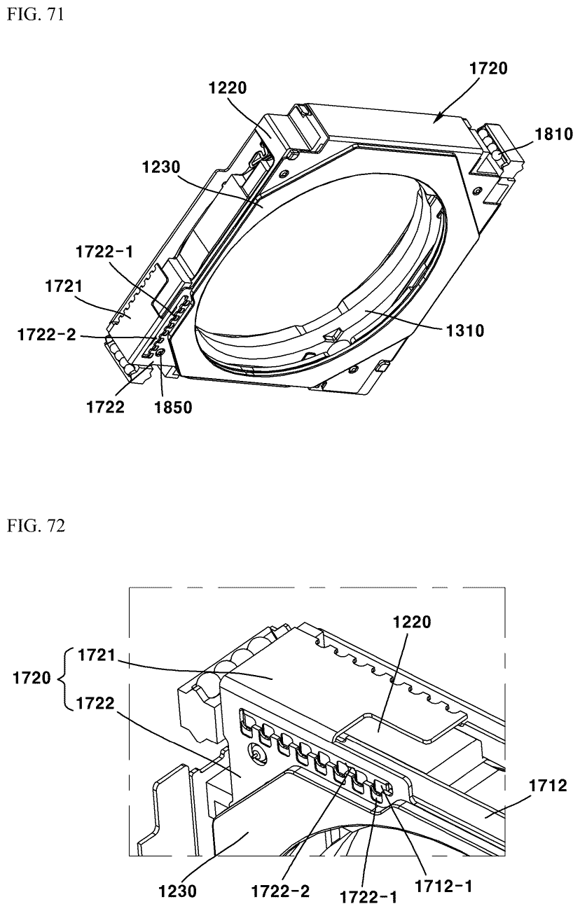

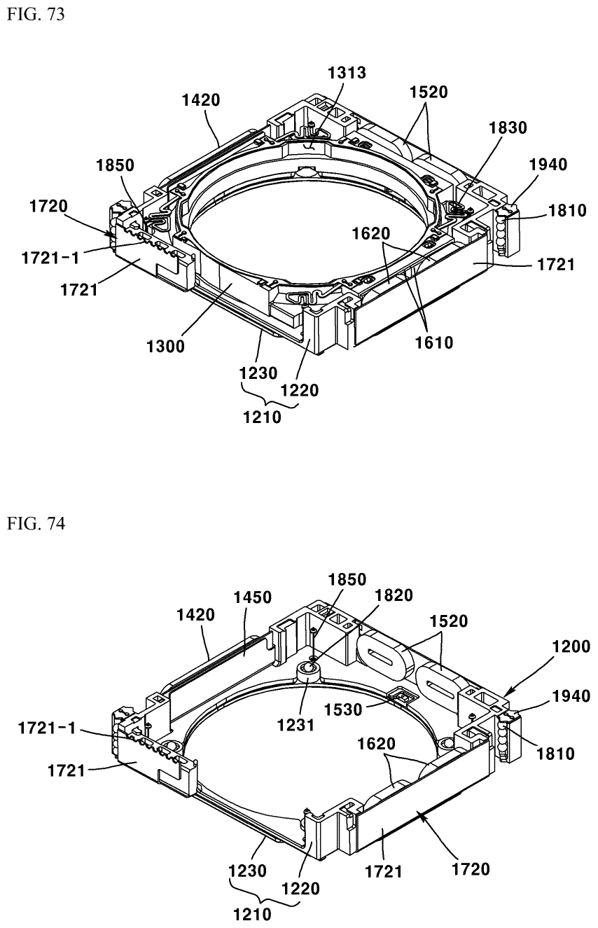

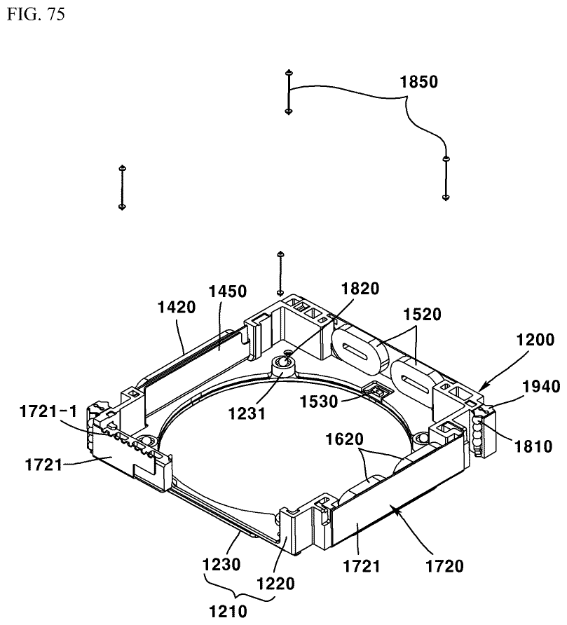

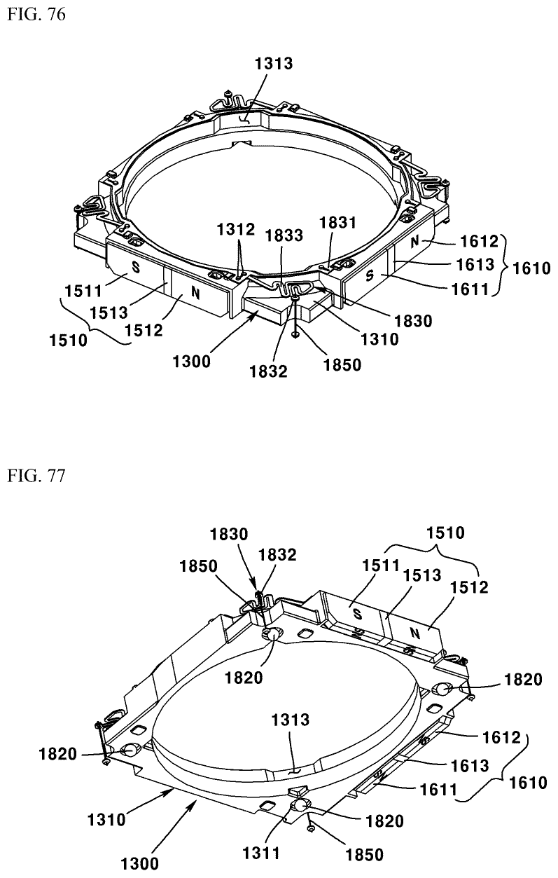

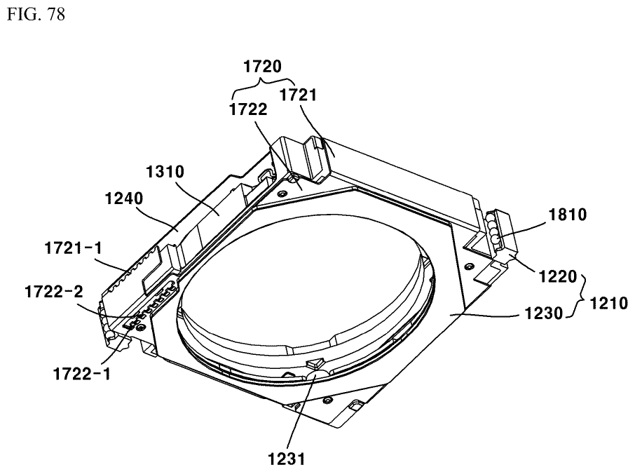

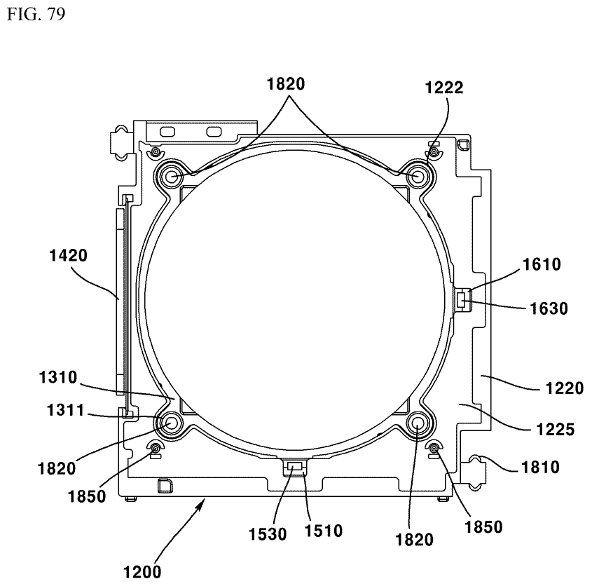

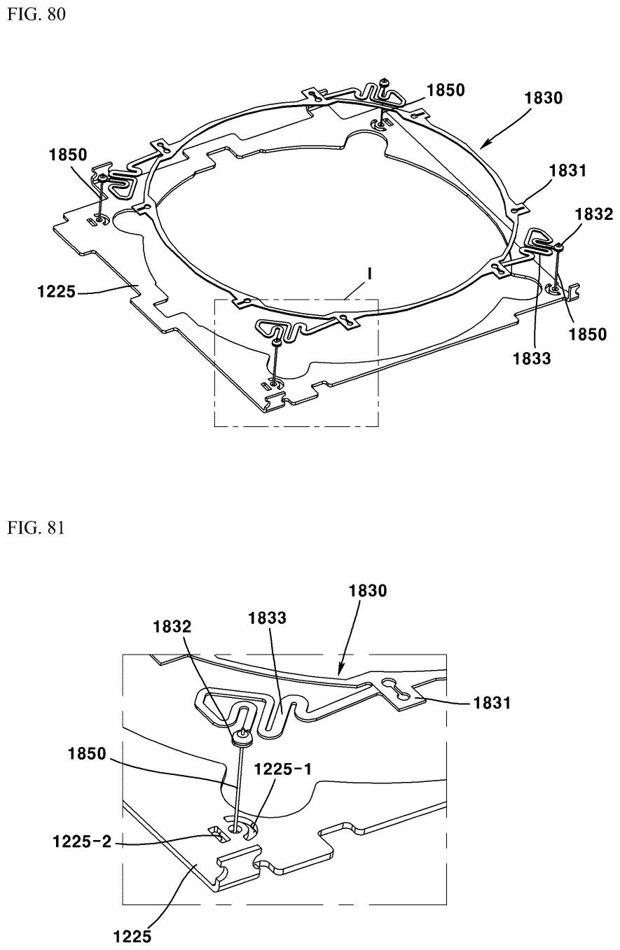

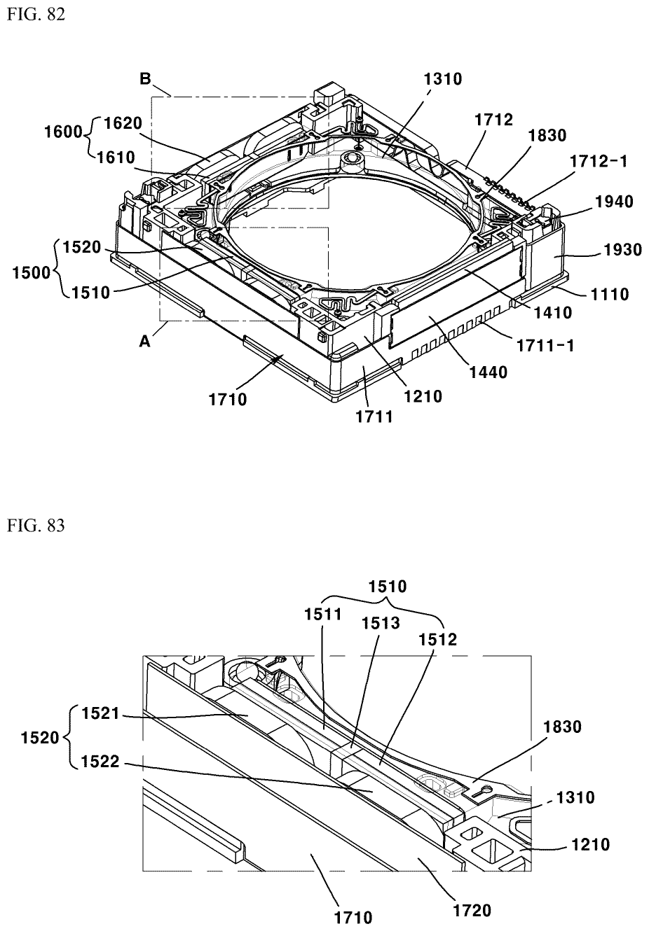

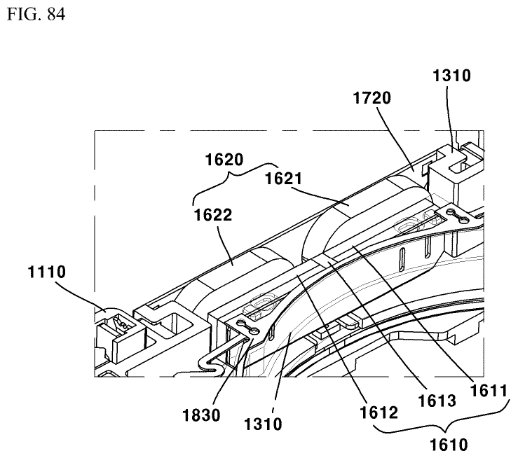

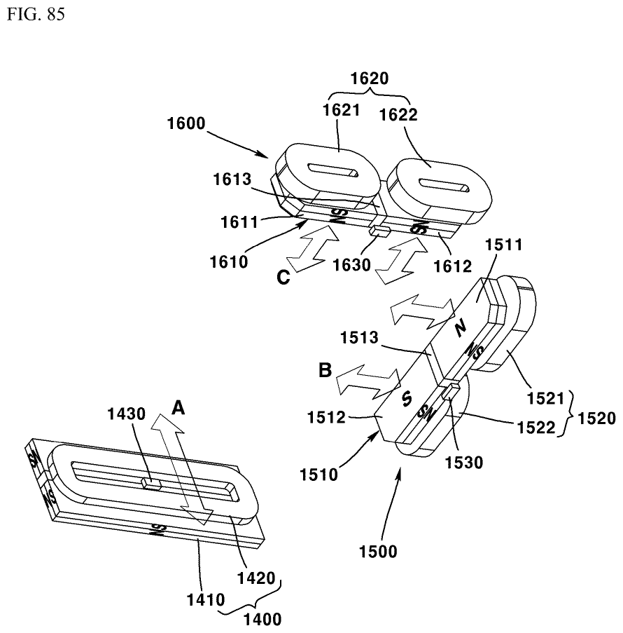

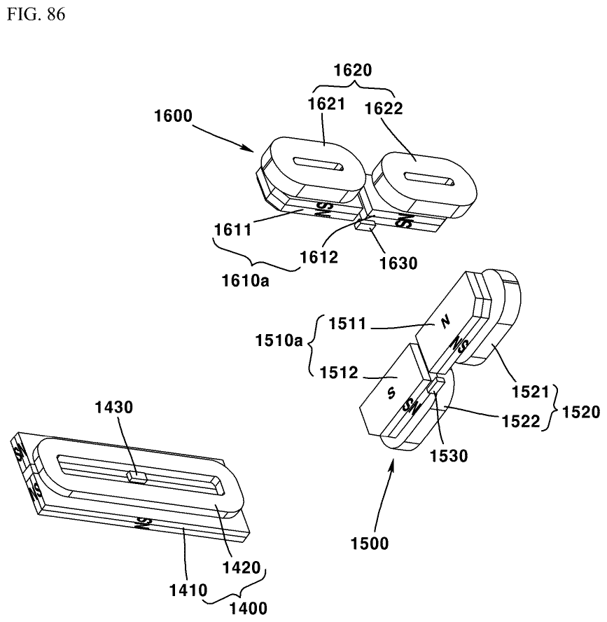

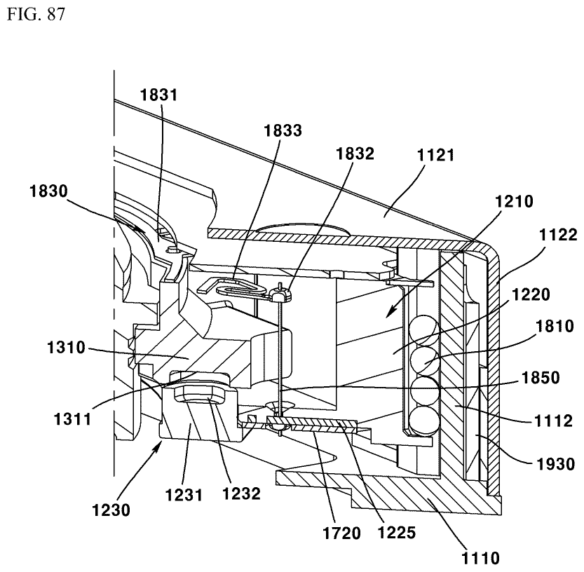

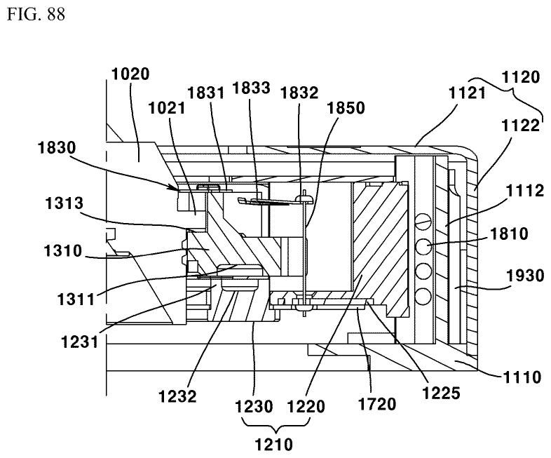

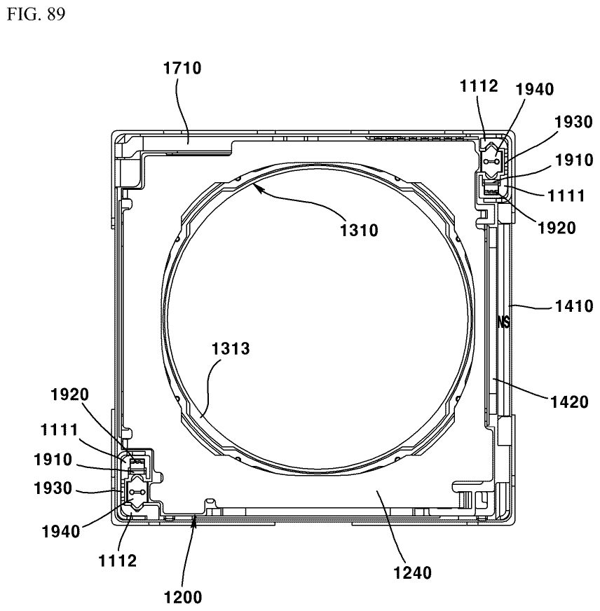

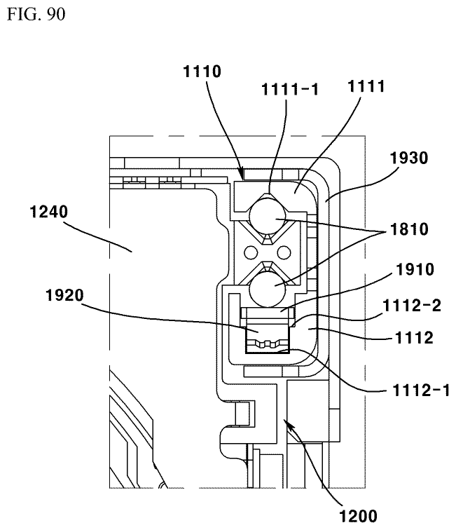

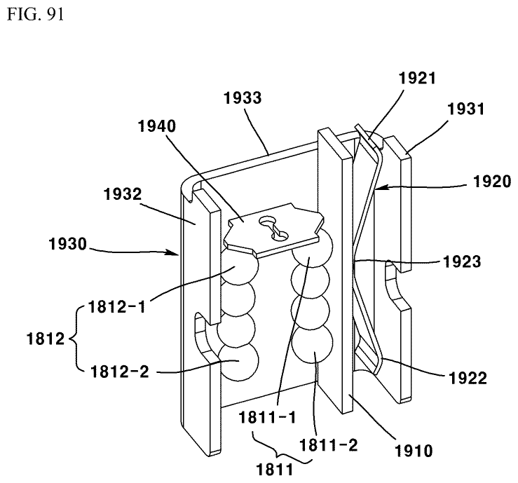

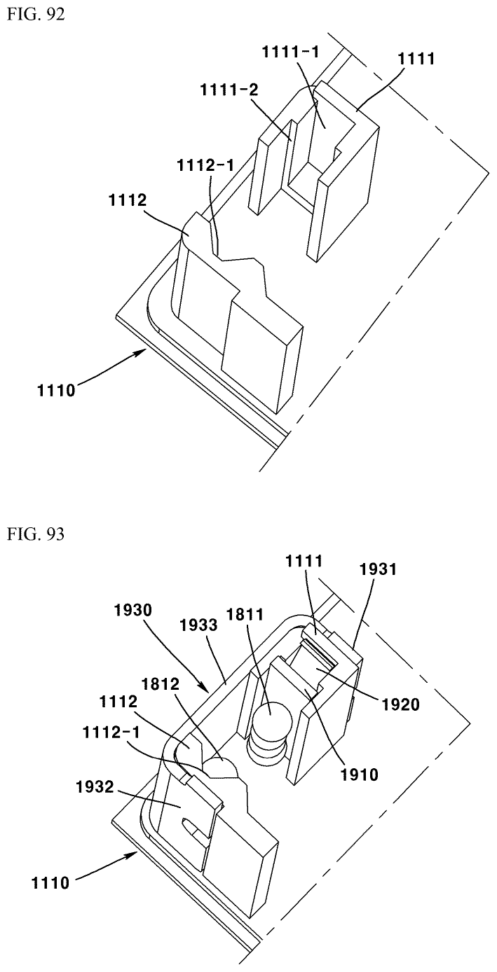

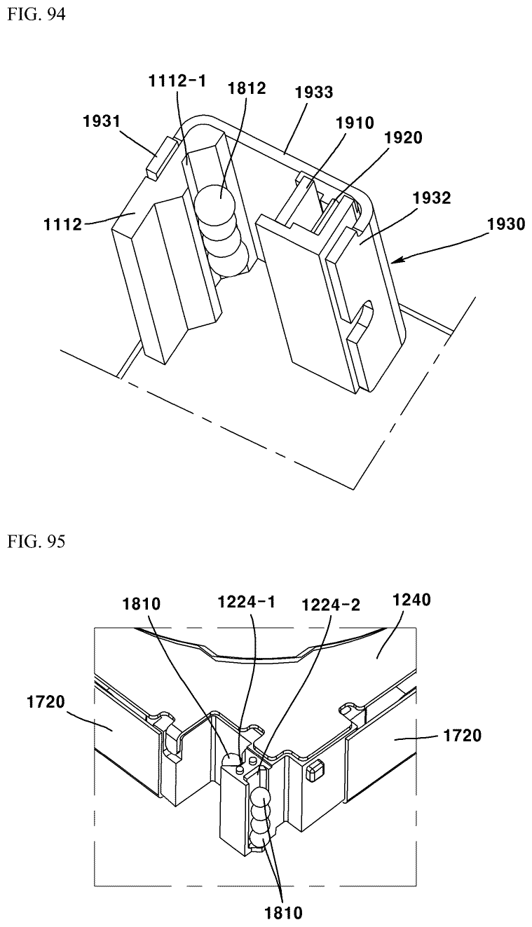

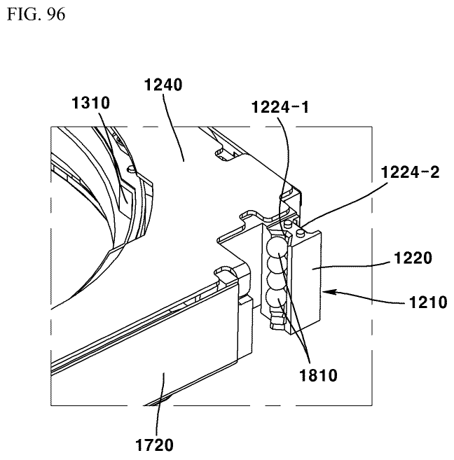

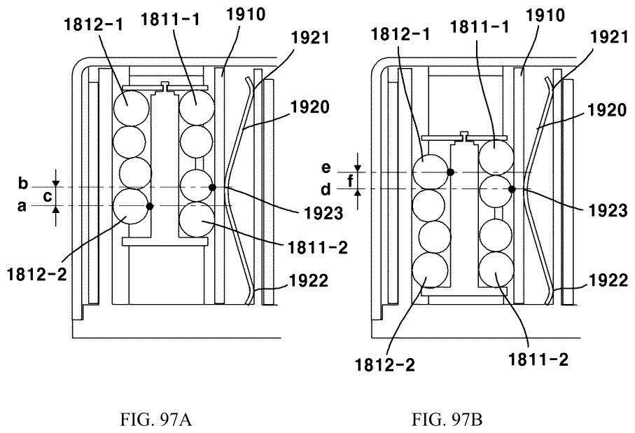

FIG. 54 is a conceptual diagram of a lens actuator according to a second embodiment of the present invention; FIG. 55 is a perspective view of a lens actuator according to a second embodiment of the present invention; FIG. 56 is a cross-sectional view taken along line A-A of FIG. 55; FIG. 57 is a cross-sectional view taken along line B-B of FIG. 55; FIG. 58 is an enlarged view of area F of FIG. 57; FIG. 59 is a cross-sectional view taken along line C-C of FIG. 55; FIG. 60 is an enlarged view of area G of FIG. 59; FIG. 61 is a cross-sectional view taken along line D-D of FIG. 55; FIG. 62 is an enlarged view of area H of FIG. 61; FIG. 63 is a cross-sectional view taken along line E-E of FIG. 55; FIG. 64 is a cross-sectional view taken along line orthogonal to an optical axis and viewed from above of a lens actuator according to a second embodiment of the present invention; FIG. 65 is an exploded perspective view of a lens actuator according to a second embodiment of the present invention; FIG. 66 is an exploded perspective view of a lens actuator according to a second embodiment of the present invention, viewed from a different direction than FIG. 65; FIG. 67 is a perspective view of a lens actuator according to a second embodiment of the present invention with the cover omitted; FIG. 68 is a perspective view illustrating a fixed unit and related components of a lens actuator according to a second embodiment of the present invention; FIG. 69 is a perspective view illustrating a moving unit and related components of a lens actuator according to a second embodiment of the present invention; FIG. 70 is a perspective view illustrating a coupling structure of an inner substrate and an outer substrate of a lens actuator according to a second embodiment of the present invention; FIG. 71 is a bottom perspective view illustrating a moving unit and related components of a lens actuator according to a second embodiment of the present invention; FIG. 72 is a bottom perspective view illustrating a coupling structure of inner and outer substrates of a lens actuator according to a second embodiment of the present invention; FIG. 73 is a perspective view of FIG. 69 with a cover removed; FIG. 74 is a perspective view of FIG. 73 with an OIS moving unit and related components removed; FIG. 75 is an exploded perspective view of FIG. 74 with wires removed; FIG. 76 is a perspective view illustrating an OIS moving unit and related components of a lens actuator according to a second embodiment of the present invention; FIG. 77 is a bottom perspective view viewed from a different direction from FIG. 76; FIG. 78 is a bottom perspective view of FIG. 69 viewed from a different direction; FIG. 79 is a bottom view of FIG. 78 with a preload member and an inner substrate removed; FIG. 80 is a perspective view illustrating a coupling structure of an elastic member, a wire, and a metal member of a lens actuator according to a second embodiment of the present invention; FIG. 81 is an enlarged view of area I of FIG. 80; FIG. 82 is a partial perspective view of a lens actuator according to a second embodiment of the present invention with a cover removed; FIG. 83 is an enlarged view of area A of FIG. 82; FIG. 84 is an enlarged view of area B of FIG. 82; FIG. 85 is a bottom perspective view of a driving unit of a lens actuator according to a second embodiment of the present invention; FIG. 86 is a bottom perspective view of a driving unit of a lens actuator according to a modified embodiment; FIG. 87 is a cross-sectional perspective view illustrating a coupling structure of a wire and a preload member of a lens actuator according to a second embodiment of the present invention; FIG. 88 is a cross-sectional view illustrating a coupling structure of a wire and a preload member of a lens actuator according to a second embodiment of the present invention; FIG. 89 is a plan view of a lens actuator according to a second embodiment of the present invention with a cover removed; FIG. 90 is a plan view of a portion of FIG. 89 enlarged with a cover omitted; FIG. 91 is a perspective view illustrating a ball and related components of a lens actuator according to a second embodiment of the present invention; FIG. 92 is a perspective view illustrating a ball-accommodating structure of a base of a lens actuator according to a second embodiment of the present invention; FIG. 93 is a perspective view illustrating a state in which a ball, a plate member, an elastic member, and a reinforcing member in FIG. 92 are disposed; FIG. 94 is a perspective view of FIG. 93 viewed from a different direction; FIG. 95 is a perspective view illustrating a moving unit and a ball of a lens actuator according to a second embodiment of the present invention; FIG. 96 is a perspective view of FIG. 95 viewed from a different direction; and FIG. 97A is a drawing comparing the heights of a ball and a pressure point when a moving unit moves upward, and FIG. 97B is a drawing comparing the heights of a ball and a pressure point when a moving unit moves downward.

The lens actuator 1010 may be a voice coil motor VCM. The lens actuator 1010 may be a lens driving motor. The lens actuator 1010 may be a lens driving actuator. The lens actuator 1010 may comprise an AF module. The lens actuator 1010 may comprise an OIS module.

The lens actuator 1010 may comprise a fixed unit 1100. The fixed unit 1100 may be a portion that is relatively fixed portion when the moving unit moves. The moving unit may move against the fixed unit 1100.

The lens actuator 1010 may comprise a base 1110. The fixed unit 1100 may comprise a base 1110. The base 1110 may be disposed below the AF carrier 1210. The base 1110 may be disposed below the OIS carrier 1310. The base 1110 may be coupled to the cover 1120. The AF carrier 1210 and the OIS carrier 1310 may be disposed on the base 1110. The AF carrier 1210 and the OIS carrier 1310 may be disposed on the lower plate portion of the base 1110. The AF carrier 1210 and the OIS carrier 1310 may be disposed within the base 1110. The AF carrier 1210 and the OIS carrier 1310 can be disposed within the side wall portion of the base 1110.

The base 1110 may comprise a lower plate portion. The lower plate portion of the base 1110 may support the lower surface of the AF moving unit 1200. The lower plate portion of the base 1110 may support the lower surface of the AF carrier 1210.

The base 1110 may comprise a pillar part 1111. The pillar part 1111 may be extended from an upper surface of the lower plate portion. The pillar part 1111 may be disposed at an inner side of the outer wall part 1112.

The base 1110 may comprise a first guide that guides the AF guide ball 1810 to move. The first guide may comprise an inner groove 1111-1 of the base 1110. The first guide may comprise an outer groove 1112-1 of the base 1110.

The base 1110 may comprise an inner groove 1111-1. The pillar part 1111 may comprise an inner groove 1111-1. The inner groove 1111-1 may be formed in the pillar part 1111. The inner groove 1111-1 may be an ‘AF guide ball accommodating groove’. An AF guide ball 1810 may be disposed in the inner groove 1111-1. The inner ball 1811 may be disposed in the inner groove 1111-1. The inner groove 1111-1 may be in direct contact with the AF guide ball 1810. The inner groove 1111-1 may be disposed in an optical axis direction. The inner groove 1111-1 may comprise a plurality of grooves. The inner groove 1111-1 may comprise two grooves. The two grooves can be disposed parallel to each other. The two grooves can be disposed diagonally with respect to the optical axis.

The base 1110 may comprise a step 1111-2. The step 1111-2 may be formed in the pillar part 1111. A plate member 1910 may be disposed in the step 1111-2.

The base 1110 may comprise an outer wall part 1112. The outer wall part 1112 may be a ‘side portion’. The outer wall part 1112 may be a ‘side plate’. The outer wall part 1112 may be a ‘side wall’. The outer wall part 1112 of the base 1110 may be extended from an upper surface of the lower plate portion.

The base 1110 may comprise an outer groove 1112-1. The outer wall part 1112 may comprise an outer groove 1112-1. The outer groove 1112-1 may be formed to face the inner groove 1111-1. The outer groove 1112-1 may be disposed to face the inner groove 1111-1. The outer groove 1112-1 may be an ‘AF guide ball accommodating groove’. An AF guide ball 1810 may be disposed in the outer groove 1112-1. An outer ball 1812 may be disposed in the outer groove 1112-1. The outer groove 1112-1 may be in direct contact with the AF guide ball 1810. The outer groove 1112-1 may be disposed in an optical axis direction. The outer groove 1112-1 may comprise multiple grooves. The outer groove 1112-1 may comprise two grooves. The two grooves may be disposed parallel to each other. The two grooves may be disposed diagonally with respect to an optical axis. The outer groove 1112-1 may be disposed at an opposite side of the inner groove 1111-1. The outer groove 1112-1 may be formed to have a shape corresponding to the inner groove 1111-1. The outer groove 1112-1 and the inner groove 1111-1 may be formed to have the same length in an optical axis direction.

The base 1110 may comprise a protruded portion 1114. The protruded portion 1114 may be protruded outward. A connecting portion 1712 of an outer substrate 1710 may be disposed above and below the protruded portion 1114. A groove may be formed in the protruded portion 1114 so as not to interfere with the connecting portion 1712 of the outer substrate 1710 even when it moves.

The base 1110 may comprise a step. The step may be formed at a lower end portion of an outer side surface of the base 1110. The step may be protruded from an outer side surface of the base 1110. A side plate 1122 of a cover 1120 may be disposed in the step of the base 1110.

The lens actuator 1010 may comprise a cover 1120. The fixed unit 1100 may comprise a cover 1120. The cover 1120 may be disposed in the base 1110. The cover 1120 may be disposed on the base 1110. The cover 1120 may be coupled to the base 1110. The cover 1120 may be fixed to the base 1110. The cover 1120 may accommodate an AF carrier 1210 therein. The cover 1120 may accommodate an OIS carrier 1310 therein. The cover 1120 may be a shield member. The cover 1120 may be a shield can.

The cover 1120 may comprise an upper plate 1121. The upper plate 1121 may be disposed on a moving unit. The upward movement of the moving unit may be limited by the moving unit by being in contact with the upper plate 1121. The upper plate 1121 may comprise a hole through which light passes.

The cover 1120 may comprise a side plate 1122. The side plate 1122 may be extended from the upper plate 1121. The side plate 1122 may be disposed in the base 1110. The side plate 1122 may be disposed on a step portion being protruded from a lower end portion of an outer side surface of the base 1110. The side plate 1122 may comprise a plurality of side plates. The side plate 1122 may comprise four side plates. The side plate 1122 may comprise a first side plate and a second side plate being disposed opposite to each other, and a third side plate and a fourth side plate being disposed opposite to each other.

The lens actuator 1010 may comprise a moving unit. The moving unit may be disposed in the fixed unit 1100. The moving unit may be disposed within the fixed unit 1100. The moving unit may be disposed on the fixed unit 1100. The moving unit may be movably disposed in the fixed unit 1100. The moving unit may be moved with respect to the fixed unit 1100 by the driving unit. The moving unit may be moved during AF driving. The moving unit may be moved during OIS driving. A lens may be coupled to the moving unit.

The lens actuator 1010 may comprise an AF moving unit 1200. The AF moving unit 1200 may be disposed in the fixed unit 1100. The AF moving unit 1200 may be disposed within the fixed unit 1100. The AF moving unit 1200 may be disposed on the fixed unit 1100. The AF moving unit 1200 may be disposed between the fixed unit 1100 and the OIS moving unit 1300. The AF moving unit 1200 may be movably disposed in the fixed unit 1100. The AF moving unit 1200 may move in an optical axis direction against the fixed unit 1100 by the AF driving unit 1400. The AF moving unit 1200 may move during AF driving.

In a modified embodiment, the AF moving unit 1200 and the AF driving unit 1400 may be omitted. That is, the OIS moving unit 1300 may be disposed in the fixed unit 1100. Or, the OIS moving unit 1300 may be disposed on the fixed unit 1100 and the AF moving unit 1200 may be disposed within the OIS moving unit 1300.

The lens actuator 1010 may comprise an AF carrier 1210. The AF moving unit 1200 may comprise an AF carrier 1210. The AF carrier 1210 may be an ‘AF holder’. The AF carrier 1210 may be a ‘housing’. The AF carrier 1210 may be disposed within the base 1110. The AF carrier 1210 may be disposed on the base 1110. The AF carrier 1210 may be disposed within the cover 1120. The AF carrier 1210 may be disposed between the base 1110 and the OIS carrier 1310. The AF carrier 1210 may be movably disposed in an optical axis direction.

The AF carrier 1210 may comprise a frame, a first upper plate, and a second upper plate. At this time, the frame may be a body part. The frame may be a holder member 1220. The first upper plate may be a metal member 1225. The second upper plate may be a preload member 1230. The AF carrier 1210 may be a housing. The housing may comprise a first housing and a second housing. At this time, the first housing may comprise a holder member 1220 and the second housing may comprise a preload member 1230. The OIS carrier 1310 may be a bobbin. The OIS guide ball 1820 may be disposed between the housing and the bobbin. The AF guide ball 1810 may be disposed between a side surface of the housing and a cover 1120. The AF guide ball 1810 can be disposed between the side surface of the housing and the base or the pillar of the base.

The lens actuator 1010 may comprise a holder member 1220. The AF carrier 1210 may comprise a holder member 1220. The holder member 1220 may be formed separately from the preload member 1230. A wire 1850 may be coupled to the holder member 1220.

The AF carrier 1210 may comprise a lower plate. The lower plate may be disposed below the OIS carrier 1310. The lower plate may be disposed between the OIS carrier 1310 and the base 1110.

The AF carrier 1210 may comprise a groove 1222. The groove 1222 may be a ‘preload member passage hole’. The holder member 1220 may comprise a groove 1222. The lower plate of the holder member 1220 may comprise the groove 1222. The groove 1222 may be formed on a lower plate of the holder member 1220. The groove 1222 may be open inward. A preload member 1230 may be inserted into the groove 1222. A protruded portion 1231 of the preload member 1230 may be inserted into the groove 1222. The groove 1222 may be formed as a hole. The groove 1222 may be redisposed with a hole. That is, in a modified embodiment, the AF carrier 1210 may comprise a groove 1222 into which the protruded portion 1231 of the preload member 1230 is inserted.

The AF carrier 1210 may comprise a side wall. The side wall may be extended downward from the upper plate. An inner substrate 1720 may be disposed at a side wall. An AF coil 1420 may be disposed at a side wall. An OIS-x coil 1520 may be disposed at a side wall. An OIS-y coil 1620 may be disposed at a side wall. The side wall may comprise a groove for avoiding the coil. The side wall may comprise a plurality of side walls. The side wall may comprise four side walls. The side wall may comprise a first side wall and a second side wall being disposed opposite to each other, and a third side wall and a fourth side wall being disposed opposite to each other.

The AF carrier 1210 may comprise a second guide that guides the AF guide ball 1810 to move. The second guide may comprise an inner groove 1224-1 of the AF carrier 1210. The second guide may comprise an outer groove 1224-2 of the AF carrier 1210.

The AF carrier 1210 may comprise an inner groove 1224-1. The holder member 1220 may comprise an inner groove 1224-1. The inner groove 1224-1 may be an ‘AF guide ball accommodating groove’. An AF guide ball 1810 may be disposed in the inner groove 1224-1. An inner ball 1811 may be disposed in the inner groove 1224-1. The inner groove 1224-1 may be in direct contact with the AF guide ball 1810. The inner groove 1224-1 may be disposed in an optical axis direction. The inner groove 1224-1 may guide the AF guide ball 1810 to move in an optical axis direction. The inner groove 1224-1 may comprise a plurality of grooves. The inner groove 1224-1 may comprise two grooves. The two grooves can be disposed parallel to each other. The two grooves can be disposed diagonally with respect to the optical axis.

The AF carrier 1210 may comprise an outer groove 1224-2. The holder member 1220 may comprise an outer groove 1224-2. The outer groove 1224-2 may be an ‘AF guide ball accommodating groove’. An AF guide ball 1810 may be disposed in the outer groove 1224-2. An outer ball 1812 may be disposed in the outer groove 1224-2. The outer groove 1224-2 may be in direct contact with the AF guide ball 1810. The outer groove 1224-2 may be disposed in an optical axis direction. The outer groove 1224-2 may guide the AF guide ball 1810 to move in an optical axis direction. The outer groove 1224-2 may comprise a plurality of grooves. The outer groove 1224-2 may comprise two grooves. The two grooves can be disposed parallel to each other. The two grooves can be disposed diagonally with respect to the optical axis. The outer groove 1224-2 can be disposed opposite the inner groove 1224-1. The outer groove 1224-2 can be formed to have a shape corresponding to the inner groove 1224-1. The outer groove 1224-2 and the inner groove 1224-1 can be formed to have the same length in an optical axis direction.

The AF carrier 1210 may comprise a metal member 1225. The holder member 1220 may comprise the metal member 1225. The metal member 1225 may comprise a lower plate having the metal member 1225. The metal member 1225 may be disposed in the holder member 1220. The metal member 1225 may be insert-molded into the holder member 1220. At least a portion of the metal member 1225 may be disposed on an upper surface of the holder member 1220. A metal member 1225 may be disposed to reinforce the strength of the holder member 1220.

The metal member 1225 may comprise a hole. A wire 1850 may be disposed in the hole. The wire 1850 may pass through the hole of the metal member 1225.

The metal member 1225 may comprise a first hole 1225-1. The first hole 1225-1 may be disposed adjacent to the wire 1850. The first hole 1225-1 may be disposed adjacent to a hole through which the wire 1850 passes. The first hole 1225-1 may be disposed adjacent to a conductive member that connects the wire 1850 and the metal member 1225. The conductive member that connects the wire 1850 and the metal member 1225 may be introduced into the first hole 1225-1. Solder that connects the wire 1850 and the metal member 1225 may be introduced into the first hole 1225-1. The first hole 1225-1 may be formed to have a curvature. The first hole 1225-1 may be formed in a U-shape when viewed from below. The first hole 1225-1 may comprise a curved shape when viewed from below.

The metal member 1225 may comprise a second hole 1225-2. The second hole 1225-2 may be disposed adjacent to the wire 1850. The second hole 1225-2 may be disposed adjacent to a hole through which the wire 1850 passes. The second hole 1225-2 may be disposed adjacent to a conductive member that connects the wire 1850 and the metal member 1225. The conductive member that connects the wire 1850 and the metal member 1225 may be introduced into the second hole 1225-2. The second hole 1225-2 may be disposed at an opposite side of the first hole 1225-1 with respect to the wire 1850. The second hole 1225-2 may be disposed at an opposite side of the first hole 1225-1 with respect to the hole of the metal member 1225 in which the wire 1850 is disposed. Solder that connects the wire 1850 and the metal member 1225 may be introduced into the second hole 1225-2. The second hole 1225-2 may be extended straight.

The AF carrier 1210 may comprise a protruded portion 1226. The holder member 1220 may comprise a protruded portion 1226. The protruded portion 1226 may be formed on an outer side surface of the AF carrier 1210. The protruded portion 1226 may be protruded outward from the AF carrier 1210. A connecting portion 1712 may be disposed on an upper surface and a lower surface of the protruded portion 1226.

The lens actuator 1010 may comprise a preload member 1230. The AF carrier 1210 may comprise a preload member 1230. The preload member 1230 may be coupled to an upper surface of a holder member 1220. The preload member 1230 may be coupled to the holder member 1220. The preload member 1230 may be inserted into and coupled to the holder member 1220 from the upper side. The preload member 1230 may pressurize the OIS guide ball 1820. The preload member 1230 may be in contact with the OIS guide ball 1820. The preload member 1230 may be in directly contact with the OIS guide ball 1820. The preload member 1230 may be coupled to the holder member 1220 to pressurize the OIS guide ball 1820. The preload member 1230 can pressurize a portion of the coil spring 1830 by being in contact with the OIS guide ball 1820.

The preload member 1230 may be disposed between the AF moving unit 1200 and the base 1110 in an optical axis direction. The preload member 1230 may be disposed between the AF moving unit 1200 and the base 1110. The preload member 1230 may be disposed between the AF carrier 1210 and the base 1110.

The AF carrier 1210 may comprise a protruded portion 1231. The preload member 1230 may comprise a protruded portion 1231. The protruded portion 1231 may be ‘protrusion’. The preload member 1230 may have a protruded portion 1231 that guides the OIS guide ball 1820. The protruded portion 1231 may be coupled to a groove 1222 of a holder member 1220. The protruded portion 1231 of the preload member 1230 may be inserted into the groove 1222 of the holder member 1220 from below. The protruded portion 1231 of the preload member 1230 may be disposed in the groove 1222 of the holder member 1220. At least a portion of the protruded portion 1231 of the preload member 1230 may be disposed in the groove 1222 of the holder member 1220. The protruded portion 1231 may comprise a plurality of protrusions. The protruded portion 1231 may comprise four protrusions.

The AF carrier 1210 may comprise a groove 1232. The preload member 1230 may comprise a groove 1232. The groove 1232 may be an ‘OIS guide ball accommodating groove’. The groove 1232 may be formed in the protruded portion 1231. The groove 1232 may be formed on an upper surface of the protruded portion 1231. The groove 1232 may be formed on an end portion of the protruded portion 1231. The groove 1232 may be concavely formed on an upper surface of the protruded portion 1231. An OIS guide ball 1820 may be disposed in the groove 1232. The OIS guide ball 1820 may come into contact with the groove 1232.

The preload member 1230 may comprise a body part 1233. The body part 1233 may be coupled to a holder member 1220. The body part 1233 may be disposed on a lower surface of the holder member 1220. The protruded portion 1231 may protrude upward from the body part 1233.

The lens actuator 1010 may comprise a cover 1240. The AF moving unit 1200 may comprise a cover 1240. The cover 1240 may be coupled to the AF carrier 1210. The cover 1240 may be coupled to an upper surface of the AF carrier 1210. The cover 1240 may be coupled to an upper surface of the AF carrier 1210. The cover 1240 may be coupled to an upper side of the holder member 1220. The cover 1240 may comprise a hook. The hook of the cover 1240 may be coupled to the AF carrier 1210. The hook of the cover 1240 may be protruded downward and be coupled to a side surface of the AF carrier 1210.

The lens actuator 1010 may comprise an OIS moving unit 1300. The OIS moving unit 1300 may be disposed in the fixed unit 1100. The OIS moving unit 1300 may be disposed within the fixed unit 1100. The OIS moving unit 1300 may be disposed on the fixed unit 1100. The OIS moving unit 1300 may be disposed within the AF moving unit 1200. The OIS moving unit 1300 may be disposed on the AF moving unit 1200. The OIS moving unit 1300 may be disposed on a lower plate of the AF moving unit 1200. The OIS moving unit 1300 may be movably disposed. The OIS moving unit 1300 may move in a direction perpendicular to the optical axis with respect to the fixed unit 1100 and the AF moving unit 1200 by the OIS driving unit. The OIS moving unit 1300 can move in an x-axis direction by the OIS-x driving unit 1500. The OIS moving unit 1300 can move in a y-axis direction by the OIS-y driving unit 1600. The OIS moving unit 1300 can move during OIS driving.

The OIS moving unit 1300 may comprise a first side surface and a second side surface which are disposed opposite to each other, and a third side surface and a fourth side surface which are disposed opposite to each other. The OIS-x magnet 1510 may be disposed on a first side surface of the OIS moving unit 1300. The AF magnet 1410 may be disposed on a third side surface of the OIS moving unit 1300 or may be disposed opposite to the third side surface. That is, the AF magnet 1410 may be disposed at a position corresponding to a third side surface of the OIS moving unit 1300. The AF magnet 1410 may be disposed closest to a third side surface among the first to fourth side surfaces of the OIS moving unit 1300. The OIS-y magnet 1610 may be disposed on a fourth side surface of the OIS moving unit 1300.

The lens actuator 1010 may comprise an OIS carrier 1310. The OIS moving unit 1300 may comprise an OIS carrier 1310. The OIS carrier 1310 may be an ‘OIS holder’. The OIS carrier 1310 may be a ‘bobbin’. The OIS carrier 1310 may be disposed within the AF carrier 1210. The OIS carrier 1310 may be disposed within the base 1110. The OIS carrier 1310 may be disposed on the base 1110. The OIS carrier 1310 may be disposed within the cover 1120. The OIS carrier 1310 may be movably disposed in a direction perpendicular to the optical axis. The OIS carrier 1310 may comprise an outer side surface. The OIS carrier 1310 may comprise a plurality of side surfaces. The OIS carrier 1310 may comprise a first side surface and a second side surface being disposed opposite to each other, and a third side surface and a fourth side surface being disposed opposite to each other. The AF coil 1420 may be disposed between the first side surface of the OIS carrier 1310 and the AF magnet 1410. The OIS-x magnet 1510 may be disposed on a third side surface of the OIS carrier 1310. The OIS-y magnet 1610 may be disposed on a second side surface of the OIS carrier 1310.

The OIS carrier 1310 may comprise a groove. The groove may be an ‘elastic member interference prevention groove’. The groove may be formed on an upper surface of the OIS carrier 1310. The groove may be formed concavely on an upper surface of the OIS carrier 1310. The groove may be disposed corresponding to the coil spring 1830 to prevent interference between the OIS carrier 1310 and the coil spring 1830.

The OIS carrier 1310 may comprise a groove 1311. The groove 1311 may be an ‘OIS guide ball accommodating groove’. An OIS guide ball 1820 may be disposed in the groove 1311. The groove 1311 may be in direct contact with the OIS guide ball 1820. The groove 1311 may be concavely formed on a lower surface of the OIS moving unit 1300. The groove 1311 may be concavely formed on a lower surface of the OIS carrier 1310. The groove 1311 may be disposed in a direction perpendicular to the optical axis. The groove 1311 may be recessed in an optical axis direction. The groove 1311 may comprise a plurality of grooves. The groove 1311 may comprise four grooves. The groove 1311 may be formed on a lower surface of the OIS carrier 1310.

The OIS carrier 1310 may comprise a lateral stopper. The lateral stopper may limit the lateral stroke of the OIS carrier 1310. That is, when the OIS carrier 1310 moves to the maximum, the lateral stopper of the OIS carrier 1310 may be in contact with at least one of the AF carrier 1210 and the base 1110. The lateral stopper may be formed on an outer side surface of the OIS carrier 1310. The lateral stopper may be protruded outward from a side surface of the OIS carrier 1310.

The OIS carrier 1310 may comprise a protrusion 1312. The protrusion 1312 may be coupled with an elastic member 1830. The protrusion 1312 may be a ‘coupling protrusion’. The elastic member 1830 may comprise a hole into which the protrusion 1312 of the OIS carrier 1310 is inserted. The protrusion 1312 may be formed on an upper surface of the OIS carrier 1310.

The OIS carrier 1310 may comprise a groove 1313. The groove 1313 may be a ‘lens adhesive accommodating groove’. The groove 1313 may be formed on an inner surface of the OIS carrier 1310. The groove 1313 may be formed concavely on an inner surface of the OIS carrier 1310. An adhesive may be injected between the lens and the OIS carrier 1310 through the groove 1313. An adhesive for bonding the lens and the OIS carrier 1310 may be disposed in the groove 1313.

The OIS carrier 1310 may comprise a mounting portion. The mounting portion may be a ‘magnet mounting portion.’ Magnets 1510 and 1620 may be disposed in the mounting portion. The mounting portion may be formed, for example, as a groove.

The lens actuator 1010 may comprise a driving unit. The driving unit may move the moving unit against the fixed unit 1100. The driving unit may comprise an AF driving unit 1400. The driving unit may comprise an OIS driving unit. The driving unit may comprise an OIS-x driving unit 1500. The driving unit may comprise an OIS-y driving unit 1600. The driving unit may comprise a coil and a magnet.

The lens actuator 1010 may comprise an AF driving unit 1400. The AF driving unit 1400 may move the AF moving unit 1200 in an optical axis direction. The AF driving unit 1400 may move the AF carrier 1210 in an optical axis direction. The AF driving unit 1400 may move the AF carrier 1210 in an optical axis direction through electromagnetic force. The AF driving unit 1400 may comprise a coil and a magnet.

The lens actuator 1010 may comprise an AF magnet 1410 and an AF coil 1420 that move the AF moving unit 1200 in an optical axis direction.

In a second embodiment of the present invention, the AF carrier 1210 and the OIS carrier 1310 can move in an optical axis direction by the interaction between the AF coil 1420 and the AF magnet 1410. The AF coil 1420, the AF carrier 1210, and the OIS carrier 1310 can move integrally in an optical axis direction.

The lens actuator 1010 may comprise an AF magnet 1410. The AF driving unit 1400 may comprise an AF magnet 1410. The AF magnet 1410 may be an ‘AF magnet’. The AF magnet 1410 may be a permanent magnet. The AF magnet 1410 may be disposed in the fixed unit 1100. The AF magnet 1410 may be disposed in the base 1110. The AF magnet 1410 may be disposed in the cover 1120. The AF magnet 1410 may be disposed in the side plate 1122 of the cover 1120. The AF magnet 1410 may be disposed on an outer side surface of the base 1110. The AF magnet 1410 may be disposed on an inner side surface of the base 1110. The AF magnet 1410 can be fixed to the base 1110. The AF magnet 1410 can be coupled to the base 1110. The AF magnet 1410 can be bonded to the base 1110 with an adhesive. The AF magnet 1410 can be disposed within the cover 1120. The AF magnet 1410 can interact with the AF coil 1420. The AF magnet 1410 can electromagnetically interact with the AF coil 1420. The AF magnet 1410 can be disposed at a position corresponding to the AF coil 1420. The AF magnet 1410 can face the AF coil 1420. The AF magnet 1410 can face the AF coil 1420. The AF magnet 1410 can be overlapped with the AF coil 1420 in a direction perpendicular to the optical axis.

The AF magnet 1410 may be a four-pole magnet. The AF magnet 1410 may comprise a four-pole magnetizing magnet. The AF magnet 1410 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be disposed spaced apart from each other in a vertical direction, and a neutral portion may be disposed between the first magnet portion and the second magnet portion.

The lens actuator 1010 may comprise an AF coil 1420. The AF driving unit 1400 may comprise the AF coil 1420. The AF coil 1420 may interact with the AF magnet 1410. The AF coil 1420 may face the AF magnet 1410. The AF coil 1420 may be disposed at a position corresponding to the AF magnet 1410. The AF coil 1420 may be overlapped with the AF magnet 1410 in a direction perpendicular to the optical axis. The AF coil 1420 may be disposed in the inner substrate 1720. The AF coil 1420 may be disposed in the AF carrier 1210. The AF coil 1420 may be disposed in the AF moving unit 1200.

In a second embodiment of the present invention, the AF coil 1420 can move in an optical axis direction. The AF coil 1420 can move in an optical axis direction through interaction with the AF magnet 1410. The AF coil 1420 can move together with the AF moving unit 1200. The AF coil 1420 can move in an optical axis direction together with the AF moving unit 1200. During the AF driving process, the AF coil 1420 can move in an optical axis direction together with the AF moving unit 1200. The AF coil 1420 can be disposed in the AF moving unit 1200. The AF coil 1420 can be fixed to the AF moving unit 1200. The AF coil 1420 can be coupled to the AF moving unit 1200.

The lens actuator 1010 may comprise an AF sensor 1430. The AF driving unit 1400 may comprise an AF sensor 1430. The AF sensor 1430 may be a Hall sensor. The AF sensor 1430 may be disposed in the inner substrate 1720. The AF sensor 1430 may detect the AF magnet 1410. The AF sensor 1430 may detect the movement of the AF magnet 1410. The movement amount or position of the AF magnet 1410 detected by the AF sensor 1430 may be used for feedback of auto focus driving.

The AF sensor 1430 may be a driver IC. The driver IC may comprise a sensing unit. The sensing unit may comprise a Hall element (Hall IC). The driver IC may be electrically connected to the AF coil 1420. The driver IC may supply current to the AF coil 1420.

The AF sensor 1430 may be disposed within the AF coil 1420. The AF sensor 1430 may be overlapped with the neutral portion of the AF magnet 1410 in a direction perpendicular to the optical axis. In a modified embodiment, the AF sensor 1430 may be disposed outside the AF coil 1420. The AF sensor 1430 may be overlapped with the AF coil 1420 in an optical axis direction. The AF sensor 1430 may be overlapped with the AF coil 1420 in a direction perpendicular to the optical axis.

The lens actuator 1010 may comprise an AF yoke 1440. The AF yoke 1440 may be disposed corresponding to the AF magnet 1410. An attractive force may be applied between the AF yoke 1440 and the AF magnet 1410. The AF guide ball 1810 may be maintained in contact with the base 1110 and the AF carrier 1210 by the attractive force between the AF yoke 1440 and the AF magnet 1410. The AF yoke 1440 may be disposed in the inner substrate 1720. The AF yoke 1440 may be disposed inside the AF coil 1420.

The lens actuator 1010 may comprise an AF attractive force yoke 1450. The AF attractive force 1450 may act attractive force with the AF magnet 1410. The AF attractive force 1450 may be disposed on an inner side of the AF coil 1420. The attractive force 1450 may be disposed on an inner surface of the side plate portion 1721 of the inner substrate 1720. The attractive force yoke 1450 may pull the AF magnet 1410 inward.

The lens actuator 1010 may comprise an OIS driving unit. The OIS driving unit may move the OIS moving unit 1300 in a direction perpendicular to the optical axis direction. The OIS driving unit may move the OIS carrier 1310 in a direction perpendicular to the optical axis. The OIS driving unit may move the OIS carrier 1310 in a direction perpendicular to the optical axis through electromagnetic force.

The lens actuator 1010 may comprise an OIS-x driving unit 1500. The OIS driving unit may comprise an OIS-x driving unit 1500. The OIS-x driving unit 1500 may move the OIS carrier 1310 in an x-axis direction perpendicular to the optical axis. The OIS-x driving unit 1500 may move the OIS carrier 1310 in an x-axis direction perpendicular to the optical axis through electromagnetic force. The OIS-x driving unit 1500 may comprise a coil and a magnet. The lens actuator 1010 may comprise an OIS-x magnet 1510 and an OIS-x coil 1520 that move the OIS moving unit 1300 in an x-axis direction perpendicular to the optical axis direction.

In a second embodiment of the present invention, the OIS-x magnet 1510 and the OIS-x coil 1520 can move the OIS moving unit 1300 in a first direction perpendicular to the optical axis direction. At this time, the first direction may be an x-axis direction. The OIS carrier 1310 can move in an x-axis direction perpendicular to the optical axis direction by the interaction between the OIS-x coil 1520 and the OIS-x magnet 1510. The OIS-x magnet 1510 and the OIS carrier 1310 can move integrally in an x-axis direction.

The lens actuator 1010 may comprise an OIS-x magnet 1510. The OIS driving unit may comprise an OIS-x magnet 1510. The OIS-x magnet 1510 may be an ‘OIS-x magnet’. The OIS-x magnet 1510 may be a permanent magnet. The OIS-x magnet 1510 may be disposed in the OIS moving unit 1300. The OIS-x magnet 1510 may be spaced apart from the AF magnet 1410. The OIS-x magnet 1510 may be disposed in the OIS carrier 1310. The OIS-x magnet 1510 may be disposed on an outer surface of the OIS carrier 1310. The OIS-x magnet 1510 may be fixed to the OIS carrier 1310. The OIS-x magnet 1510 can be coupled to the OIS carrier 1310. The OIS-x magnet 1510 can be bonded to the OIS carrier 1310 with an adhesive. The OIS-x magnet 1510 can be disposed inside the cover 1120. The OIS-x magnet 1510 can interact with the OIS-x coil 1520. The OIS-x magnet 1510 can electromagnetically interact with the OIS-x coil 1520. The OIS-x magnet 1510 can be disposed at a position corresponding to the OIS-x coil 1520. The OIS-x magnet 1510 can face the OIS-x coil 1520. The OIS-x magnet 1510 can face the OIS-x coil 1520. The OIS-x magnet 1510 can be overlapped with the OIS-x coil 1520 in a direction perpendicular to the optical axis. The OIS-x magnet 1510 can be overlapped with the OIS-x coil 1520 in an x-axis direction. The OIS-x magnet 1510 can move in an x-axis direction perpendicular to the optical axis.

The OIS-x magnet 510 may be a two-pole magnet. The OIS-x magnet 510 may comprise a two-pole magnetizing magnet. The OIS-x magnet 510 may comprise an N pole and an S pole (See B in FIG. 85).

The OIS-x magnet 1510 may be a two-pole magnet. The OIS-x magnet 1510 may comprise a two-pole magnetizing magnet. The OIS-x magnet 1510 may comprise an N pole and an S pole.

The OIS-x magnet 1510 may comprise a first magnet portion 1511. The first magnet portion 1511 may comprise an N pole and an S pole. The first magnet portion 1511 may be disposed on a first side surface of the OIS moving unit 1300. The first magnet portion 1511 may comprise an inner surface being disposed on a first side surface of the OIS moving unit 1300 and an outer surface opposite to the inner surface. The inner surface of the first magnet portion 1511 may be formed as an N pole in its entirety. The outer surface of the first magnet portion 1511 may be formed as an S pole in its entirety. Or, conversely, the inner surface of the first magnet portion 1511 may be an S pole and the outer surface may be an N pole.

The OIS-x magnet 1510 may comprise a second magnet portion 1512. The second magnet portion 1512 may comprise a south pole and a north pole. The second magnet portion 1512 may be disposed on a first side surface of the OIS moving unit 1300. The second magnet portion 1512 may comprise an inner surface disposed on a first side surface of the OIS moving unit 1300 and an outer surface opposite the inner surface. The inner surface of the second magnet portion 1512 may be formed as a south pole in its entirety. The outer surface of the second magnet portion 1512 may be formed as a north pole in its entirety. Or, conversely, the inner surface of the second magnet portion 1512 may be a north pole and the outer surface may be a south pole.

The first magnet portion 1511 and the second magnet portion 1512 may be overlapped with each other in a y-axis direction perpendicular to the optical axis direction and the x-axis direction. The first magnet portion 1511 and the second magnet portion 1512 may be formed to have the same size. The first magnet portion 1511 and the second magnet portion 1512 may be formed to have the same shape.

In a second embodiment of the present invention, the first magnet portion 1511 and the second magnet portion 1512 of the OIS-x magnet 1510 may have outer surfaces formed with different polarities. However, in a modified embodiment, the first magnet portion 1511 and the second magnet portion 1512 of the OIS-x magnet 1510 may have outer surfaces formed with the same polarity.

The polarity of the first magnet portion 1511 facing the first coil portion 1521 and the polarity of the second magnet portion 1512 facing the second coil portion 1522 may be different from each other. The polarity of the entire area of the first magnet portion 1511 facing the first coil portion 1521 may be a south pole. The polarity of the entire area of the first magnet portion 1511 facing the first coil portion 1521 may be a single polarity. The polarity of the entire area of the second magnet portion 1512 facing the second coil portion 1522 may be a north pole. The polarity of the entire area of the second magnet portion 1512 facing the second coil portion 1522 may be a single polarity.

The OIS-x magnet 1510 may comprise a neutral portion 1513. The neutral portion 1513 may be disposed between the first magnet portion 1511 and the second magnet portion 1512. The neutral portion 1513 may have a lower polarity than the first magnet portion 1511 and the second magnet portion 1512. The neutral portion 1513 may have a lower magnetism than the first magnet portion 1511 and the second magnet portion 1512. The neutral portion 1513 may not have a polarity. The neutral portion 1513 may be non-polar. The neutral portion 1513 may not have magnetism. The neutral portion 1513 may be non-magnetic.

In a first embodiment of the present invention, the first magnet portion 1511, the second magnet portion 1512, and the neutral portion 1513 may be formed integrally. That is, the first magnet portion 1511, the second magnet portion 1512, and the neutral portion 1513 may be a single four-pole magnetized magnet.

As illustrated in FIG. 86, in a modified embodiment, the first magnet portion 1511 and the second magnet portion 1512 may be formed as separate magnets. That is, the OIS-x magnet 1510a may comprise the first magnet portion 1511 and the second magnet portion 1512 formed as separate magnets. The first magnet portion 1511 and the second magnet portion 1512 may be spaced apart from each other. A gap, which is not a neutral portion, may be formed between the first magnet portion 1511 and the second magnet portion 1512. Or, the first magnet portion 1511 and the second magnet portion 1512 may be in contact with each other such that there is no neutral portion or gap between the first magnet portion 1511 and the second magnet portion 1512.

The lens actuator 1010 may comprise an OIS-x coil 1520. The OIS driving unit may comprise an OIS-x coil 1520. The OIS-x coil 1520 may interact with the OIS-x magnet 1510. The OIS-x coil 1520 may move the OIS-x magnet 1510 in an x-axis direction perpendicular to the optical axis. The OIS-x coil 1520 may move the OIS-x magnet 1510 in an x-axis direction through interaction with the OIS-x magnet 1510. The OIS-x coil 1520 may face the OIS-x magnet 1510. The OIS-x coil 1520 may face the OIS-x magnet 1510. The OIS-x coil 1520 may be disposed corresponding to the OIS-x magnet 1510. The OIS-x coil 1520 may be overlapped with the OIS-x magnet 1510 in a direction perpendicular to the optical axis. The OIS-x coil 1520 may be disposed in the inner substrate 1720. The OIS-x coil 1520 may be disposed in the AF carrier 1210.

In a second embodiment of the present invention, the OIS-x coil 1520 can move together with the AF moving unit 1200. The OIS-x coil 1520 can move in an optical axis direction together with the AF moving unit 1200. During the AF driving process, the OIS-x coil 1520 can move in an optical axis direction together with the AF moving unit 1200. The OIS-x coil 1520 can be disposed in the AF moving unit 1200. The OIS-x coil 1520 can be fixed to the AF moving unit 1200. The OIS-x coil 1520 can be coupled to the AF moving unit 1200. When a current is applied to the OIS-x coil 1520, the OIS-x magnet 1510 can move away from or closer to the OIS-x coil 1520 in an x-axis direction.

The OIS-x coil 1520 may comprise a first coil portion 1521. The first coil portion 1521 may interact with the first magnet portion 1511. The first coil portion 1521 may be overlapped with the first magnet portion 1511 in an x-axis direction. That is, the first coil portion 1521 and the first magnet portion 1511 may be overlapped in a direction that matches the driving direction due to the interaction.

The OIS-x coil 1520 may comprise a second coil portion 1522. The second coil portion 1522 may interact with the second magnet portion 1512. The second coil portion 1522 may be overlapped with the second magnet portion 1512 in an x-axis direction. That is, the second coil portion 1522 and the second magnet portion 1512 may be overlapped with each other in a direction that matches the driving direction due to the interaction.

The OIS-x coil 1520 may comprise two coils. The OIS-x coil 1520 may comprise two bundles of coils. The OIS-x coil 1520 may comprise two ring-shaped coils. The OIS-x coil 1520 may comprise two coil units. The OIS-x coil 1520 may comprise two split coils. The OIS-x coil 1520 may be separated into two coils. The OIS-x coil 1520 may be separated into two regions. Each of the first coil portion 1521 and the second coil portion 1522 may comprise a ring shape. The first coil portion 1521 and the second coil portion 1522 can be formed as separate coils.

The first coil portion 1521 and the second coil portion 1522 can be connected. The first coil portion 1521 can be electrically connected to the second coil portion 1522. At this time, the winding direction of the first coil portion 1521 can be opposite to the winding direction of the second coil portion 1522. In this case, when a current is applied, the direction of the electromagnetic force induced in s first coil portion 1521 and s second coil portion 1522 can be opposite.

In a modified embodiment, the first coil portion 1521 and the second coil portion 1522 may have the same winding direction. At this time, the directions of the currents applied to the first coil portion 1521 and the second coil portion 1522 may be opposite.

The lens actuator 1010 may comprise an OIS-x sensor 1530. The OIS driving unit may comprise an OIS-x sensor 1530. The OIS-x sensor 1530 may be disposed in an inner substrate 1720. The OIS-x sensor 1530 may comprise a Hall sensor. The OIS-x sensor 1530 may detect an OIS-x magnet 1510. The OIS-x sensor 1530 may detect a magnetic force of the OIS-x magnet 1510. The OIS-x sensor 1530 may be disposed at a lower side of the OIS-x magnet 1510. The OIS-x sensor 1530 may be overlapped with the OIS-x magnet 1510 in an optical axis direction. In a modified embodiment, the OIS-x sensor 1530 may be disposed within the OIS-x coil 1520. The OIS-x sensor 1530 may be overlapped with the OIS-x coil 1520 in an optical axis direction. The OIS-x sensor 1530 may be overlapped with the OIS-x coil 1520 in a direction perpendicular to the optical axis. The OIS-x sensor 1530 may face the OIS-x magnet 1510. The OIS-x sensor 1530 may be disposed at a position corresponding to the OIS-x magnet 1510. The OIS-x sensor 1530 may detect movement of the OIS-x magnet 1510. The amount of movement or position of the OIS-x magnet 1510 detected by the OIS-x sensor 1530 may be used for feedback of handshake correction driving in an x-axis direction.

The lens actuator 1010 may comprise an OIS-x yoke 1540. The OIS-x yoke 1540 may be disposed in an OIS-x magnet 1510. The OIS-x yoke 1540 may be disposed between the OIS-x magnet 1510 and the OIS carrier 1310. The OIS-x yoke 1540 may prevent magnetic flux leakage of the OIS-x magnet 1510 and thereby improve interaction with the OIS-x coil 1520.

The lens actuator 1010 may comprise an OIS-y driving unit 1600. The OIS driving unit may comprise an OIS-y driving unit 1600. The OIS-y driving unit 1600 may move the OIS carrier 1310 in a y-axis direction perpendicular to both the optical axis and the x-axis direction. The OIS-y driving unit 1600 may move the OIS carrier 1310 in a y-axis direction perpendicular to both the optical axis and the x-axis direction through electromagnetic force. The OIS-y driving unit 1600 may comprise a coil and a magnet.

The lens actuator 1010 may comprise an OIS-y magnet 1610 and an OIS-y coil 1620 that move the OIS moving unit 1300 in a y-axis direction perpendicular to the optical axis direction and the x-axis direction.

In a second embodiment of the present invention, the OIS-y magnet 1610 and the OIS-y coil 1620 can move the OIS moving unit 1300 in a second direction perpendicular to the optical axis direction and the first direction. At this time, the second direction may be a y-axis direction. By the interaction of the OIS-y coil 1620 and the OIS-y magnet 1610, the OIS carrier 1310 can move in a y-axis direction perpendicular to both the optical axis direction and the x-axis direction. The OIS-y magnet 1610 and the OIS carrier 1310 can move integrally in a y-axis direction. The OIS-y magnet 1610 can be overlapped with the AF magnet 1410 in a second direction. The OIS-y magnet 1610 can be overlapped with the AF magnet 1410 in a y-axis direction.

The lens actuator 1010 may comprise an OIS-y magnet 1610. The OIS-y driving unit 1600 may comprise an OIS-y magnet 1610. The OIS-y magnet 1610 may be an ‘OIS-y magnet’. The OIS-y magnet 1610 may be a permanent magnet. The OIS-y magnet 1610 may be disposed in the OIS moving unit 1300. The OIS-y magnet 1610 may be spaced apart from the OIS-x magnet 1510. The OIS-y magnet 1610 may be spaced apart from the AF magnet 1410. The OIS-y magnet 1610 may be disposed in the OIS carrier 1310. The OIS-y magnet 1610 may be disposed on an outer side surface of the OIS carrier 1310. The OIS-y magnet 1610 may be fixed to the OIS carrier 1310. The OIS-y magnet 1610 may be coupled to the OIS carrier 1310. The OIS-y magnet 1610 may be adhesively bonded to the OIS carrier 1310 with an adhesive. The OIS-y magnet 1610 may be disposed within the cover 1120. The OIS-y magnet 1610 may interact with the OIS-y coil 1620. The OIS-y magnet 1610 may electromagnetically interact with the OIS-y coil 1620. The OIS-y magnet 1610 may be disposed at a position corresponding to the OIS-y coil 1620. The OIS-y magnet 1610 can face the OIS-y coil 1620. The OIS-y magnet 1610 can face the OIS-y coil 1620. The OIS-y magnet 1610 can be overlapped with the OIS-y coil 1620 in a direction perpendicular to the optical axis. The OIS-y magnet 1610 can be overlapped with the OIS-y coil 1620 in a y-axis direction. The OIS-y magnet 1610 can move in a y-axis direction.

The OIS-y magnet 1610 can move in the direction of pushing and pulling the OIS-y coil 1620 through interaction with the OIS-y coil 1620. (See C in FIG. 85) The OIS-y magnet 1610 may be a two-pole magnet. The OIS-y magnet 1610 may comprise a two-pole magnetizing magnet. The OIS-y magnet 1610 may comprise an N pole and an S pole.

The OIS-y magnet 1610 may comprise a third magnet portion 1611. The third magnet portion 1611 may comprise an N pole and an S pole. The third magnet portion 1611 may be disposed on a fourth side surface of the OIS moving unit 1300. The third magnet portion 1611 may comprise an inner surface being disposed on a fourth side surface of the OIS moving unit 1300 and an outer surface opposite to the inner surface. The inner surface of the third magnet portion 1611 may be formed as an N pole in its entirety. The outer surface of the third magnet portion 1611 may be formed as an S pole in its entirety. Or, conversely, the inner surface of the third magnet portion 1611 may be an S pole and the outer surface may be an N pole.

The OIS-y magnet 1610 may comprise a fourth magnet portion 1612. The fourth magnet portion 1612 may comprise a south pole and a north pole. The fourth magnet portion 1612 may be disposed on a fourth side surface of the OIS moving unit 1300. The fourth magnet portion 1612 may comprise an inner surface being disposed on a fourth side surface of the OIS moving unit 1300 and an outer surface opposite to the inner surface. The inner surface of the fourth magnet portion 1612 may be formed as a south pole in its entirety. The outer surface of the fourth magnet portion 1612 may be formed as a north pole in its entirety. Or, conversely, the inner surface of the fourth magnet portion 1612 may be a north pole and the outer surface may be a south pole.

The third magnet portion 1611 and the fourth magnet portion 1612 may be overlapped with each other in a y-axis direction perpendicular to the optical axis direction and the x-axis direction. The third magnet portion 1611 and the fourth magnet portion 1612 may be formed to have the same size. The third magnet portion 1611 and the fourth magnet portion 1612 may be formed to have the same shape.

In a second embodiment of the present invention, the third magnet portion 1611 and the fourth magnet portion 1612 of the OIS-y magnet 1610 may have outer surfaces formed with different polarities. However, in a modified embodiment, the third magnet portion 1611 and the fourth magnet portion 1612 of the OIS-y magnet 1610 may have outer surfaces formed with the same polarity.

The polarity of the third magnet portion 1611 facing the third coil portion 1621 and the polarity of the fourth magnet portion 1612 facing the fourth coil portion 1622 may be different from each other. The polarity of the entire area of the third magnet portion 1611 facing the third coil portion 1621 may be a south pole. The polarity of the entire area of the third magnet portion 1611 facing the third coil portion 1621 may be a single polarity. The polarity of the entire area of the fourth magnet portion 1612 facing the fourth coil portion 1622 may be a north pole. The polarity of the entire area of the fourth magnet portion 1612 facing the fourth coil portion 1622 may be a single polarity.

The OIS-y magnet 1610 may comprise a neutral portion 1613. The neutral portion 1613 may be disposed between the third magnet portion 1611 and the fourth magnet portion 1612. The neutral portion 1613 may have a lower polarity than the third magnet portion 1611 and the fourth magnet portion 1612. The neutral portion 1613 may not have a polarity.

In a second embodiment of the present invention, the third magnet portion 1611, the fourth magnet portion 1612, and the neutral portion 1613 may be formed integrally. That is, the third magnet portion 1611, the fourth magnet portion 1612, and the neutral portion 1613 may be a single four-pole magnetized magnet.

As illustrated in FIG. 86, in a modified embodiment, the third magnet portion 1611 and the fourth magnet portion 1612 may be formed as separate magnets. That is, the OIS-y magnet 1610a may comprise the third magnet portion 1611 and the fourth magnet portion 1612 formed as separate magnets. The third magnet portion 1611 and the fourth magnet portion 1612 may be spaced apart from each other. A gap, which is not a neutral portion, may be formed between the third magnet portion 1611 and the fourth magnet portion 1612. Or, the third magnet portion 1611 and the fourth magnet portion 1612 may be in contact with each other so that there is no neutral portion or gap between the third magnet portion 1611 and the fourth magnet portion 1612.

The lens actuator 1010 may comprise an OIS-y coil 1620. The OIS-y driving unit 1600 may comprise the OIS-y coil 1620. The OIS-y coil 1620 may interact with the OIS-y magnet 1610. The OIS-y coil 1620 may be disposed on the opposite side of the AF coil 1420 with respect to the optical axis. The OIS-y coil 1620 may move the OIS-y magnet 1610 in a y-axis direction, which is perpendicular to both the optical axis and the x-axis. The OIS-y coil 1620 may move the OIS-y magnet 1610 in a y-axis direction through interaction with the OIS-y magnet 1610. The OIS-y coil 1620 may face the OIS-y magnet 1610. The OIS-y coil 1620 may face the OIS-y magnet 1610. The OIS-y coil 1620 may be disposed corresponding to the OIS-y magnet 1610. The OIS-y coil 1620 may be overlapped with the OIS-y magnet 1610 in a direction perpendicular to the optical axis. The OIS-y coil 1620 may be disposed on the inner substrate 1720. The OIS-y coil 1620 may be disposed on the AF carrier 1210.

In a second embodiment of the present invention, the OIS-y coil 1620 can move together with the AF moving unit 1200. The OIS-y coil 1620 can move in an optical axis direction together with the AF moving unit 1200. During the AF driving process, the OIS-y coil 1620 can move in an optical axis direction together with the AF moving unit 1200. The OIS-y coil 1620 can be disposed in the AF moving unit 1200. The OIS-y coil 1620 can be fixed to the AF moving unit 1200. The OIS-y coil 1620 can be coupled to the AF moving unit 1200. When a current is applied to the OIS-y coil 1620, the OIS-y magnet 1610 can move away from or closer to the OIS-y coil 1620 in a y-axis direction.

The OIS-y coil 1620 may comprise a third coil portion 1621. The third coil portion 1621 may interact with the third magnet portion 1611. The third coil portion 1621 may be overlapped with the third magnet portion 1611 in an x-axis direction. That is, the third coil portion 1621 and the third magnet portion 1611 may be overlapped with each other in a direction that matches the driving direction due to the interaction.

The OIS-y coil 1620 may comprise a fourth coil portion 1622. The fourth coil portion 1622 may interact with the fourth magnet portion 1612. The fourth coil portion 1622 may be overlapped with the fourth magnet portion 1612 in an x-axis direction. That is, the fourth coil portion 1622 and the fourth magnet portion 1612 may be overlapped with each other in a direction that matches the driving direction due to the interaction.

The OIS-y coil 1620 may comprise two coils. The OIS-y coil 1620 may comprise two bundles of coils. The OIS-y coil 1620 may comprise two ring-shaped coils. The OIS-y coil 1620 may comprise two coil units. The OIS-y coil 1620 may comprise two split coils. The OIS-y coil 1620 may be separated into two coils. The OIS-y coil 1620 may be separated into two regions. Each of the third coil portion 1621 and the fourth coil portion 1622 may comprise a ring shape. The third coil portion 1621 and the fourth coil portion 1622 can be formed as separate coils.

The third coil portion 1621 and the fourth coil portion 1622 can be connected. The third coil portion 1621 can be electrically connected to the fourth coil portion 1622. At this time, the winding direction of the third coil portion 1621 can be opposite to the winding direction of the fourth coil portion 1622. In this case, when a current is applied, the direction of the electromagnetic force induced in the third coil portion 1621 and the fourth coil portion 1622 can be opposite.

In a modified embodiment, the third coil portion 1621 and the fourth coil portion 1622 may have the same winding direction. At this time, the directions of currents applied to the third coil portion 1621 and the fourth coil portion 1622 may be opposite.

The lens actuator 1010 may comprise an OIS-y sensor 1630. The OIS-y driving unit 1600 may comprise the OIS-y sensor 1630. The OIS-y sensor 1630 may be disposed in the inner substrate 1720. The OIS-y sensor 1630 may comprise a Hall sensor. The OIS-y sensor 1630 may detect the OIS-y magnet 1610. The OIS-y sensor 1630 may detect the magnetic force of the OIS-y magnet 1610. The OIS-y sensor 1630 may be disposed below the OIS-y magnet 1610. The OIS-y sensor 1630 may be overlapped with the OIS-y magnet 1610 in an optical axis direction. The OIS-y sensor 1630 may be overlapped with the OIS-y magnet 1610 in a direction perpendicular to the optical axis. In a modified embodiment, the OIS-y sensor 1630 may be disposed within the OIS-y coil 1620. The OIS-y sensor 1630 may be overlapped with the OIS-y coil 1620 in an optical axis direction. The OIS-y sensor 1630 may face the OIS-y magnet 1610. The OIS-y sensor 1630 may be disposed at a position corresponding to the OIS-y magnet 1610. The OIS-y sensor 1630 may detect the movement of the OIS-y magnet 1610. The movement amount or position of the OIS-y magnet 1610 detected by the OIS-y sensor 1630 may be used for feedback of the handshake correction driving in a y-axis direction.

The lens actuator 1010 may comprise an OIS-y yoke 1640. The OIS-y yoke 1640 may be disposed on an OIS-y magnet 1610. The OIS-y yoke 1640 may be disposed between the OIS-y magnet 1610 and the OIS carrier 1310. The OIS-y yoke 1640 may prevent magnetic flux leakage of the OIS-y magnet 1610 and thereby enhance interaction with the OIS-y coil 1620.

When viewed from above, the AF magnet 1410, the AF coil 1420, the OIS-y magnet 1610, and the OIS-y coil 1620 can be disposed in order on an imaginary straight line. When viewed from above, the AF magnet 1410, the AF coil 1420, the OIS-y magnet 1610, and the OIS-y coil 1620 can be disposed in order on an imaginary straight line. When viewed from above, the AF magnet 1410, the AF coil 1420, the OIS-y magnet 1610, and the OIS-y coil 1620 can be disposed in order. When viewed from above, the AF magnet 1410, the AF coil 1420, the OIS-y magnet 1610, and the OIS-y coil 1620 can be disposed in order in a y-axis direction. When viewed from above, the AF magnet 1410, the AF coil 1420, the OIS-y magnet 1610, and the OIS-y coil 1620 can be overlapped in a y-axis direction.

The lens actuator 1010 may comprise substrates 1710 and 1720. The substrates 1710 and 1720 may comprise a flexible printed circuit board (FPCB). The substrates 1710 and 1720 may be electrically connected to coils 1420, 1520 and 1620. The substrates 1710 and 1720 may be electrically connected to sensors 1430, 1530 and 1630.

The lens actuator 1010 may comprise an outer substrate 1710. The outer substrate 1710 may be disposed in the base 1110. The outer substrate 1710 may be electrically connected to coils 1420, 1520 and 1620. The outer substrate 1710 may be electrically connected to sensors 1430, 1530 and 1630. The outer substrate 1710 may connect the AF carrier 1210 and the base 1110. The outer substrate 1710 may elastically connect the AF carrier 1210 and the base 1110. The outer substrate 1710 may connect the fixed unit 1100 and the inner substrate 1720. The outer substrate 1710 may support the AF carrier 1210 to be movable against the base 1110. The outer substrate 1710 can guide the AF carrier 1210 to move in an optical axis direction with respect to the base 1110. The outer substrate 1710 can comprise a flexible substrate. The outer substrate 1710 can comprise a flexible printed circuit board (FPCB). The outer substrate 1710 can comprise an elastic portion. The outer substrate 1710 can comprise an elastic member. The outer substrate 1710 can comprise an outer portion 1711 disposed in the fixed unit 1100, and a connecting portion 1712 being extended from the outer portion 1711 and coupled to the inner substrate 1720.

The outer substrate 1710 may comprise an outer side portion 1711. The outer side portion 1711 may be disposed on the base 1110. The outer side portion 1711 may be formed to surround a side surface of the base 1110. The outer side portion 1711 may be disposed on three side surfaces of the base 1110. The outer side portion 1711 may comprise two terminal portions. The two terminal portions may be disposed on opposite sides with respect to the optical axis. The terminal portion may comprise a terminal 1711-1.

The outer substrate 1710 may comprise a terminal 1711-1. The outer side portion 1711 of the outer substrate 1710 may comprise a terminal 1711-1. The terminal 1711-1 may be electrically connected to a terminal 1712-1. The terminal 1711-1 may be disposed at a lower end portion of the base 1110. The terminal 1711-1 may be coupled to a printed circuit board 1050. The terminal 1711-1 may be coupled to a terminal of the printed circuit board 1050 via solder. The terminal 1711-1 may be coupled to a terminal of the printed circuit board 1050 via a conductive member. The terminal 1711-1 may be connected to a terminal of the printed circuit board 1050. The terminal 1711-1 can be electrically connected to a terminal of a printed circuit board 1050.

The outer substrate 1710 may comprise a connecting portion 1712. The connecting portion 1712 may be an ‘extension portion’. The connecting portion 1712 may be a ‘leg portion’. The connecting portion 1712 may be extended from the outer side portion 1711. At least a portion of the connecting portion 1712 may move together with the AF carrier 1210. The extending portion may extend from the outer side portion 1711. At least a portion of the extending portion may move together with the AF carrier 1210. At least a portion of the connecting portion 1712 may be disposed perpendicular to the optical axis direction. The connecting portion 1712 of the outer substrate 1710 may be coupled to the inner substrate 1720 such that the inner substrate 1720 may move in an optical axis direction. At least a portion of the connecting portion 1712 may be disposed parallel to the optical axis direction.

The connecting portion 1712 may comprise a plurality of connecting portions. The connecting portion 1712 may comprise a first connecting portion and a second connecting portion. The second connecting portion may be disposed below the first connecting portion.

The outer substrate 1710 may comprise a terminal 1712-1. The connecting portion 1712 of the outer substrate 1710 may comprise a terminal 1712-1. The terminal 1712-1 may be coupled to a terminal 1721-1 of the inner substrate 1720. The terminal 1712-1 of the outer substrate 1710 may be coupled to the terminal 1721-1 of the inner substrate 1720 through solder. The terminal 1712-1 of the outer substrate 1710 may be coupled to the terminal 1721-1 of the inner substrate 1720 through a conductive member. The terminal 1712-1 of the outer substrate 1710 may be connected to the terminal 1721-1 of the inner substrate 1720. The terminal 1712-1 of the outer substrate 1710 can be electrically connected to the terminal 1721-1 of the inner substrate 1720.

The outer substrate 1710 may comprise a bent portion 1712-2. The bent portion 1712-2 may be formed in the connecting portion 1712. The bent portion 1712-2 may be formed in each of the first connecting portion and the second connecting portion. The bent portion 1712-2 may comprise a shape that is bent at least 55 times. The bent portion 1712-2 may comprise a shape that is bent in a U shape. The bent portion 1712-2 may comprise a rounded shape. The bent portion 1712-2 may comprise a portion that is disposed parallel to an optical axis.

Hereinafter, one of the ‘terminal 1711-1’ and the ‘terminal 1712-1’ of the outer substrate 1710 may be referred to as a ‘first terminal’ and the other may be referred to as a ‘second terminal’.

The lens actuator 1010 may comprise an inner substrate 1720. The inner substrate 1720 may be electrically connected to coils 1420, 1520 and 1620. The inner substrate 1720 may be electrically connected to sensors 1430, 1530 and 1630. The inner substrate 1720 may be disposed in the AF moving unit 1200. The inner substrate 1720 may be disposed in the AF carrier 1210. The inner substrate 1720 may be fixed to the AF carrier 1210. The inner substrate 1720 may be coupled to the AF carrier 1210. The inner substrate 1720 may be bonded to the AF carrier 1210 with an adhesive. The inner substrate 1720 may comprise a flexible substrate. The inner substrate 1720 may comprise a flexible printed circuit board (FPCB). The inner substrate 1720 may comprise an elastic portion. The inner substrate 1720 may comprise an elastic member.

The inner substrate 1720 can be coupled to a lower surface of the holder member 1220. The preload member 1230 can be coupled to the inner substrate 1720.

The inner substrate 1720 may comprise a side plate portion 1721. The side plate portion 1721 may be disposed on the side surface of the AF carrier 1210. The side plate portion 1721 may be disposed on an outer side surface of the AF carrier 1210. In another embodiment, the side plate portion 1721 may be disposed on an inner side surface of the AF carrier 1210. The side plate portion 1721 of the inner substrate 1720 may comprise a plurality of portions. The side plate portion 1721 may comprise first to fourth portions.

The inner substrate 1720 may comprise a first portion. The first portion may be disposed on the AF carrier 1210. The AF coil 1420 may be disposed in a first portion of the inner substrate 1720. The AF sensor 1430 may be disposed in a first portion of the inner substrate 1720. The AF yoke 1440 may be disposed in a first portion of the inner substrate 1720.

The inner substrate 1720 may comprise a second portion. The second portion may be disposed opposite to the first portion. The second portion may be disposed in the AF carrier 1210. The second portion may be disposed at a second side surface of the AF carrier 1210. The OIS-y coil 1620 may be disposed at a second portion of the inner substrate 1720. The OIS-y sensor 1630 may be disposed at a second portion of the inner substrate 1720. More specifically, the OIS-y sensor 1630 may be disposed at a lower plate portion 1722 being bent and disposed at an upper side of a second portion of the inner substrate 1720. The OIS-y sensor 1630 may be disposed at a lower surface of the lower plate portion 1722.

The inner substrate 1720 may comprise a third portion. The third portion may be disposed in the AF carrier 1210. The third portion may be disposed at a third side surface of the AF carrier 1210. The OIS-x coil 1520 may be disposed at a third portion of the inner substrate 1720. The OIS-x sensor 1530 may be disposed at a third portion of the inner substrate 1720. More specifically, the OIS-x sensor 1530 may be disposed at a lower plate portion 1722 being bent and disposed at an upper side of a third portion of the inner substrate 1720. The OIS-x sensor 1530 may be disposed at a lower surface of the lower plate portion 1722.

The inner substrate 1720 may comprise a fourth portion. The fourth portion may be disposed opposite to the third portion. The fourth portion may be disposed in the AF carrier 1210. The fourth portion may be disposed at a fourth side surface of the AF carrier 1210.

The inner substrate 1720 may comprise a terminal 1721-1. The terminal 1721-1 may be disposed in the fourth portion of the inner substrate 1720. The terminal 1721-1 may be electrically connected to the coils 1420, 1520 and 1620. The terminal 1721-1 may be electrically connected to the sensors 1430, 1530 and 1630. The terminal 1721-1 may be coupled to the terminal 1712-1 of the outer substrate 1710.

The inner substrate 1720 may comprise a terminal 1722-1. The terminal 1722-1 may be disposed in the lower plate portion 1722 of the inner substrate 1720. The terminal 1722-1 may be electrically connected to the coils 1420, 1520 and 1620. The terminal 1722-1 may be electrically connected to the sensors 1430, 1530 and 1630. The terminal 1722-1 may be coupled to the terminal 1712-1 of the outer substrate 1710.

The inner substrate 1720 may comprise a hole 1722-2. Through the hole 1722-2, a terminal 1722-1 of the inner substrate 1720 may be soldered to a terminal 1712-1 of the outer substrate 1710.

The lens actuator 1010 may comprise a guide member. The guide member may comprise a ball. The guide member may comprise a pin. The guide member may comprise a cylindrical member. The guide member may guide the movement of the moving unit against the fixed unit 1100 in a specific direction.

The lens actuator 1010 may comprise an AF guide ball 1810. The AF guide ball 1810 may guide movement of the AF moving unit 1200 against the fixed unit 1100 in an optical axis direction. The AF guide ball 1810 may guide movement of the AF carrier 1210 against the base 1110 in an optical axis direction. The AF guide ball 1810 may be disposed between the fixed unit 1100 and the AF moving unit 1200. The AF guide ball 1810 may be disposed between the base 1110 and the AF carrier 1210. The AF guide ball 1810 may be disposed between the housing and the base 1110. The AF guide ball 1810 may be disposed between the base 1110 and the AF carrier 1210 in an x direction. Or, the AF guide ball 1810 may be disposed between the base 1110 and the AF carrier 1210 in a y direction. The AF guide ball 1810 may be disposed in a groove of the base 1110. The AF guide ball 1810 may be disposed in a groove of the AF carrier 1210. The AF guide ball 1810 may be spherical. The AF guide ball 1810 may be formed of metal. Grease may be applied to the surface of the AF guide ball 1810.

The AF guide ball 1810 may be disposed at a first corner of the base 1110. The AF guide ball 1810 may be disposed at a second corner in diagonal direction of the first corner of the base 1110. The AF guide ball 1810 may be disposed at each of the first and second corners of the base 1110. The first and second corner regions of the fixed unit 1100 may be disposed diagonally against an optical axis. The AF guide ball 1810 may be disposed at the first and second corner regions of the fixed unit 1100. Two sets of AF guide balls 1810 may be disposed at each of the first and second corners of the base 1110. At this time, one set may comprise four balls. The two sets may be disposed at opposite sides of the pillar part of the AF carrier 1210.

In a modified embodiment, the AF guide ball 1810 may be disposed at a first corner and a third corner. Or, the AF guide ball 1810 may be disposed at a first corner and a fourth corner. That is, the AF guide ball 1810 may not be disposed diagonally.

The AF guide ball 1810 may comprise a first unit ball disposed at a first corner region of the fixed unit 1100 when viewed from above, and a second unit ball being disposed at a second corner region diagonally from a first corner region of the fixed unit 1100. At this time, the OIS guide ball 1820 may comprise a first guide member and a second guide member being spaced apart from each other and disposed diagonally between the first unit ball and the second unit ball of the AF guide ball 1810, when viewed from above.

The AF guide ball 1810 may comprise a first unit ball and a second unit ball being disposed at a first corner region of the fixed unit 1100 when viewed from above, and a third unit ball and a fourth unit ball being disposed at a second corner region diagonally opposite to the first corner region of the fixed unit 1100. The AF guide balls 1810 may be disposed in sets of two per corner.

The AF guide ball 1810 may comprise a ball being overlapped with the OIS guide ball 1820 in a direction perpendicular to the optical axis direction. At least a portion of the AF guide ball 1810 may be overlapped with the OIS guide ball 1820.

The AF guide ball 1810 may comprise an inner ball 1811. The inner ball 1811 may be disposed in the pillar part 1111 of the base 1110. The inner ball 1811 may be disposed in the inner groove 1111-1 of the base 1110. The inner ball 1811 may be disposed in the inner groove 1224-1 of the AF carrier 1210. The inner ball 1811 may be disposed in the inner groove 1224-1 of the AF moving unit 1200. The inner ball 1811 may be disposed in the inner groove 1111-1 of the base 1110 and the inner groove 1224-1 of the AF carrier 1210. The inner ball 1811 may be disposed between the inner groove 1111-1 of the base 1110 and the inner groove 1224-1 of the AF carrier 1210. The inner ball 1811 can be disposed between the AF moving unit 1200 and the pillar part 1111 of the fixed unit 1100.

The AF guide ball 1810 may comprise an outer ball 1812. The outer ball 1812 may be disposed in the outer wall part 1112 of the base 1110. The outer ball 1812 may be disposed in the outer groove 1112-1 of the base 1110. The outer ball 1812 may be disposed in the outer groove 1224-2 of the AF carrier 1210. The outer ball 1812 may be disposed in the outer groove 1112-1 of the base 1110 and the outer groove 1224-2 of the AF carrier 1210. The outer ball 1812 may be disposed between the outer groove 1112-1 of the base 1110 and the outer groove 1224-2 of the AF carrier 1210. The outer ball 1812 may be disposed between the outer groove 1112-1 of the fixed unit 1100 and the outer groove 1224-2 of the AF moving unit 1200. The outer ball 1812 may be disposed between the AF moving unit 1200 and the outer wall part 1112 of the fixed unit 1100.

The inner ball 1811 may comprise a plurality of inner balls 1811. The plurality of inner balls 1811 may be disposed in the optical axis direction. The inner ball 1811 may comprise four inner balls 1811. The inner ball 1811 may comprise first to fourth inner balls. Two of the four inner balls 1811 may have large diameters and the remaining two may have small diameters. The two balls with large diameters may be disposed at the uppermost end and the lowermost end. In other words, two balls with small diameters may be disposed between the two balls with large diameters.

The inner ball 1811 may comprise an inner uppermost ball 1811-1. The inner uppermost ball 1811-1 may be disposed highest among the inner balls 1811. The inner uppermost ball 811-1 may be disposed closest to the upper plate 1121 of the cover 1120 among the inner balls 1811. The inner ball 1811 may comprise an inner lowermost ball 1811-2. The inner lowermost ball 1811-2 may be disposed lowest among the inner balls 1811. The inner lowermost ball 1811-2 may be disposed closest to the lower plate portion of the base 1110 among the inner balls 1811. The plurality of inner balls 1811 may comprise balls having a smaller diameter than each of the inner uppermost ball 1811-1 and the inner lowermost ball 1811-2. The plurality of inner balls 1811 may comprise balls being disposed between the inner uppermost ball 1811-1 and the inner lowermost ball 1811-2.

The outer ball 1812 may comprise a plurality of outer balls 1812. The plurality of outer balls 1812 may be disposed in an optical axis direction. The outer ball 1812 may comprise four outer balls 1812. The outer ball 1812 may comprise first to fourth outer balls. Two of the four outer balls 1812 may have large diameters and the remaining two may have small diameters. The two balls with large diameters may be disposed at the uppermost end and the lowermost end. That is, two balls with small diameters may be disposed between the two balls with large diameters.

The outer ball 1812 may comprise an outer uppermost ball 1812-1. The outer uppermost ball 1812-1 may be disposed highest among the outer balls 1812. The outer uppermost ball 1812-1 may be disposed closest to the upper plate 1121 of the cover 1120 among the outer balls 1812. The outer ball 1812 may comprise an outer lowermost ball 1812-2. The outer lowermost ball 1812-2 may be disposed lowest among the outer balls 1812. The outer lowermost ball 1812-2 may be disposed closest to the lower plate portion of the base 1110 among the outer balls 1812. The plurality of outer balls 1812 may comprise balls having a diameter smaller than each of the outer uppermost ball 1812-1 and the outer lowermost ball 1812-2. The plurality of outer balls 1812 may comprise balls being disposed between the outer uppermost ball 1812-1 and the outer lowermost ball 1812-2.

The AF guide ball 1810 may comprise a plurality of balls disposed in an optical axis direction. At this time, the plurality of balls may comprise uppermost balls 1811-1 and 1812-1 being disposed at the highest position and lowermost balls 1811-2 and 1812-2 being disposed at the lowest position. The height of the point where the elastic member 1920 pressurizes the plate member 1910 may be disposed between the height of the uppermost balls 1811-1 and 1812-1 and the height of the lowermost balls 1811-2 and 1812-2.

The lens actuator 1010 may comprise an OIS guide ball 1820. The OIS guide ball 1820 may guide the movement of the OIS carrier 1310 against the AF carrier 1210 in a direction perpendicular to the optical axis. The OIS guide ball 1820 may be disposed between the AF moving unit 1200 and the OIS moving unit 1300. The OIS guide ball 1820 may be disposed between the lower plate of the AF moving unit 1200 and the OIS moving unit 1300. The OIS guide ball 1820 may be disposed between the AF carrier 1210 and the OIS carrier 1310. The OIS guide ball 1820 may be disposed between the lower side of the AF carrier 1210 and the OIS carrier 1310. The OIS guide ball 1820 may be disposed between the housing and the bobbin. The OIS guide ball 1820 may be disposed between the housing and the lower side of the bobbin. The OIS guide ball 1820 may be disposed between the AF carrier 1210 and the OIS carrier 1310 in an optical axis direction.

The OIS guide ball 1820 may be disposed in the protruded portion 1231 of the preload member 1230. The OIS guide ball 1820 may be disposed in the groove 1232 of the protruded portion 1231. The OIS guide ball 1820 may be disposed in the groove 1311 of the OIS moving unit 1300. The OIS guide ball 1820 may be disposed between the groove 1232 of the protruded portion 1231 of the AF moving unit 1200 and the groove 311 of the OIS moving unit 1300.

The OIS guide ball 1820 may be disposed between the preload member 1230 of the AF carrier 1210 and the OIS carrier 1310. The OIS guide ball 1820 may be pressurized between the AF carrier 1210 and the OIS carrier 1310 by the pressurizing force of the coil spring 1830. The preload member 1230 may pressurize the OIS guide ball 1820 upward during the process of being coupled to the holder member 1220. The preload member 1230 may pressurize the OIS guide ball 1820 toward the OIS carrier 1310 during the process of being coupled to the holder member 1220. At this time, the OIS carrier 1310 may pressurize the OIS guide ball 1820 toward the preload member 1230 by the restoring force of the coil spring 1830. Accordingly, the OIS guide ball 1820 can be pressurized between the preload member 1230 and the OIS carrier 1310.

The OIS guide ball 1820 can guide the OIS moving unit 1300 to move in an x-axis direction and a y-axis direction. The OIS guide ball 1820 can guide the movement of the OIS moving unit 1300 in an x-axis direction and a y-axis direction. The OIS guide ball 1820 can guide the OIS carrier 1310 to move in an x-axis direction and a y-axis direction perpendicular to the optical axis direction against the AF carrier 1210. That is, the OIS guide ball 1820 can guide the OIS carrier 1310 to move in an x-axis direction and a y-axis direction. That is, the OIS guide ball 1820 can guide the movement in both an x-axis direction and a y-axis direction. For reference, in a first embodiment of the present invention in which the ball guiding an x-axis direction and the ball guiding a y-axis direction are provided as a single unit, the size of the lens actuator 1010 can be minimized compared to the comparative example in which the ball guiding an x-axis direction and the ball guiding a y-axis direction are provided separately. In particular, the height of the lens actuator 1010 in an optical axis direction can be reduced. Through this, the height being protruded from the smartphone, that is, the shoulder height can be minimized. The OIS guide ball 1820 may comprise a plurality of balls. The OIS guide ball 1820 may comprise four balls.

In a modified embodiment, the OIS guide ball 1820 may be provided with a separate ball that guides an x-axis driving and a ball that guides a y-axis driving.

The lens actuator 1010 may comprise an elastic member. The elastic member may be formed to support OIS driving. The elastic member may support movement of the OIS moving unit 1300. The elastic member may be a ‘supporting member’. The elastic member may be formed to pressurize the OIS guide ball 1820. The elastic member may be a ‘pressurizing member’. The elastic member may be formed to guide both an OIS-x-axis driving and an OIS-y-axis driving with only the OIS guide ball 1820. The elastic member may have elasticity. The elastic member may be formed of metal.

The elastic member can pressurize the OIS guide ball 1820 between the AF moving unit 1200 and the OIS moving unit 1300. The elastic member can pressurize the OIS moving unit 1300 toward the AF moving unit 1200. The elastic member can pressurize the AF moving unit 1200 toward the OIS moving unit 1300.

The lens actuator 1010 may comprise an elastic member 1830. The elastic member 1830 may be an ‘upper elastic member’. The elastic member 1830 may be an ‘upper spring’. The elastic member 1830 may be a leaf spring. The elastic member 1830 may have elasticity. The elastic member 1830 may be disposed in the OIS moving unit 1300. The elastic member 1830 may be coupled to the OIS moving unit 1300. The elastic member 1830 may be connected to the OIS moving unit 1300. The elastic member 1830 may be coupled to an upper surface of the OIS moving unit 1300. The elastic member 1830 may be disposed on an upper surface of the OIS moving unit 1300. The elastic member 1830 may be disposed on the upper portion of the OIS carrier 1310. The elastic member 1830 may be disposed on the OIS carrier 1310. The elastic member 1830 may be disposed at an upper portion of the OIS carrier 1310. The elastic member 1830 may be disposed above the OIS carrier 1310. The elastic member 1830 may be disposed perpendicular to the optical axis.

The elastic member 1830 may comprise an inner side portion 1831. The inner side portion 1831 may be coupled with the OIS moving unit 1300. The elastic member 1830 may comprise an outer side portion 1832. The outer side portion 1832 may be coupled with a wire 1850. The elastic member 1830 may comprise a connecting portion 1833. The connecting portion 1833 may connect the inner side portion 1831 and the outer side portion 1832. The connecting portion 1833 may elastically connect the inner side portion 1831 and the outer side portion 1832. The connecting portion 1833 may comprise elasticity. The connecting portion 1833 may be an elastic portion. The connecting portion 1833 may be a ‘leg portion’.

The inner side portion 1831 of the elastic member 1830 may be disposed higher than the outer side portion 1832. The inner side portion 1831 of the elastic member 1830 may be located higher than the outer side portion 1832. The inner side portion 1831 of the elastic member 1830 may be disposed higher than the outer side portion 1832 by a first distance. The reason why the inner side portion 1831 of the elastic member 1830 is disposed higher than the outer side portion 1832 may be due to the pressurizing force of the preload member 1230. Through this structure, the OIS guide ball 1820 may be maintained in contact with the preload member 1230 of the AF carrier 1210 and the OIS carrier 1310.

The OIS carrier 1310 may comprise a first region being coupled with the elastic member 1830. The wire 1850 may comprise a second region being coupled with the elastic member 1830. The first region of the OIS carrier 1310 may be disposed above the second region of the wire 1850. The first region of the OIS carrier 1310 may be disposed above the second region of the wire 1850 by 0.2 to 0.6 mm. The first region of the OIS carrier 1310 may be disposed above the second region of the wire 1850 by 0.3 to 0.5 mm.

The lens actuator 1010 may comprise a wire 1850. The wire 1850 may be a ‘side portion elastic member’. The wire 1850 may be a wire. The wire 1850 may be a wire spring. The wire 1850 may be a suspension wire. The wire 1850 may have elasticity. The wire 1850 may connect the elastic member 1830 and the AF carrier 1210. The wire 1850 may connect the elastic member 1830 and the lower side of the AF carrier 1210. The wire 1850 may connect the elastic member 1830 and the housing. The wire 1850 may connect the elastic member 1830 and the lower side of the housing. The wire 1850 can elastically connect the elastic member 1830 and the AF carrier 1210. The wire 1850 can connect the elastic member 1830 and the metal member 1225 of the AF carrier 1210. The wire 1850 can elastically connect the elastic member 1830 and the metal member 1225 of the AF carrier 1210. The wire 1850 can be disposed parallel to the optical axis. The wire 1850 can be disposed in an optical axis direction.

An upper end portion of the wire 1850 can be coupled with the elastic member 1830. The first portion of the wire 1850 can be coupled with the elastic member 1830. The lower end portion of the wire 1850 can be coupled with the AF moving unit 1200. The lower end portion of the wire 1850 can be coupled with a lower surface of the AF moving unit 1200. The second portion of the wire 1850 can be coupled with the AF moving unit 1200. The lower end portion of the wire 1850 can be coupled with the AF carrier 1210. The lower end portion of the wire 1850 can be coupled with the holder member 1220. The lower end portion of the wire 1850 can be coupled with the metal member 1225. The lower end portion of the wire 1850 can be soldered to the metal member 1225. The lower end portion of the wire 1850 can be welded to the metal member 1225. The lower end portion of the wire 1850 can be bonded to the metal member 1225 by a conductive epoxy. The lower end portion of the wire 1850 can be bonded to the metal member 1225 through a conductive material. The lower end portion of the wire 1850 can be directly bonded to the metal member 1225. The wire 1850 can connect the elastic member 1830 and the AF moving unit 1200. The wire 1850 can connect the elastic member 1830 and the AF carrier 1210. The wire 1850 can connect the elastic member 1830 and the holder member 1220. The wire 1850 can connect the elastic member 1830 and the metal member 1225.

The lens actuator 1010 may comprise a pressurizing member. The pressurizing member may be an ‘AF guide ball pressurizing member’. The pressurizing member may pressurize the AF guide ball 1810. The pressurizing member may be formed to pressurize the ball. The AF guide ball 1810 pressurized by the pressurizing member may be sandwiched between the fixed unit 1100 and the AF moving unit 1200. The AF guide ball 1810 pressurized by the pressurizing member may be sandwiched between the base 1110 and the AF carrier 1210. The pressurizing member may allow the AF guide ball 1810 to be maintained in contact with the fixed unit 1100 and the AF moving unit 1200. The pressurizing member may allow the AF guide ball 1810 to be maintained in contact with the base 1110 and the AF carrier 1210.

The lens actuator 1010 may comprise a plate member 1910. The pressurizing member may comprise the plate member 1910. The plate member 1910 may be disposed at the AF guide ball 1810. The plate member 1910 may contact the AF guide ball 1810. The plate member 1910 may be disposed at the elastic member 1920. The plate member 1910 may be disposed in the base 1110. The plate member 1910 may be disposed between the elastic member 1920 and the AF guide ball 1810. The plate member 1910 may pressurize the AF guide ball 1810 toward the AF carrier 1210 by the elastic member 1920. The plate member 1910 may be disposed between the AF guide ball 1810 and the fixed unit 1100. The plate member 1910 can be disposed between the inner ball 1811 and the pillar part 1111 of the fixed unit 1100

The lens actuator 1010 may comprise an elastic member 1920. The pressurizing member may comprise the elastic member 1920. The elastic member 1920 may be a spring. The elastic member 1920 may be a tapered spring. The elastic member 1920 may be disposed in the fixed unit 1100. The elastic member 1920 may pressurize the AF guide ball 1810 toward the AF moving unit 1200. The elastic member 1920 may pressurize the plate member 1910 toward the AF guide ball 1810. The elastic member 1920 may be disposed between the plate member 1910 and the fixed unit 1100. The elastic member 1920 may push the plate member 1910 against the fixed unit 1100. The elastic member 1920 can pressurize the plate member 1910 in an opposite direction of the fixed unit 1100. The elastic member 1920 can be disposed between the plate member 1910 and the pillar part 1111 of the fixed unit 1100. The elastic member 1920 can be disposed in the inner groove 1111-1 of the fixed unit 1100. The elastic member 1920 can pressurize the AF guide ball 1810 between the fixed unit 1100 and the AF moving unit 1200.

In a modified embodiment, the elastic member 1920 may be disposed in the AF moving unit 1200. At this time, the elastic member 1920 may pressurize the AF guide ball 1810 toward the fixed unit 1100. The elastic member 1920 may be disposed in one of the fixed unit 1100 and the AF moving unit 1200 to pressurize the AF guide ball 1810 toward the other of the fixed unit 1100 and the AF moving unit 1200. The elastic member 1920 may pressurize the plate member 1910. The elastic member 1920 may be disposed between the plate member 1910 and the base 1110. The elastic member 1920 may be disposed between the AF guide ball 1810 and the base 1110. The elastic member 1920 may be disposed in the base 1110. The elastic member 1920 can be disposed in the inner groove 1111-1 of the base 1110. The elastic member 1920 can pressurize the AF guide ball 1810 toward the AF carrier 1210. Through this, the AF guide ball 1810 can be maintained in contact with the plate member 1910 and the AF carrier 1210.

The elastic member 1920 may comprise a bent portion. The bent portion may comprise a bent shape. The bent portion may comprise a plurality of bent portions. The bent portion may comprise three bent portions. The elastic member 1920 may be bent at least three times. The elastic member 1920 may comprise an upper bent portion 1921. The elastic member 1920 may comprise a lower bent portion 1922. The elastic member 1920 may comprise a connecting bent portion 1923. The connecting bent portion 1923 may be disposed between the upper bent portion 1921 and the lower bent portion 1922. The upper bent portion 1921 may form an obtuse angle. The lower bent portion 1922 may form an obtuse angle. The connecting bent portion 1923 may form an obtuse angle. The upper bent portion 1921 may be disposed in the fixed unit 1100. The lower bent portion 1922 may be disposed in the fixed unit 1100. The connecting bent portion 1923 may be disposed in the plate member 1910. Through this structure, the elastic member 1920 may push the plate member 910 against the fixed unit 1100. The connecting bent portion 1923 may be in contact with the plate member 1910 and pressurize the plate member 1910 toward the AF guide ball 1810.

The height of the point where the elastic member 1920 pressurizes the plate member 1910 may be lower than the height of the ball that is disposed lower between the inner uppermost ball 1811-1 and the outer uppermost ball 1812-1 and higher than the height of the ball being disposed higher between the inner lowermost ball 1811-2 and the outer lowermost ball 1812-2. More specifically, as shown in FIG. 97A, when the AF moving unit 1200 moves upward, the height (b) of the point where the elastic member 1920 the plate member 1910 may be higher than the height (a) of the ball that is disposed higher between the inner lowermost ball 1422 and the outer lowermost ball 1412. A gap c may exist in the height between the two points. In addition, as shown in FIG. 97B, when the AF moving unit 1200 moves downward, the height e of the point where the elastic member 1920 pressurizes the plate member 1910 may be lower than the height d of the ball that is disposed lower between the inner uppermost ball 1421 and the outer uppermost ball 1411. A gap f may exist between the two points. Through this, the generation of a moment being generated as the elastic member 1920 pressurizes the plate member 1910 can be prevented or minimized. In other words, the phenomenon in that the plate member 1910 is tilted or detached can be prevented.

The lens actuator 1010 may comprise a reinforcing member 1930. The reinforcing member 1930 may be disposed in the base 1110. The reinforcing member 1930 may be disposed to reinforce the strength of the base 1110. The reinforcing member 1930 may prevent damage to the base 1110. The reinforcing member 1930 may prevent damage to the pillar part 1111 of the base 1110. The reinforcing member 1930 may prevent damage to the outer wall part 1112 of the base 1110. The reinforcing member 1930 may have elasticity. The reinforcing member 1930 may be formed of metal. The reinforcing member 1930 may comprise a shape that is bent at least 55 times. The reinforcing member 1930 may be formed in a ‘⊂’ shape when viewed from above. The reinforcing member 1930 can be opened inward.

The reinforcing member 1930 may comprise an inner side portion 1931. The inner side portion 1931 may be disposed on an opposite surface of the inner groove 1111-1 of the pillar part 1111 of the fixed unit 1100. The reinforcing member 1930 may comprise an outer side portion 1932. The outer side portion 1932 may be disposed on an opposite surface of the outer groove 1112-1 of the outer wall part 1112 of the fixed unit 1100. The reinforcing member 1930 may comprise a connecting portion 1933. The connecting portion 1933 may connect the inner side portion 1931 and the outer side portion 1932.

The lens actuator 1010 may comprise a cover 1940. The cover 1940 may be disposed on the AF guide ball 1810. The cover 1940 may be overlapped with the AF guide ball 1810 in an optical axis direction. The cover 1940 may be overlapped with the inner ball 1811 in an optical axis direction. The cover 1940 may be overlapped with the outer ball 1812 in an optical axis direction. The cover 1940 may be disposed on the inner groove 1224-1 and the outer groove 1224-2 of the AF carrier 1210 to prevent the AF guide ball 1810 from being separated upward.

In a second embodiment of the present invention, one side of the wire 1850 can be coupled to the AF moving unit 1200 that is fixed during OIS driving, thereby reducing the characteristic of the wire 1850 vibrating as a point mass.

In a second embodiment of the present invention, the base 1110, preload member 1230, inner substrate 1720, holder member 1220, and OIS carrier 1310 may be disposed in this order from the bottom up. In a first embodiment of the present invention, the base 1110, preload member 1230, inner substrate 1720, holder member 1220, and OIS carrier 1310 may be laminated in this order from the bottom up. In a first embodiment of the present invention, a stable coupling surface with the lens module 1020 can be secured through the lamination direction. In a first embodiment of the present invention, the rib of the lens module 1020 can be disposed in the groove 1313 of the OIS carrier 1310.

In a second embodiment of the present invention, two coils may be provided for each of the OIS-x driving unit 1500 and the OIS-y driving unit 1600. By forming the distribution of the driving force into two points on the outside, the driving linearity may be improved. The magnets of each of the OIS-x driving unit 1500 and the OIS-y driving unit 1600 may be formed with four poles. Or, a total of four magnets may be formed, with two each of the two poles.

According to a second embodiment of the present invention, the attraction and repulsive forces between the AF magnet 1410 and the OIS-x magnet 1510 or the AF magnet 1410 and the OIS-y magnet 1610 can be reduced. Accordingly, the driving noise can be reduced. Hereinafter, the auto focus (AF) operation of the lens actuator according to a second embodiment of the present invention will be described with reference to the drawings.

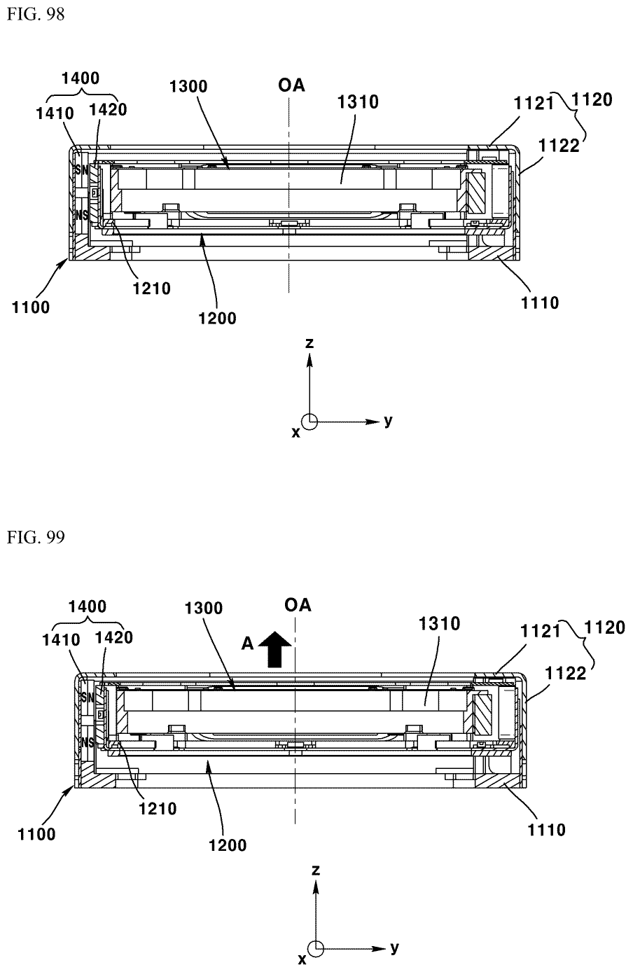

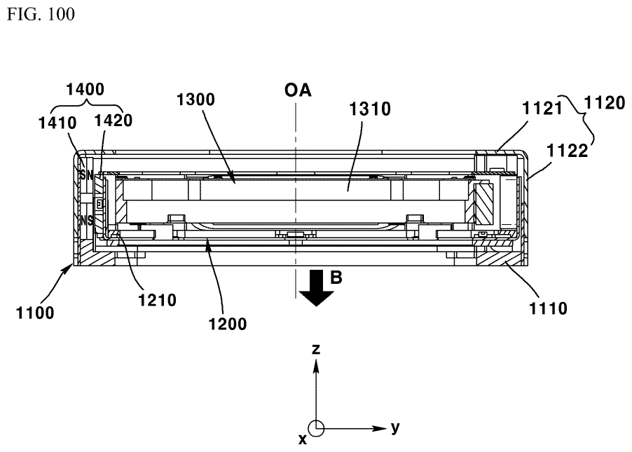

FIGS. 98 to 100 are drawings for explaining an auto focus driving of a lens actuator according to a second embodiment of the present invention. FIG. 98 is a cross-sectional view illustrating the appearance of a moving unit in an initial state where no current is applied to an AF coil. FIG. 99 is a cross-sectional view illustrating the appearance where a moving unit moves upward in an optical axis direction when a forward current is applied to an AF coil. FIG. 100 is a cross-sectional view illustrating the appearance where a moving unit moves downward in an optical axis direction when a reverse current is applied to an AF coil.

As illustrated in FIG. 98, the moving unit may be disposed at a position spaced apart from both the upper plate 1121 of the cover 1120 and the base 1110 in an initial position where no current is applied to the AF coil 1420. At this time, the moving unit may be an AF moving unit 1200. In addition, the moving unit may comprise an AF moving unit 1200 and an OIS moving unit 1300.

When a positive current is applied to the AF coil 1420, the AF coil 1420 can move upward in an optical axis direction due to the electromagnetic interaction between the AF coil 1420 and the AF magnet 1410 (See A of FIG. 99). At this time, the AF carrier 1210 can move upward in an optical axis direction together with the AF coil 1420. Furthermore, the OIS carrier 1310 and the lens can move upward in an optical axis direction together with the AF carrier 1210. Accordingly, the distance between the lens and the image sensor can be changed, so that the focus of the image formed on the image sensor through the lens can be adjusted.

When a reverse current is applied to the AF coil 1420, the AF coil 1420 can move downward in an optical axis direction due to the electromagnetic interaction between the AF coil 1420 and the AF magnet 1410 (See B of FIG. 100). At this time, the AF carrier 1210 can move downward in an optical axis direction together with the AF coil 1420. Furthermore, the OIS carrier 1310 and the lens can move downward in an optical axis direction together with the AF carrier 1210. Accordingly, the distance between the lens and the image sensor can be changed, so that the focus of the image being formed on the image sensor through the lens can be adjusted.

Meanwhile, during the movement of the AF coil 1420, the AF sensor 1430 moves together with the AF coil 1420 and detects the strength of the magnetic field of the AF magnet 1410 to detect the amount of movement or position of the lens in an optical axis direction. The amount of movement or position of the lens in an optical axis direction detected by the AF sensor 1430 can be used for auto focus feedback control.

Hereinafter, the handshake correction (OIS, optical image stabilization) operation of the lens actuator according to a second embodiment of the present invention will be described with reference to the drawings.

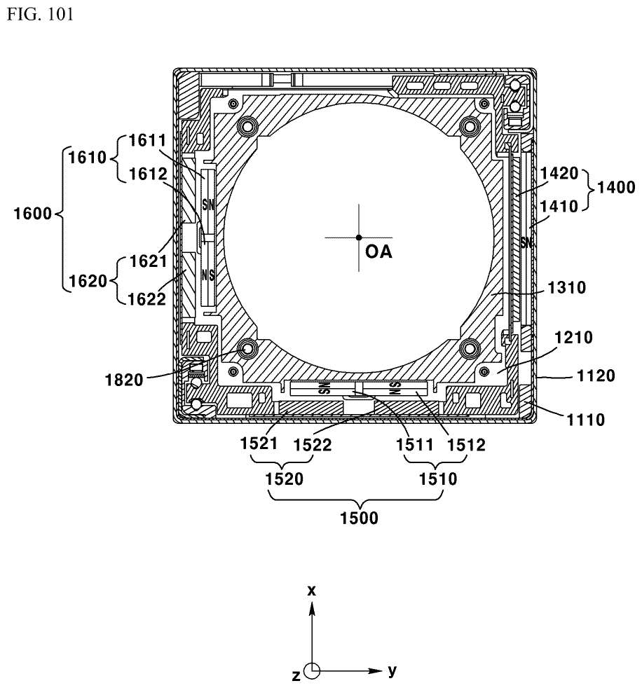

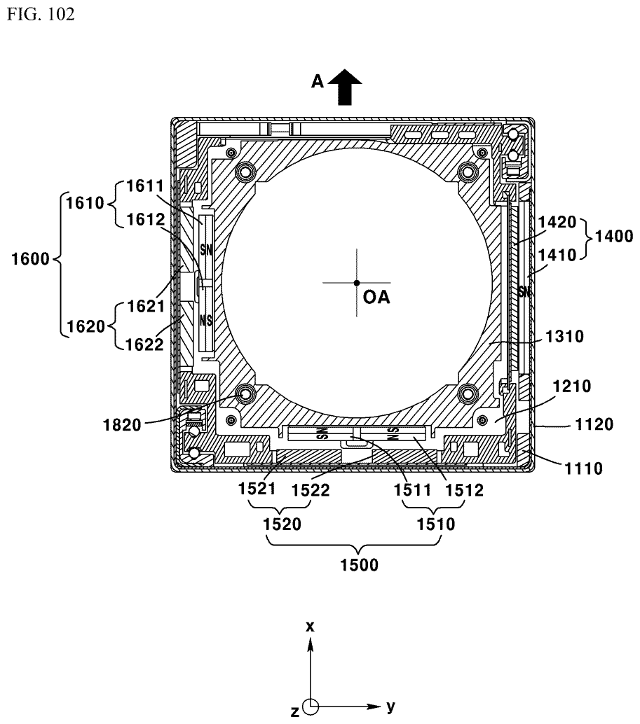

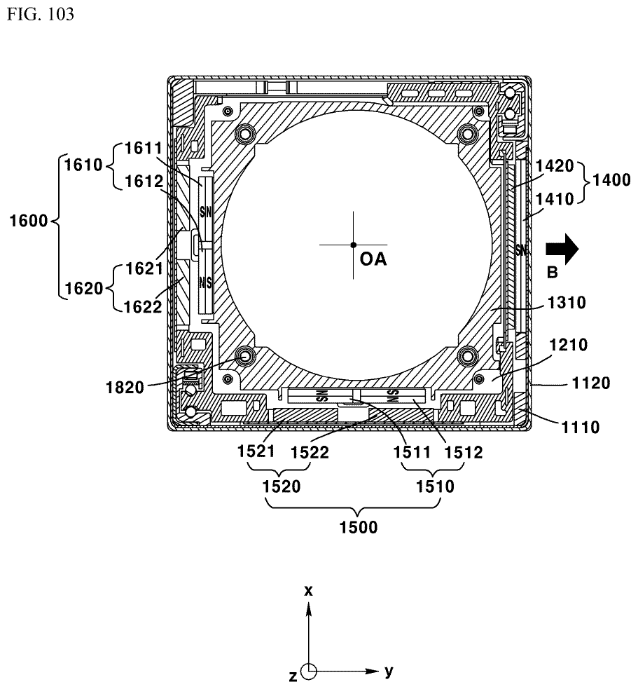

FIGS. 101 to 103 are diagrams for explaining the handshake correction driving of a lens actuator according to a second embodiment of the present invention. FIG. 101 is a cross-sectional view illustrating the appearance of an OIS moving unit in an initial state in which no current is applied to an OIS-x coil and an OIS-y coil. FIG. 102 is a cross-sectional view illustrating the appearance in which an OIS moving unit moves in an x-axis direction perpendicular to the optical axis when a current is applied to an OIS-x coil. FIG. 103 is a cross-sectional view illustrating the appearance in which an OIS moving unit moves in a y-axis direction perpendicular to both an optical axis and an x-axis when a current is applied to an OIS-y coil.

As illustrated in FIG. 101, the moving unit may be disposed at an initial position in a state in which no current is applied to the OIS-x coil 1520 and the OIS-y coil 1620. At this time, the moving unit may be the OIS moving unit 1300

When current is applied to the OIS-x coil 1520, the OIS-x magnet 1510 can move in an x-axis direction perpendicular to the optical axis due to the electromagnetic interaction between the OIS-x coil 1520 and the OIS-x magnet 1510 (See A of FIG. 102). At this time, the OIS carrier 1310 can move in an x-axis direction together with the OIS-x magnet 1510. Furthermore, the lens can move in an x-axis direction together with the OIS carrier 1310. More specifically, when a positive current is applied to the OIS-x coil 1520, the OIS-x magnet 1510, the OIS carrier 1310, and the lens can move in one direction on the x-axis. In addition, when a reverse current is applied to the OIS-x coil 1520, the OIS-x magnet 1510, the OIS carrier 1310, and the lens can move in the other direction along the x-axis.

When a current is applied to an OIS-y coil 1620, the OIS-y magnet 1610 can move in a y-axis direction perpendicular to the optical axis due to the electromagnetic interaction between the OIS-y coil 1620 and the OIS-y magnet 1610 (See B of FIG. 103). At this time, the OIS carrier 1310 can move in a y-axis direction together with the OIS-y magnet 1610. Furthermore, the lens can move in a y-axis direction together with the OIS carrier 1310. More specifically, when a positive current is applied to the OIS-y coil 1620, the OIS-y magnet 1610, the OIS carrier 1310, and the lens can move in one direction on a y-axis. In addition, when a reverse current is applied to the OIS-y coil 1620, the OIS-y magnet 1610, the OIS carrier 1310, and the lens can move in the other direction on a y-axis.

Meanwhile, the OIS-x sensor 1530 can detect the amount of movement or position of the OIS-x magnet 1510 by detecting the strength of the magnetic field of the OIS-x magnet 1510. The amount of movement or position detected by the OIS-x sensor 1530 can be used for x-axis direction handshake correction feedback control. The OIS-y sensor 1630 can detect the amount of movement or position of the OIS-y magnet 1610 by detecting the strength of the magnetic field of the OIS-y magnet 1610. The amount of movement or position detected by the OIS-y sensor 1630 can be used for y-axis direction handshake correction feedback control. Hereinafter, a camera device according to a second embodiment of the present invention will be described with reference to the drawings.

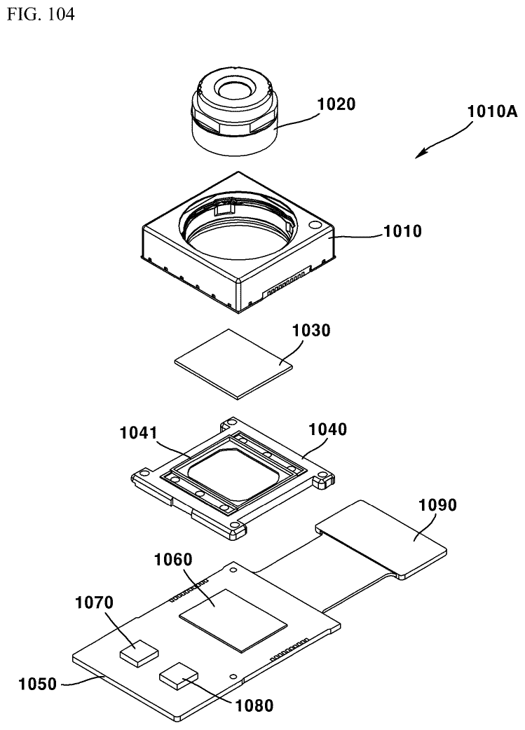

FIG. 104 is an exploded perspective view of a camera device according to a second embodiment of the present invention.

The camera device 1010A may comprise a camera module.

The camera device 1010A may comprise a lens module 1020. The lens module 1020 may comprise at least one lens. The lens may be disposed corresponding to the image sensor 1060. The lens module 1020 may comprise a lens and a barrel. The lens module 1020 may be coupled to the OIS carrier 1310 of the lens actuator 1010. The lens module 1020 may be coupled to the OIS carrier 1310 by screw coupling and/or an adhesive. The lens module 1020 may move integrally with the OIS carrier 1310.

The camera device 1010A may comprise a filter 1030. The filter 1030 may block light of a specific frequency band from passing through the lens module 1020 from being incident on the image sensor 1060. The filter 1030 may be disposed parallel to an x-y plane. The filter 1030 may be disposed between the lens module 1020 and the image sensor 1060. The filter 1030 may be disposed in the sensor base 1040. In a modified embodiment, the filter 1030 may be disposed in the base 1110. The filter 1030 may comprise an infrared filter. The infrared filter may block light in the infrared region from being incident on the image sensor 1060.

The camera device 1010A may comprise a sensor base 1040. The sensor base 1040 may be disposed between the lens actuator 1010 and the printed circuit board 1050. The sensor base 1040 may comprise a protruded portion 1041 in which a filter 1030 is disposed. An opening may be formed in a portion of the sensor base 1040 in which the filter 1030 is disposed so that light passing through the filter 1030 may be incident on the image sensor 1060. An adhesive member may couple or attach the base 1110 of the lens actuator 1010 to the sensor base 1040. The adhesive member may additionally serve to prevent foreign substances from entering the interior of the lens actuator 1010. The adhesive member may comprise at least one among an epoxy, a thermosetting adhesive, and an ultraviolet-curable adhesive.

The camera device 1010A may comprise a printed circuit board (PCB) 1050. The printed circuit board 1050 may be a substrate or a circuit board. A lens actuator 1010 may be disposed in the printed circuit board 1050. A sensor base 1040 may be disposed between the printed circuit board 1050 and the lens actuator 1010. The printed circuit board 1050 may be electrically connected to the lens actuator 1010. An image sensor 1060 may be disposed on the printed circuit board 1050. Various circuits, elements, control units, and the like may be provided on the printed circuit board 1050 to convert an image being formed on the image sensor 1060 into an electrical signal and transmit it to an external device.

The camera device 1010A may comprise an image sensor 1060. The image sensor 1060 may be a configuration in which a light passing through a lens and a filter 1030 is incident thereon to form an image. The image sensor 1060 may be mounted on a printed circuit board 1050. The image sensor 1060 may be electrically connected to the printed circuit board 1050. For example, the image sensor 1060 may be coupled to the printed circuit board 1050 by surface mounting technology (SMT). As another example, the image sensor 1060 may be coupled to the printed circuit board 1050 by flip chip technology. The image sensor 1060 may be disposed such that its optical axis is aligned with that of the lens. That is, the optical axis of the image sensor 1060 and the optical axis of the lens may be aligned. The image sensor 1060 can convert light irradiated to the effective image area of the image sensor 1060 into an electrical signal. The image sensor 1060 can be any one among a charge coupled device (CCD), a metal oxide semi-conductor (MOS), a CPD, and a CID.

The camera device 1010A may comprise a motion sensor 1070. The motion sensor 1070 may be mounted on a printed circuit board 1050. The motion sensor 1070 may be electrically connected to the control unit 1080 through a circuit pattern being provided on the printed circuit board 1050. The motion sensor 1070 may output rotational velocity information due to the movement of the camera device 1010A. The motion sensor 1070 may comprise a two-axis or three-axis gyro sensor or an angular velocity sensor.

The camera device 1010A may comprise a control unit 1080. The control unit 1080 may be disposed on a printed circuit board 1050. The control unit 1080 may be electrically connected to a coil 1330 of a lens driving device 1010. The control unit 1080 may individually control the direction, intensity, amplitude, and the like of the current supplied to the coil 1330. The control unit 1080 may control the lens driving device 1010 to perform an auto focus function and/or a shake correction function. Furthermore, the control unit 1080 may perform auto focus feedback control and/or handshake correction feedback control for the lens driving device 1010.

The camera device 1010A may comprise a connector 1090. The connector 1090 may be electrically connected to the printed circuit board 1050. The connector 1090 may comprise a port for electrically connecting to an external device.

Hereinafter, an optical instrument according to a second embodiment of the present invention will be described with reference to the drawings.

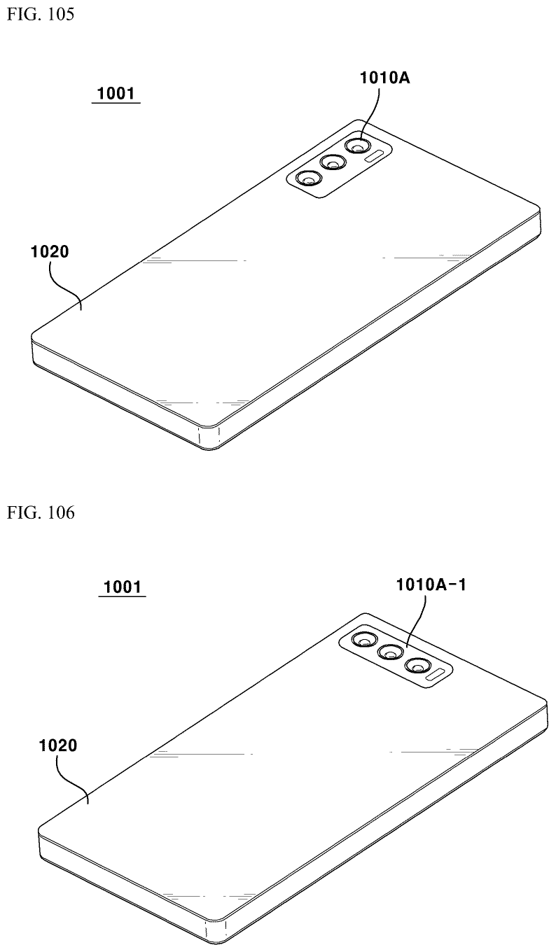

FIG. 105 is a perspective view of an optical instrument according to a second embodiment of the present invention. FIG. 106 is a perspective view of an optical instrument according to a modified embodiment.

The optical instrument 1001 may comprise at least one among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical instrument 1001 may comprise any device for photographing videos or pictures.

The optical instrument 1001 may comprise a main body 1020. The optical instrument 1001 may comprise a camera device 1010A. The camera device 1010A may be disposed in the main body 1020. The camera device 1010A may capture a subject. The optical instrument 1001 may comprise a display. The display may be disposed in the main body 1020. The display may output one or more of an image and a video captured by the camera device 1010A. The display may be disposed on a first surface of the main body 1020. The camera device 1010A may be disposed on one or more of the first surface of the main body 1020 and the second surface opposite to the first surface. As illustrated in FIG. 105, in the camera device 1010A, a triple camera may be disposed in a vertical direction. As illustrated in FIG. 106, in the camera device 1010A-1, a triple camera may be disposed in a horizontal direction.

Although the embodiments of the present invention have been described with reference to the attached drawings, those skilled in the art will appreciate that the present invention can be implemented in other specific forms without altering the technical concept or essential features thereof. Therefore, the embodiments described above should be understood to be illustrative in all respects and not restrictive.

1. A camera device comprising:
a housing;
a bobbin disposed in the housing;
a second ball disposed between the housing and a lower side of the bobbin; and
a coil spring coupled with the bobbin and the housing,
wherein the coil spring is configured to press the second ball.

2. The camera device of claim 1, comprising:
a base; and
a first ball disposed between the housing and the base,
wherein the housing is disposed on the base, and
wherein the base comprises a first guide configured to guide movement of the first ball.

3. The camera device of claim 2, wherein the housing comprises a second guide configured to guide movement of the first ball and formed on a side surface of the housing.

4. The camera device of claim 3, wherein the first guide and the second guide comprise grooves.

5. The camera device of claim 1, wherein the housing comprises a first housing comprising a lower plate having a metal member and a second housing coupled with the first housing and having a protrusion configured to guide the second ball.

6. The camera device of claim 5, comprising a first substrate disposed between the first housing and the second housing,
wherein the first substrate is coupled with a lower surface of the first housing, and
wherein the second housing is coupled with the first substrate.

7. The camera device of claim 5, wherein the second housing is in contact with the second ball to press a portion of the coil spring.

8. The camera device of claim 1, comprising a cover coupled with the base,
wherein the first ball is disposed between the cover and a pillar of the base.

9. The camera device of claim 1, wherein the coil spring has a circular ring shape when viewed from above.

10. The camera device of claim 1, wherein the coil spring is formed by bending one strand so that it is overlapped with itself multiple times in an optical axis direction.

11. The camera device of claim 1, wherein the bobbin comprises a protruded portion protruding from an outer surface of the bobbin, and
wherein the coil spring connects the protruded portion of the bobbin and a lower plate of the housing.

12. The camera device of claim 5, wherein the coil spring connects the bobbin and the metal member of the housing.

13. The camera device of claim 1, wherein the bobbin comprises first to fourth corners,
wherein the coil spring comprises first to fourth coil springs disposed at the first to fourth corners of the bobbin, and
wherein the first to fourth coil springs are spaced apart from one another in a direction perpendicular to an optical axis direction.

14. The camera device of claim 1, comprising:
a printed circuit board;
an image sensor disposed on the printed circuit board; and
a lens coupled with the bobbin.

15. An optical instrument, comprising:
a main body;
the camera device of claim 1 disposed on the main body; and
a display disposed on the main body and configured to output at least one of an image and a video photographed by the camera device.

16. A camera device comprising:
an image sensor;
a housing disposed on the image sensor;
a bobbin disposed in the housing;
a lens coupled with the lens;
a second ball disposed between the housing and the bobbin; and
a coil spring coupled with the bobbin and the housing,
wherein the bobbin comprises a lower surface facing a side of the image sensor,
wherein the second ball is disposed between the lower surface of the bobbin and the housing, and
wherein the coil spring is configured to press the second ball.

17. The camera device of claim 16, wherein the coil spring is disposed in an optical axis direction of the image sensor.

18. The camera device of claim 16, wherein the housing comprises a first housing comprising a lower plate having a metal member and a second housing coupled with the first housing and having a protrusion configured to guide the second ball.

19. The camera device of claim 18, comprising a first substrate disposed between the first housing and the second housing,
wherein the first substrate is coupled with a lower surface of the first housing, and
wherein the second housing is coupled with the first substrate.

20. A camera device comprising:
a base;
a housing disposed on the base;
a bobbin disposed in the housing;
a second ball disposed between the housing and a lower side of the bobbin; and
a coil spring coupled with the bobbin and the housing,
wherein the coil spring is configured to press the second ball.
